(19) United States
(12) Patent Application Publication
(10) Pub. No.: US 2013/0169896 A1
(43) Pub. Date: Jul. 4, 2013

(54) STEREO IMAGE PRINT AND METHOD OF PRODUCING THE SAME

(71) Applicant: FUJIFILM CORPORATION, Tokyo (JP)

(72) Inventors: Nobutaka IWAHASHI, Minami-ashigara-shi (JP); Shinichi MORISHIMA, Minami-ashigara-shi (JP)

(73) Assignee: FUJIFILM CORPORATION, Tokyo (JP)

(21) Appl. No.: 13/717,307

(22) Filed: Dec. 17, 2012

Related U.S. Application Data
(63) Continuation of application No. PCT/JP2011/063927, filed on Jun. 17, 2011.

(30) Foreign Application Priority Data
Jun. 18, 2010 (JP) 2010-139316

(51) Int. Cl. G02B 27/22

(52) U.S. Cl. CPC G02B 27/225
USPC 349/15; 359/465; 347/102

(57) ABSTRACT

Stereo image print observable without polarized glasses, having: a transparent support; first laminate and second laminate disposed on a front surface and a back surface, respectively, of the transparent support, each laminate having an image layer satisfying condition (1) and protective layer having at least one layer satisfying condition (2), the image layer and the protective layer being disposed in this order from the transparent support side: (1) each image layer has a dichroic image including pixels for a left eye and pixels for a right eye arranged in a predetermined array, each pixel has at least one horizontally aligned dichroic dye, and absorption axes of the dichroic images included in the first and the second laminates are orthogonal to each other, (2) the protective layer has an in-plane retardation value (Re) of 10 nm or less for visible light; and a linearly polarizing layer satisfying the according to predefined condition.

The present application is a continuation of PCT/JP2011/063927 filed on Jun. 17, 2011 and claims priority under 35 U.S.C. §119 of Japanese Patent Application No. 139316/2010, filed on Jun. 18, 2010.

### TECHNICAL FIELD

The present invention relates to a stereo image print stereoscopically displaying an image and a method of producing the image print.

### BACKGROUND ART

Conventional methods of stereoscopically displaying image prints of planar images for viewers have been proposed (e.g., PCT Japanese Translation Patent Publication Nos. Hei 11-511702 and 2001-505323 and Journal of Imaging Science and Technology, “Full-color 3-D Prints and Technology”, vol. 42, No. 4, July/August 1998, J. J. Scarpetti, P. M. Dubois, R. M. Friedhoff, and V. K. Walworth) in which the methods use dichroic dyes. In each method, polarized images for the left eye and the right eye are separately formed using an ink containing a dichroic dye on a sheet of which molecules are aligned by, for example, stretching treatment. Another method of producing a stereo image print disclosed in Japanese Patent Laid-Open No. Hei 5-210182 involves arranging pixels for a left eye and the right eye in a predetermined array, disposing a polarizing filter over the pixels for a left eye and the right eye, and further stacking a ¼ wavelength plate on the polarizing film, where the angle between the polarizing axis of the polarizing film and the delay axis of the ¼ wavelength plate is ±45 degrees for the right eye and the left eye, respectively.

In these methods, the viewer needs to wear polarized glasses.

### SUMMARY OF INVENTION

It is an object of the present invention to provide a stereo image print that can be observed without polarized glasses and a method of producing the stereo image print.

The method for solving the above-mentioned problem is as follows:

<1> A stereo image print comprising:

a transparent support;

a first laminate and a second laminate disposed on a front surface and a back surface, respectively, of the transparent support, each laminate comprising an image layer satisfying the following condition (1) and a protective layer comprising at least one layer satisfying the following condition (2), the image layer and the protective layer being disposed in this order from the transparent support side:

(1) each image layer has a dichroic image including pixels for a left eye and pixels for a right eye arranged in a predetermined array, each pixel comprises at least one kind of horizontally aligned dichroic dye, and the dichroic images included in the first and second laminates have absorption axes being orthogonal to each other,

(2) the protective layer comprising at least one layer included in the first laminate has an in-plane retardation value (Re) of 10 nm or less for visible light; and

comprising a patterned retardation layer satisfying the following condition (3) and a linearly polarizing layer satisfying the following condition (4) on the surface of the first laminate, the stereo image print being viewed from exterior of the linearly polarizing layer:

(3) the patterned retardation layer is patterned into a first domain having an in-plane retardation of 0 and a second domain having an in-plane retardation of a ½ wavelength, the pixels for a left eye and the pixels for a right eye being arranged at positions corresponding to the first and second domains, the pixels for a left eye and the pixels for a right eye in the first laminate are left-right reversed to the pixels for a left eye and the pixels for a right eye in the second laminate, and the absorption axes of the dichroic images included in the first laminate and the second laminate forms an angle of 45° with respect to the in-plane slow axis of the second domain,

(4) the linearly polarizing layer has a polarization axis coincident with any one of the absorption axes of the dichroic images included in the first and second laminates,

wherein the stereo image print is configured such that only the dichroic image for a left eye enters an designed viewing position for the left eye and that only the dichroic image for a right eye enters an designed viewing position for the right eye.

<2> The stereo image print according to <1>, wherein the pixels for a right eye and the pixels for a left eye are alternately adjacently arranged, respectively; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included in the second laminate.

<3> The stereo image print according to <1> or <2>, wherein the transparent support shows an in-plane retardation value (Re) of 10 nm or less for visible light.

<4> The stereo image print according to any one of <1> to <3>, wherein the at least one kind of dichroic dye has liquid crystallinity; and

which comprises a first alignment film disposed between the image layer of the first laminate and the transparent support and a second alignment film disposed between the image layer of the second laminate and the transparent support; and the first and second alignment films have alignment axes orthogonal to each other.

<5> The stereo image print according to <4>, wherein the first and second alignment films are rubbing alignment films formed from a composition primarily composed of a polymer compound by rubbing the surfaces of the films such that the rubbing directions of the films are orthogonal to each other.

<6> The stereo image print according to <4>, wherein the first and second alignment films are photoalignment films aligned by light irradiation in the directions orthogonal to each other.

<7> The stereo image print according to any one of <4> to <6>, wherein the at least one liquid crystalline dichroic dye is hydrophobic; and the first and second alignment films each comprise a hydrophilic polymer as a main component.

<8> The stereo image print according to any one of <1> to <7>, wherein the first laminate and/or the second laminate comprises an oxygen-shielding layer formed from a composition primarily composed of polyvinyl alcohol as one layer of the protective layer comprising one or more layers.

<9> The stereo image print according to any one of <1> to <8>, wherein the first laminate and/or the second laminate comprises a layer containing a UV absorber as one layer of the protective layer comprising one or more layers.

<10> The stereo image print according to any one of <1> to <9>, wherein the at least one dichroic dye is a liquid crystalline dichroic dye represented by Formula (I), Formula (II), Formula (III), Formula (IV), or Formula (VI):

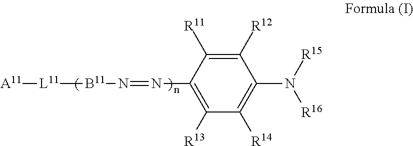

(in the formula, R¹¹ to R¹⁴ each independently represent a hydrogen atom or a substituent; R¹⁵ and R¹⁶ each independently represent a hydrogen atom or an optionally substituted alkyl group; L¹¹ represents —N═N—, —CH═N—, —N═CH—, —C(═O)O—, —OC(═O)—, or —CH═CH—; A¹¹ represents an optionally substituted phenyl group, an optionally substituted naphthyl group, or an optionally substituted aromatic heterocyclic group; B¹¹ represents an optionally substituted divalent aromatic hydrocarbon group or divalent aromatic heterocyclic group; and n represents an integer of 1 to 5, provided that when n represents an integer of 2 or more, a plurality of B¹¹'s may be the same as or different from each other);

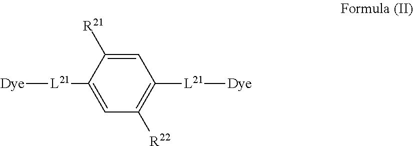

(in the formula, R²¹ and R²² each represent a hydrogen atom, an alkyl group, an alkoxy group, or a substituent represented by -L²²-Y, provided that at least one of R²¹ and R²² represents a group other than a hydrogen atom, wherein L²² represents an alkylene group, where one CH₂ group or two or more nonadjacent CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbon atoms); and Y represents a hydrogen atom, a hydroxy group, an alkoxy group, a carboxyl group, a halogen atom, or a polymerizable group; each L²¹ represents a linker selected from the group consisting of an azo group (—N═N—), a carbonyloxy group (—C(═O)O—), an oxycarbonyl group (−O—C(═O)—), an imino group (—N═CH—), and a vinylene group (—C═C—); and each Dye represents an azo dye residue represented by Formula (IIa):

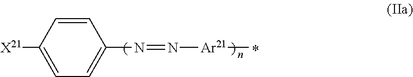

in Formula (IIa), * represents a bonding site to L²¹; X²¹ represents a hydroxy group, a substituted or unsubstituted alkyl group, a substituted or unsubstituted alkoxy group, an unsubstituted amino group, or a mono- or di-alkylamino group; each Ar²¹ represents an optionally substituted aromatic hydrocarbon ring or aromatic heterocyclic group; and n represents an integer of 1 to 3, and when n is an integer of 2 or more, a plurality of Ar²¹'s may be the same as or different from each other);

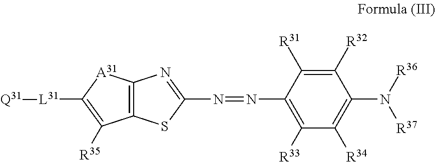

(in the formula, R³¹ to R³⁵ each independently represent a hydrogen atom or a substituent; R³⁶ and R³⁷ each independently represent a hydrogen atom or an optionally substituted alkyl group; Q³¹ represents an optionally substituted aromatic hydrocarbon, aromatic heterocyclic, or cyclohexane ring group; L³¹ represents a divalent linker; and A³¹ represents an oxygen atom or a sulfur atom);

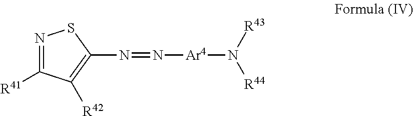

(in the formula, R⁴¹ and R⁴² each represent a hydrogen atom or a substituent or may be bonded to each other to form a ring; Ar⁴ represents an optionally substituted divalent aromatic hydrocarbon or aromatic heterocyclic group; and R⁴³ and R⁴⁴ each represent a hydrogen atom or an optionally substituted alkyl group or may be bonded to each other to form a heterocyclic ring); and

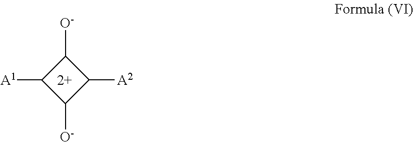

(in the formula, A¹ and A² each independently represent a substituted or unsubstituted hydrocarbon ring or heterocyclic group).

<11> The stereo image print according to any one of <1> to <10>, wherein the patterned retardation layer is formed by hardening a curable liquid crystal composition.

<12> The stereo image print according to <11>, wherein the patterned retardation layer is formed by pattern-exposing a film comprising the curable liquid crystal composition to generate the first and the second domains through expression or extinction of in-plane retardation.

<13> The stereo image print according to any one of <1> to <12>, further comprising a non-depolarizing reflecting layer on the surface opposite to the viewer side.

<14> A method of producing a stereo image print according to any one of <1> to <13>, the method comprising:

applying a dichroic dye composition comprising an organic solvent and at least one dichroic dye dissolved in the organic solvent, simultaneously or separately, onto the front surface and the back surface of a transparent support so as to form the respective images by arranging pixels for a left eye and pixels for a right eye in a predetermined array; and

horizontally aligning spontaneously or passively the at least one dichroic dye by evaporating the organic solvent in the composition.

<15> The method according to <14>, wherein the liquid crystalline dichroic dye composition is applied by ink jetting.

The present invention can provide a stereo image print a viewer can observe without wearing polarized glasses and a method of producing the stereo image print.

### BRIEF DESCRIPTION OF DRAWINGS

FIG. 1 is a schematic cross-sectional view of an example stereo image print of the present invention.

FIG. 2 is a view schematically illustrating an operation when a viewer views a stereo image print of the present invention.

FIG. 3 is a schematic view illustrating the directions of rubbing treatment in an example rubbing alignment film that can be used in the present invention.

FIG. 4 is a schematic view illustrating the directions of light irradiation in an example photoalignment film that can be used in the present invention.

FIG. 5 schematically shows a flow of an example method of forming a patterned retardation layer that can be employed in the stereo image print of the present invention.

FIG. 6 includes a plan view (a) of an example exposure mask that can be used in the production of the stereo image print of the present invention and a plan view (b) illustrating a relationship between the absorption axis of a dichroic image and the in-plane slow axis of a second domain.

FIG. 7 is a schematic cross-sectional view of an example stereo image print of the present invention.

FIG. 8 is a schematic cross-sectional view of an example stereo image print of the present invention.

FIG. 9 is a schematic cross-sectional view of an example printing sheet that can be used for producing a stereo image print of the present invention.

### DESCRIPTION OF EMBODIMENTS

The invention is described in detail hereinunder. In this description, the numerical range expressed by the wording “a number to another number” means the range that falls between the former number indicating the lowermost limit of the range and the latter number indicating the uppermost limit thereof. First described are the terms used in this description.

Note that throughout the specification, Re(λ) denotes the front retardation value (unit: nm) at a wavelength λ nm; Rth(λ) denotes the retardation value (unit: nm) in the thickness direction at a wavelength λ nm; and the value in the case of not stating wavelength is one at a wavelength of 550 nm. The in-plane retardation (Re(λ)) is measured with KOBRA 21ADH or WR (manufactured by Oji Keisoku Kiki Co., Ltd.) using incident light having a wavelength λ nm entering in the film normal direction; and the thickness direction retardation (Rth(λ)) is calculated based on the value Re(λ) and a plurality of values obtained by measurement with light from oblique directions.

In this description, “visible light” means from 380 nm to 780 nm. Unless otherwise specifically defined in point of the wavelength in measurement in this description, the wavelength in measurement is 550 nm.

In this description, the angle (for example, “90°”, etc.) and the relational expressions thereto (for example, “perpendicular”, “parallel”, “crossing at 45°”, etc.) should be so interpreted as to include the error range generally acceptable in the technical field to which the invention belongs. For example, this means within a range of a strict angle±less than 10°, and the error from the string angle is preferably at most 5°, more preferably at most 3°.

Throughout the specification, the term “patterning” refers to production of two or more regions having different directions characterized by optical anisotropy (i.e., directions including slow axis and polarization axis) from each other on a film (layer) object or possession of two or more such regions.

Throughout the specification, the terms “crosstalk” and “ghost image” refer to the right and left images are recognized as a double image and are recognized as an image other than the objective image due to incomplete separation thereof.

### 1. Stereo Image Print

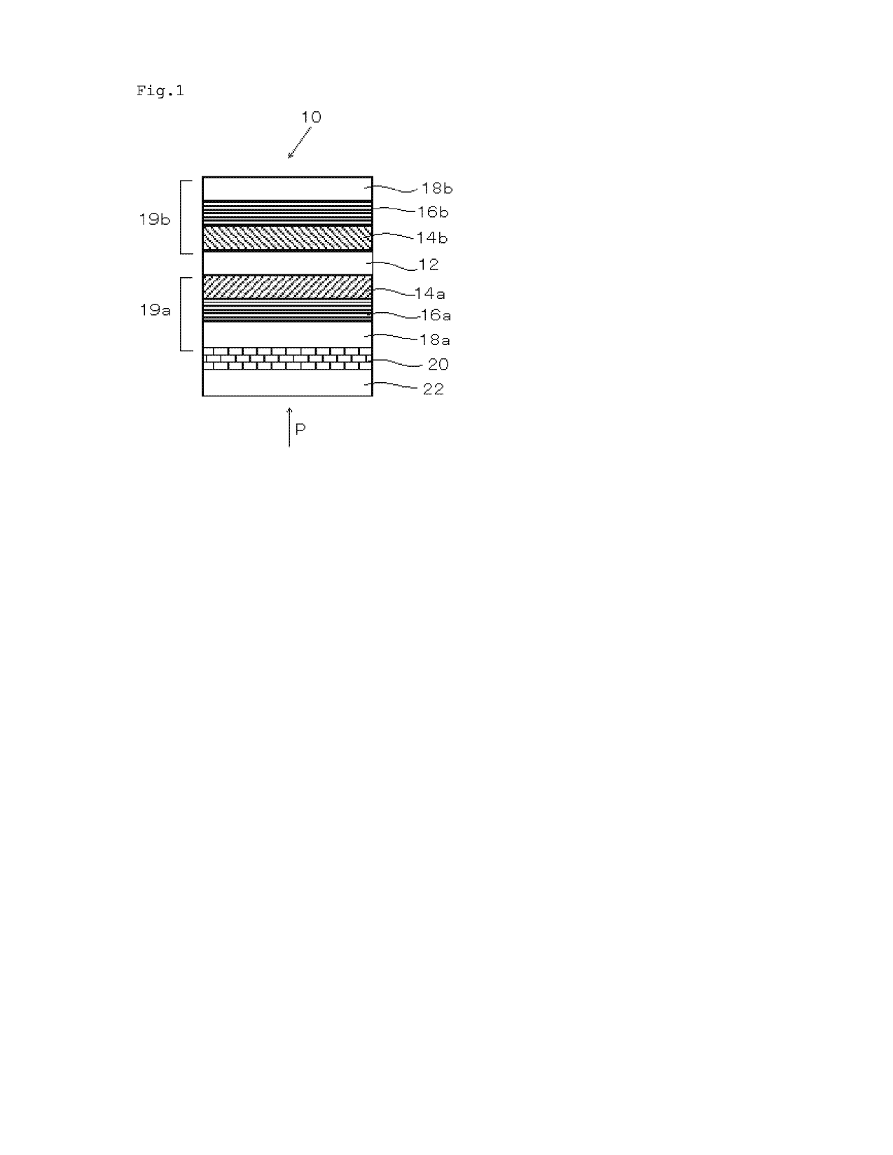

FIG. 1 is a cross-sectional view of a stereo image print of an embodiment of the present invention.

The stereo image print 10 of FIG. 1 is viewed from the direction of the arrow P. The stereo image print 10 includes a first laminate 19a including an image layer 16a and a protective layer 18a stacked on the viewer-side surface of a transparent support 12 and a second laminate 19b including an image layer 16b and a protective layer 18b stacked on the other surface of the transparent support 12. The image layers 16a and 16b each have a dichroic image including pixels for a right eye and pixels for a left eye arranged in a predetermined array, each pixel being composed of at least one substantially horizontally aligned dichroic dye. The absorption axes of the dichroic images in the first laminate 19a and the second laminate 19b are orthogonal to each other. A patterned retardation layer 20 and a linearly polarizing layer 22 are disposed on the viewer-side surface of the first laminate 19a.

An image-receiving layer 14a is disposed between the transparent support 12 and the image layer 16a, and an image-receiving layer 14b is disposed between the transparent support 12 and the image layer 16b. The image-receiving layers 14a and 14b each maintain a dichroic dye on the surface thereof or allow the dichroic dye to permeate therein and each have a function of allowing the dichroic dye to be spontaneously or passively horizontally aligned. For example, in the case of using a spontaneously aligning liquid crystalline dichroic dye, the image-receiving layers 14a and 14b are preferably alignment films that are disposed such that their alignment axes are orthogonal to each other. In the case of a dichroic dye being a compound that does not spontaneously align but passively aligns in the presence of another molecule, the image-receiving layers 14a and 14b are preferably molecularly aligned sheets stretched in directions orthogonal to each other. In such a case, the dichroic dye is required to permeate the image-receiving layers 14a and 14b, and this restricts the combination of raw materials. In contrast, in the case of using a liquid crystalline dichroic dye, the dichroic dye is not required to permeate the image-receiving layers 14a and 14b, for example, even if the liquid crystalline dichroic dye is hydrophobic whereas the image-receiving layers 14a and 14b are primarily composed of hydrophilic materials; hence, a dichroic image can be formed. In the case of using a liquid crystalline dichroic dye, a dichroic image can be formed with a high dichroic ratio, compared with the case of allowing a non-liquid crystalline dichroic dye to permeate a molecularly aligned sheet and passively align along the molecular alignment. As a result, crosstalk and ghost images can be reduced.

FIG. 1 illustrates the image layers 16a and 16b, each having a two-layer structure. For example, in the case of a dichroic dye that permeates the image-receiving layer to be horizontally aligned therein as described above, the image layer 16a and the image-receiving layer 14a can be regarded as an unseparated single layer, and similarly, the image layer 16b and the image-receiving layer 14b can be regarded as a single layer.

The image layers 16a and 16b each have a dichroic image combined based on, for example, image data photographed with a digital camera, more specifically, digital data such as an image photographed with a digital camera equipped with taking lenses of two systems for right and left. The dichroic image is composed of pixels for a left eye and the right eye arranged in a predetermined pattern. The predetermined pattern is, for example, a stripe pattern. An example is a dichroic image, wherein the pixels for a right eye and the pixels for a left eye are adjacently alternately arranged in each of the image layers 16a and 16b and the pixels for a right eye and the pixels for a left eye are stacked and arranged so that the image layer 16a and the image layer 16b correspond to each other. The dichroic images are preferably formed by ink-jet recording.

The first and the second laminates 19a and 19b, respectively, include protective layers 18a and 18b for protecting the image layers 16a and 16b. The protective layers 18a and 18b are made of, for example, a polymer film. The protective layer 18a included in the first laminate 19a, i.e., the protective layer 18a disposed on the viewing-surface side of the transparent support 12 shows an in-plane retardation value (Re) of 10 nm or less for visible light. A value Re of exceeding 10 nm changes the absorption axis of the dichroic image, causing crosstalk and ghost images. Accordingly, the protective layer 18a preferably has low retardation. Specifically, the in-plane retardation Re(550) at a wavelength of 550 nm is preferably 0 to 10 nm and more preferably 5 nm or less. The value Rth of the protective layer 18a also affects the absorption axis of a dichroic image to cause crosstalk and ghost. Accordingly, the absolute value of Rth(550) of the protective layer 18a is preferably 20 nm or less and more preferably 5 nm or less.

The patterned retardation layer 20 includes first domains 20x having an in-plane retardation of 0 and second domains 20y having an in-plane retardation of a ½ wavelength. A linearly polarizing layer 22 is disposed outer than the patterned retardation layer 20. The stereo image print is viewed from the exterior of the linearly polarizing layer 22, that is, from the direction of the arrow P. The pixels for a left eye and the pixels for a right eye of the dichroic images of the first and the second laminates 19a and 19b are arranged at positions corresponding to the first and the second domains 20x and 20y of the patterned retardation layer 20 such that the dichroic image contained in the first laminate 19a and the dichroic image contained in the second laminate 19b are left-right reversed. Furthermore, the absorption axes of the dichroic images in the first laminate 19a and the second laminate 19b respectively define an angle of 45° with respect to the in-plane slow axis of the first domains 20x. The polarization axis of the linearly polarizing layer 22 is coincident with the absorption axis of either the dichroic image in the first laminate 19a or the dichroic image in the second laminates 19b.

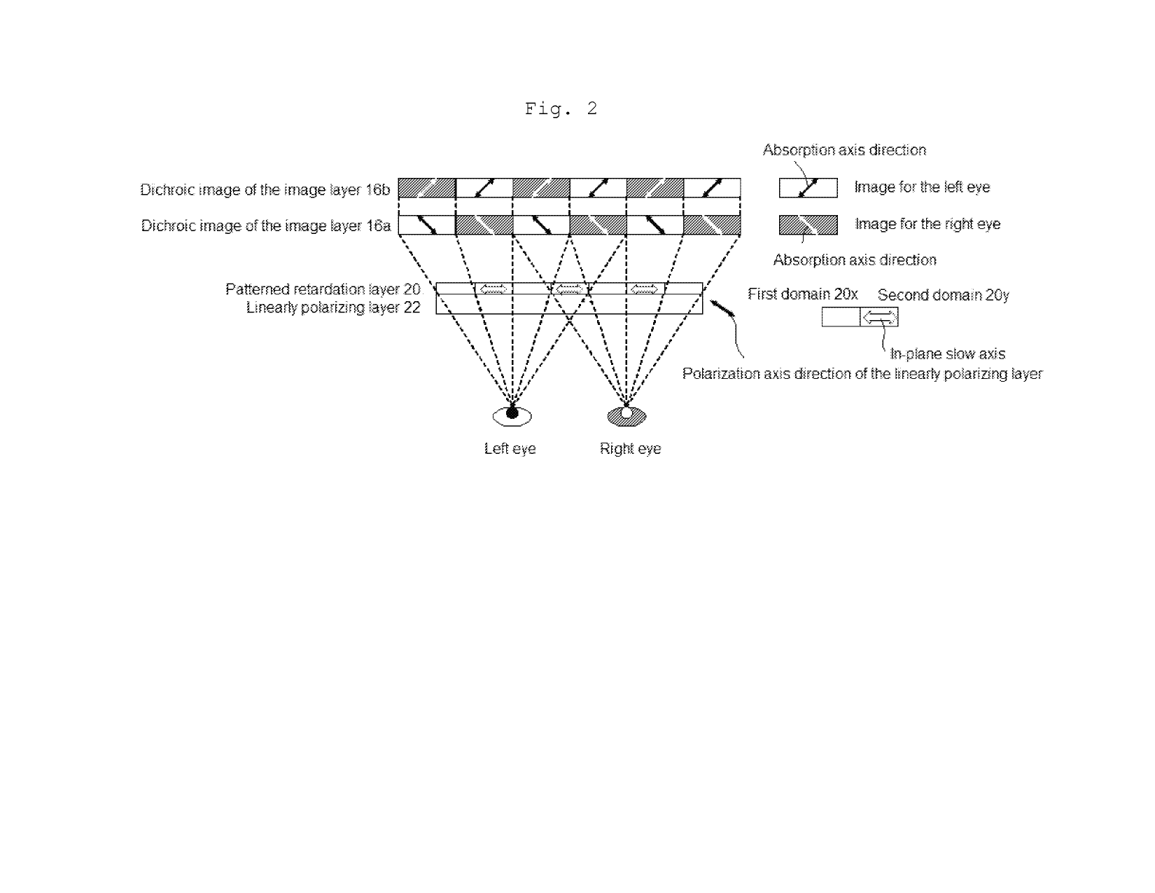

FIG. 2 is a view schematically illustrating pixels viewed by the left eye and pixels viewed by the right eye when a viewer views the stereo image print 10 without wearing polarized glasses.

In FIG. 2, the linearly polarizing layer 22 is bonded such that the absorption axis direction of the dichroic image in the first laminate 19a is coincident with the polarization axis of the linearly polarizing layer 22, when viewed from the positions of the right eye and the left eye of a viewer. The patterned retardation layer 20 is arranged such that, for the dichroic image in the first laminate 12a, the positions of first domains 20x correspond to the positions of the pixels for a left eye when viewed from the designed left eye position and correspond to the positions of the pixels for a right eye when viewed from the designed right eye position; and such that, for the dichroic image in the second laminate 12b, the positions of second domains 20y correspond to the positions of the pixels for a left eye when viewed from the designed left eye position and correspond to the positions of the pixels for a right eye when viewed from the designed right eye position.

A viewer views the stereo image print through the linearly polarizing layer 22 and the patterned retardation layer 20. The linearly polarizing layer 22 and the patterned retardation layer 20 are arranged such that, when the image Layer 16a is viewed with the left eye, the pixels for a left eye are viewed through the linearly polarizing layer 22 having a polarization axis in the direction coincident with the absorption axis direction of the pixels for a left eye and the first domains 20x having an Re of 0 while the pixels for a right eye are viewed through the linearly polarizing layer 22 having a polarization axis in the direction coincident with the absorption axis direction of the pixels for a right eye and the second domains 20y having an Re of a ½ wavelength; and when the image layer 16b is viewed with the left eye, the pixels for a left eye are viewed through the linearly polarizing layer 22 having a polarization axis in the direction orthogonal to the absorption axis direction of the pixels for a left eye and the second domains 20y having an Re of a ½ wavelength while the pixels for a right eye are viewed through the linearly polarizing layer 22 having a polarization axis in the direction orthogonal to the absorption axis direction of the pixels for a right eye and the first domains 20x having an Re of 0. As a result, the left eye can view only the pixels for a left eye of the image layers 16a and 16b. Similarly, the linearly polarizing layer 22 and the patterned retardation layer 20 are arranged such that, when the image layer 16a is viewed with the right eye, the pixels for a right eye are viewed through the linearly polarizing layer 22 having a polarization axis in the direction coincident with the absorption axis direction of the pixels for a right eye and the first domains 20x having an Re of 0 while the pixels for a left eye are viewed through the linearly polarizing layer 22 coincident with the absorption axis direction of the pixels for a left eye and the second domains 20y having an Re of a ½ wavelength; and when the image layer 16b is viewed with the right eye, the pixels for a right eye are viewed through the linearly polarizing layer 22 having a polarization axis in the direction orthogonal to the absorption axis direction of the pixels for a right eye and the second domains 20y having an Re of a ½ wavelength while the pixels for a left eye are viewed through the linearly polarizing layer 22 having a polarization axis in the direction orthogonal to the absorption axis direction of the pixels for a left eye and the first domains 20x having an Re of 0. As a result, the right eye can view only the pixels for a right eye of the image layers 16a and 16b.

The distances from a viewer to the image layers 16a and 16b, the distances from the patterned retardation layer 20 to the image layers 16a and 16b, the midpoint distances between the pixels for a left eye and the pixels for right eye, the average distance between the right eye and the left eye, and the patterning intervals of the linearly polarizing layer satisfy predetermined geometrical relationships. Accordingly, the stereo image print 10 can be designed depending on the relational expressions. The details are described in “Theory of Parallax Barriers”, July, 1952, Journal of the SMPTE, vol. 59, SAM H. KAPLAN. The conventional technology described in this specification does not use a patterned linearly polarizing layer, but uses a parallax barrier. In this point, the conventional technology differs from the present invention. The present invention is superior to the conventional technology using the parallax barrier in that a resolution can be ensured.

The optical characteristics of the transparent support 12 affect the absorption axis of the dichroic image in the second laminate 19b; hence, the transparent support 12 preferably has low retardation. Specifically, the in-plane retardation Re(550) at a wavelength of 550 nm is preferably 0 to 10 nm and more preferably 5 nm or less. The absolute value of Rth(550) is preferably 20 nm or less and more preferably 5 nm or less.

Various materials that can be used for the stereo image print of the present invention will now be described.

### Transparent Support

The support of the stereo image print is transparent. Specifically, the support preferably has a light transmittance of 70% or more, more preferably 80% or more, and most preferably 90% or more. In order not to affect the polarized nature of the dichroic image in the second laminate on the back side, the support preferably has low retardation or has isotropy, as described above. Specific examples and preferred embodiments of the polymer suitable for a low retardation film or optically isotropic film are described in paragraph [0013] of Japanese Patent Laid-Open No. 2002-22942, which can be incorporated herein. The films formed of the polymers, which are commonly known as easy to develop birefringence, such as polycarbonates or polysulfones, may be also used after being modified by the process described in WO00/26705 thereby to reduce the development of birefringence.

The transparent support may be a cellulose acylate film. The cellulose acylate film is preferably a low retardation film primarily composed of cellulose acetate having a degree of acetylation of 55.0 to 62.5%, in particular, 57.0 to 62.0%. The preferred scope of acetylation rates and the preferred chemical structures of cellulose acetates are same as those described at [0021] column in JPA No. 2002-196146. It is disclosed in Journal of Technical Disclosure (Hatsumei Kyoukai Koukai Gihou) No. 2001-1745, published by Japan Institute of Invention and Innovation, cellulose acylate films produced by using chlorine-free solvents, and the cellulose acetate films can be employed in the present invention.

The cellulose acylate film, produced by a solvent-casting method using a cellulose acylate solution (dope), is preferably used. The dope may further comprise the agent for increasing retardation, and such a dope is preferred. Multilayered films can be produced by using the cellulose acylate solution (dope). The production of the films can be carried out according to the descriptions at columns from [0038] to [0040] in JPA No. 2002-139621. The support may be a film produced by melt film formation.

Plasticizes may be added to the cellulose acetate films in order to improve the mechanical properties of the films and the drying speed. Examples of the plasticizer and the preferred scope of the plasticizers are same as those described at [0043] column in JPA No. 2002-139621.

Anti-degradation agents such as antioxidants, decomposers of peroxides, inhibitors of radicals, in-activators of metals, trapping agents of acids or amines, and UV ray protective agents, may be added to the cellulose acetate film. The anti-degradation agents are described at [0044] column in JPA No. 2002-139621. The preferred example of the anti-degradation agent is butylated hydroxy toluene. UV ray protective agents are described in JPA No. Hei 7-11056 (1995-11056).

In order to improve the adhesiveness of the transparent support to the image layer (in FIG. 1, image-receiving layer), the transparent support may be a surface-treated cellulose acylate film. The surface treatment of a cellulose acylate film and the surface energy of a solid described in paragraphs [0051] and [0052] of Japanese Patent Laid-Open No. 2002-196146 can be applied to the present invention.

In order to improve the adhesiveness of the transparent support to the first and the second alignment films, easy adhesion layers may be formed on the front and the back surfaces of the transparent support.

Other examples of the transparent support include films of cycloolefin polymers, acrylic polymers, polycarbonate polymers, polyester polymers, polystyrene polymers, polyolefin polymers, vinyl chloride polymers, amide polymers, imide polymers, sulfone polymers, polyether sulfone polymers, polyether ether ketone polymers, polyphenylene sulfide polymers, vinylidene chloride polymers, vinyl alcohol polymers, vinyl butyral polymers, acrylate polymers, polyoxymethylene polymers, epoxy polymers, and polymer blends thereof. The polymer film of the present invention may be a hardened layer composed of an ultraviolet hardening resin such as acrylic, urethane, acrylic urethane, epoxy, or silicone resin or of a heat hardening resin.

As the material for forming the transparent support, also preferred is use of thermoplastic norbornene resins. As the thermoplastic norbornene resins, there are mentioned Nippon Zeon's Zeonex and Zeonoa; JSR's Arton, etc.

The thickness of the support is not particularly limited and is usually in the range of 5 to 500 μm, preferably 20 to 250 μm, and more preferably 30 to 180 μm. In optical use, a particularly preferred thickness is in the range of 30 to 110 μm.

### Image Layer

The stereo image print of the present invention has image layers each having a dichroic image on the front and the back surfaces of the transparent support. The image layer may be, for example, a layer of an alignment film having a dichroic image formed thereon or a layer of a molecularly aligned film having a dichroic image formed therein with a permeating dichroic dye. In the former layer, the dichroic dye is preferably a liquid crystalline dichroic dye from the viewpoint of reducing crosstalk and ghost images. An embodiment of image-receiving layers composed of alignment films will be described in detail.

Throughout the specification, the term “alignment film” refers to a film capable of regulating the alignment of liquid crystal molecules. Each alignment film has an alignment axis that regulates the alignment of liquid crystal molecules, and the liquid crystal molecules are aligned according to the alignment axis. In an example, liquid crystal molecules are aligned such that the long axes are parallel to the alignment axis. In another example, liquid crystal molecules are aligned such that the long axes are orthogonal to the alignment axis. In the stereo image print of this embodiment, permeation of the liquid crystalline dichroic dye into the alignment film is not essential. The liquid crystalline dichroic dye having aligning ability aligns along the alignment axis by the regulating force of the alignment film. Accordingly, the materials for the alignment film are not required to be determined depending on the combination with the liquid crystalline dichroic dye used for image formation. In this embodiment, for example, even if the main component of the alignment film is a hydrophilic polymer, an image can be formed with a hydrophobic liquid crystalline dichroic dye.

In this embodiment, the alignment film may have any alignment-regulating ability and may be made of any material that allows the dichroic dye molecules to form a desired alignment state. A typical example of the alignment film is a rubbing alignment film that is an organic compound (preferably a polymer) film having a rubbing-treated surface. The alignment film can also be formed by other means, for example, oblique evaporation of an inorganic compound, formation of a layer having microgrooves, or accumulation of an organic compound (e.g., ω-tricosanoic acid, dioctadecyl methyl ammonium chloride, or methyl stearate) by a Langmuir-Blodgett technique (LB film). Furthermore, an alignment film in which alignment-regulating force is generated by application of an electric field, application of a magnetic field, or light irradiation is also known. In particular, in this embodiment, a rubbing alignment film formed by rubbing treatment is preferred from the viewpoint of easiness in control of the pretilt angle of the alignment film. From the viewpoint of uniformity of alignment, a photoalignment film that is formed by light irradiation is preferred.

### Rubbing Alignment Film

The rubbed alignment layer generally comprises a polymer as the main ingredient thereof. Regarding the polymer material for the alignment layer, a large number of substances are described in literature, and a large number of commercial products are available. The polymer material for use in the invention is preferably polyvinyl alcohol or polyimide, and their derivatives. Especially preferred are modified or unmodified polyvinyl alcohols. Polyvinyl alcohols having a different degree of saponification are known. In the invention, preferred is use of those having a degree of saponification of from 85 to 99 or so. Commercial products are usable here, and for example, “PVA103”, “PVA203” (by Kuraray) and others are PVAs having the above-mentioned degree of saponification. Regarding the rubbed alignment layer, referred to are the modified polyvinyl alcohols described in WO01/88574A1, from page 43, line 24 to page 49, line 8, and Japanese Patent 3907735, paragraphs [0071] to [0095]. Preferably, the thickness of the rubbed alignment layer is from 0.01 to 10 micro meters, more preferably from 0.01 to 1 micro meters.

The rubbing treatment may be attained generally by rubbing the surface of a film formed mainly of a polymer, a few times with paper or cloth in a predetermined direction. A general method of rubbing treatment is described, for example, in “Liquid Crystal Handbook” (published by Maruzen, Oct. 30, 2000).

Regarding the method of changing the rubbing density, employable is the method described in “Liquid Crystal Handbook” (published by Maruzen). The rubbing density (L) is quantified by the following (A):

L=N1(l+2πrn/60v) (A)

wherein N means the rubbing frequency, l means the contact length of the rubbing roller, r means the radius of the roller, n is the rotation number of the roller (rpm), and v means the stage moving speed (per second).

For increasing the rubbing density, the rubbing frequency is increased, the contact length of the rubbing roller is prolonged, the radius of the roller is increased, the rotation number of the roller is increased, the stage moving speed is lowered; but on the contrary, for decreasing the rubbing density, the above are reversed.

The relationship between the rubbing density and the pretilt angle of the alignment layer is that, when the rubbing density is higher, then the pretilt angle is smaller, but when the rubbing density is lower, then the pretilt angle is larger.

For sticking an alignment layer to a long polarizing film of which the absorption axis is in the lengthwise direction thereof, preferably, an alignment layer is formed on a long support of polymer film, and then continuously rubbed in the direction at 45° relative to the lengthwise direction, thereby forming the intended rubbed alignment layer. In this embodiment, on the occasion of forming a dichroic image with the liquid crystalline dichroic dye, it is preferable to perform rubbing treatment at a high rubbing density so as to provide a small pretilt angle and uniform horizontal alignment. That is, the rubbing density L calculated by the expression above is preferably 10 to 1000 mm and more preferably 50 to 500 mm.

### Photoalignment Film

Photo-alignment materials for photo-alignment films that can be used in the present invention may be those described in various documents. Preferred examples of the material for the alignment film of the present invention include azo compounds described in JP-A-s. 2006-285197, 2007-76839, 2007-138138, 2007-94071, 2007-121721, 2007-140465, 2007-156439, 2007-133184, and 2009-109831 and Japanese Patent Nos. 3883848 and 4151746; aromatic ester compounds described in JP-A-2002-229039; maleimide and/or alkenyl-substituted nadimide compounds having photo-alignment units described in JP-A-s. 2002-265541 and 2002-317013; photo-crosslinkable silane derivatives described in Japanese Patent Nos. 4205195 and 4205198; and photo-crosslinkable polyimides, polyamides, and esters described in National Publication of International Patent Application Nos. 2003-520878 and 2004-529220 and Japanese Patent No. 4162850. Particularly preferred are azo compounds and photo-crosslinkable polyimides, polyamides, and esters.

The photoalignment film composed of the above-mentioned material is irradiated with linearly polarized light or unpolarized light to develop an alignment-regulating force. The photoalignment film has an alignment axis along the light irradiation direction.

In the specification, the term “linearly polarized light irradiation” is a process for generating a photoreaction in the photoalignment material. The wavelength of the irradiation light varies depending on the photoalignment material, and any wavelength that can cause the photoreaction can be employed. The peak wavelength of the irradiation light is preferably 200 to 700 nm, and ultraviolet light having a peak wavelength of 400 nm or less is more preferred.

The light source for the light irradiation may be one that is usually used. Examples of the light source include lamps such as a tungsten lamp, a halogen lamp, a xenon lamp, a xenon flash lamp, a mercury lamp, a mercury-xenon lamp, and a carbon arc lamp; various lasers (e.g., a semiconductor laser, a helium-neon laser, an argon ion laser, a helium-cadmium laser, and a YAG laser); light-emitting diodes; and cathode-ray tubes.

The linearly polarized light can be generated by a method using a polarizing plate (e.g., an iodine polarizing plate, dichroic dye polarizing plate, or wire grid polarizing plate), a method using a prism element (e.g., a Glan-Thompson prism) or a reflection polarizer utilizing Brewstar's angle, or a method using light emitted from a polarized laser light source. Alternatively, light having only a necessary wavelength may be selectively employed for irradiation using, for example, a filter or wavelength converter.

In the case of using linearly polarized light for irradiation, the alignment film is irradiated with the light from the upper surface or back surface side in a direction perpendicular or oblique to the alignment film surface. Though the incident angle of the light varies depending on the photoalignment material, for example, it is 0° to 90° (perpendicular), preferably 40° to 90°. For example, when alignment films for forming dichroic images satisfying a relationship shown in FIG. 2 are formed from a photoalignment film irradiated with linearly polarized light, as shown in FIG. 4, one alignment film is irradiated with light from a direction parallel to a first incident plane that is perpendicular to the alignment film surface and is in a direction of −45° in the alignment film plane; and the other alignment film is irradiated with light from a direction parallel to a second incident plane that is perpendicular to the alignment film surface and is in a direction of +45° in the alignment film plane. The alignment film is, however, not limited to this example.

In the case of using unpolarized light for irradiation, the alignment film is irradiated with unpolarized light from an oblique direction. The incident angle is 10° to 80°, preferably 20° to 60°, and most preferably 30° to 50°.

The irradiation time is preferably 1 to 60 minutes, more preferably 1 to 10 minutes.

In the above-described example, the image layer includes the alignment film, but the present invention is not limited thereto. As described above, in the case of using a non-liquid crystalline dichroic dye, the image-receiving layer may be a stretched molecularly aligned film. For example, use of films respectively stretched in directions of −45° and +45° allows formation of dichroic images having absorption axes orthogonal to each other.

### Dichroic Dye

The dichroic dye that is used in formation of an image in the present invention will now be described in detail.

In the present invention, a dichroic dye composition containing at least one kind of azo dichroic dye having nematic liquid crystallinity is preferably used for forming an image. In the present invention, the term “dichroic dye” refers to a dye showing different absorbances depending on the direction. The “dichroism” or “dichroic ratio” is calculated as a ratio of the absorbance in the absorption axis direction to the absorbance in the polarization axis direction of the polarized light in a dichroic dye layer composed of a dichroic dye composition.

The dichroic dye composition in the present invention preferably contains at least one kind of azo dye represented by the following Formula (I), (II), (III), or (IV). The dichroic dyes represented by Formulae (I) to (IV) preferably have nematic liquid crystallinity.

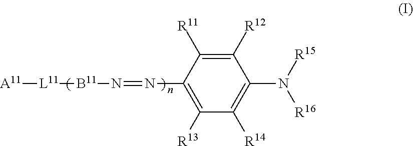

In the formula, R¹¹ to R¹⁴ respectively represent a hydrogen atom or a substituent; R¹⁵ and R¹⁶ respectively represent a hydrogen atom or an optionally-substituted alkyl; L¹¹ represents —N═N—, —CH═N—, —N═CH—, —C(═O)O— or —OC(═O)—; A¹¹ represents an optionally-substituted phenyl, an optionally-substituted naphthyl, or an optionally-substituted aromatic heterocyclic group; B¹¹ represents an optionally-substituted divalent aromatic hydrocarbon group or an optionally-substituted divalent aromatic heterocyclic group; n is an integer from 1 to 4, and B¹¹ may be same or different when n is equal to or more than 2.

Examples of the substituent represented by R¹¹-R¹⁴ respectively include alkyls (preferably C₁₋₂₀, more preferably C₁₋₁₂ and even more preferably C₁₋₈ alkyls such as methyl, ethyl, isopropyl, tert-butyl, n-octyl, n-decyl, n-hexadecyl, cyclopropyl, cyclopentyl and cyclohexyl), alkenyls (preferably C₂₋₂₀, more preferably C₂₋₁₂ and even more preferably C₂₋₈ alkenyls such as vinyl, allyl, 2-butenyl and 3-pentenyl), alkynyls (preferably C₂₋₂₀, more preferably C₂₋₁₂ and even more preferably C₂₋₆ alkynyls such as propargyl and 3-pentynyl), aryls (preferably C₆₋₃₀, more preferably C₆₋₂₀ and even more preferably C₆₋₁₂ aryls such as phenyl, 2,6-diethyl phenyl, 3,5-ditrifluoromethyl phenyl, naphthyl and biphenyl), substituted or non-substituted aminos (preferably C₀₋₂₀, more preferably C₀₋₁₀ and even more preferably C₀₋₆ aminos such as non-substituted amino, ethylamino, dimethylamino, diethylamino and anilino), alkoxys (preferably C₁₋₂₀, more preferably C₁₋₁₀ and even more preferably C₁₋₆ alkoxys such as methoxy, ethoxy and butoxy), oxycarbonyls (preferably C₂₋₂₀, more preferably C₂₋₁₅ and even more preferably C₂₋₁₀ oxycarbonyls such as methoxycarbonyl, ethoxycarbonyl and phenoxycarbonyl), acyloxys (preferably C₂₋₂₀, more preferably C₂₋₄₀ and even more preferably C₂₋₆ acyloxys such as acetoxy and benzoyloxy), acylaminos (preferably C₂₋₂₀, more preferably C₂₋₁₀ and even more preferably C₂₋₆ acylaminos such as acetylamino and benzoylamino), alkoxycarbonylaminos (preferably C₂₋₂₀, more preferably C₂₋₁₀ and even more preferably C₂₋₆ alkoxycarbonylaminos such as methoxycarbonylamino), aryloxycarbonylaminos (preferably C₇₋₂₀, more preferably C₇₋₁₆ and even more preferably C₇₋₁₂ aryloxycarbonylaminos such as phenyloxycarbonylamino), sulfonylaminos (preferably C₁₋₂₀, more preferably C₁₋₁₀ and even more preferably C₁₋₆ sulfonylaminos such as methane sulfonylamino and benzene sulfonylamino), sulfamoyls (preferably C₀₋₂₀, more preferably C_{O-10} and even more preferably C₀₋₆ sulfamoyls such as non-substituted sulfamoyl, methyl sulfamoyl, dimethyl sulfamoyl and phenyl sulfamoyl), carbamoyls (preferably C₁₋₂₀, more preferably C₁₋₁₀ and even more preferably C₁₋₆ carbamoyls such as non-substituted carbamoyl, methyl carbamoyl, diethyl carbamoyl and phenylcarbamoyl), alkylthios (preferably C₁₋₂₀, more preferably C₁₋₁₀ and even more preferably C₁₋₆ alkylthios such as methylthio and ethylthio), arylthios (preferably C₆₋₂₀, more preferably C₆₋₁₆ and even more preferably C₆₋₁₂ arylthios such as phenylthio), sulfonyls (preferably C₁₋₂₀, more preferably C₁₋₁₀ and even more preferably C₁₋₆ sulfonyls such as mesyl and tosyl), sulfinyls (preferably C₁₋₂₀, more preferably C₁₋₁₀ and even more preferably C₁₋₆ sulfinyls such as methane sulfinyl and benzene sulfinyl), ureidos (preferably C₁₋₂₀, more preferably C₁₋₁₀ and even more preferably C₁₋₆ ureidos such as non-substituted ureido, methyl ureido and phenyl ureido), amide phosphate group (preferably C₁₋₂₀, more preferably C₁₋₁₀ and even more preferably C₁₋₆ amide phosphate group such as diethyl amide phosphate and phenyl amide phosphate), hydroxy, mercapto, halogen atoms (for example, fluorine atom, chlorine atom, bromine atom and iodine atom), cyano, nitro, hydroxamic group, imino (—CH═N— or —N═CH—), azo group, heterocyclic group (preferably C₁₋₃₀ and more preferably C₁₋₁₂ heterocyclic group having at least one hetero atom selected from nitrogen atom, oxygen atom, sulfur atom and so on including imidazolyl, pyridyl, quinolyl, furyl, piperidyl, morpholino, benzoxazolyl, benzoimidazolyl and benzothiazolyl), and silyl group (preferably C₃₋₄₀, more preferably C₃₋₃₀ and even more preferably C₃₋₂₄ silyl group such as trimethyl silyl and triphenyl silyl.

These substituents may have one or more substituents. Two or more substituents may be same or different. And they may combine to form a ring.

Preferable examples of R¹¹ to R¹⁴ include a hydrogen atom, alkyl, alkoxy and a halogen atom, more preferably a hydrogen atom, alkyl and alkoxy, and even more preferably a hydrogen atom and methyl.

The optionally-substituted alkyl represented by R¹⁵ or R¹⁶ is preferably a C₁₋₂₀, more preferably C₁₋₁₂ and even more preferably C₁₋₈ alkyl such as methyl, ethyl and n-octyl. Examples of the substituent of the alkyl represented by R¹⁵ or R¹⁶ include those exemplified above as a substituent of any of R¹¹ to R¹⁴. When R¹⁵ or R¹⁶ represents an alkyl, it may combine with R¹² or R¹⁴ to form a ring. Preferably, R¹⁵ and R¹⁶ represent a hydrogen atom or alkyl respectively; and more preferably, R¹⁵ and R¹⁶ represent a hydrogen atom, methyl or ethyl respectively.

In the formula, A¹¹ represents an optionally-substituted phenyl, an optionally-substituted naphthyl or an optionally-substituted aromatic heterocyclic group.

The substituent of the phenyl or the naphthyl may be any substituent having at least one group capable of enhancing the solubility or the nematic liquid crystallinity of the azo compound, any substituent having at least one electron-releasing or electron-attracting group capable of controlling the hue of the azo dye, or any substituent having at least one polymerizable group capable of fixing the alignment of the azo compound. And specific examples thereof include those exemplified above as a substituent of any of R¹¹ to R¹⁴. Preferable examples of the substituent include optionally-substituted alkyls, optionally-substituted alkenyls, optionally-substituted alkynyls, optionally-substituted aryls, optionally-substituted alkoxys, optionally-substituted oxycarbonyls, optionally-substituted acyloxys, optionally-substituted acylaminos, optionally-substituted aminos, optionally-substituted alkoxycarbonylaminos, optionally-substituted sulfonylaminos, optionally-substituted sulfamoyls, optionally-substituted carbamoyls, optionally-substituted alkylthios, optionally-substituted sulfonyls, optionally-substituted ureidos, nitro, hydroxy, cyano, imino, azo and halogen atoms; more preferable examples of the substituent include optionally-substituted alkyls, optionally-substituted alkenyls, optionally-substituted aryls, optionally-substituted alkoxys, optionally-substituted oxycarbonyls, optionally-substituted acyloxys, nitro, imino and azo. Among these substituents, regarding each of those having a carbon atom(s), the preferable range of the number of carbon atoms therein is same as that of the substituent represented by each of R¹¹ to R¹⁴.

The phenyl or the naphthyl may have 1 to 5 substituents selected from the above described examples; and preferably, the phenyl or the naphthyl may have one substituent selected from the above described examples. Regarding the phenyl, preferably, it has one substituent selected from the above described examples at a para-position with respect to L¹¹.

The aromatic heterocyclic group may be preferably derived from a monocyclic or bicyclic hetero-ring. The atom, embedded in the aromatic heterocyclic group, other than a carbon atom may be a nitrogen, sulfur or oxygen atom. Two or more hetero atoms embedded in the aromatic heterocyclic group may be same or different from each other. Examples of the aromatic heterocyclic group include pyridyl, quinolyl, thiophenyl, thiazolyl, benzothiazolyl, thiadiazolyl, quinolonyl, naphthalimidoyl, and thienothiazoly.

Preferably, the aromatic heterocyclic group is pyridyl, quinolyl, thiazolyl, benzothiazolyl, thiadiazolyl, or thienothiazoly; and more preferably, the aromatic heterocyclic group is pyridyl, benzothiazolyl, or thienothiazoly.

Preferably, A¹¹ represents optionally-substituted phenyl, pyridyl, benzothiazolyl, or thienothiazoly.

In the formula, B¹¹ represents an optionally-substituted divalent aromatic hydrocarbon group or an optionally-substituted divalent aromatic heterocyclic group. In the formula, n is an integer from 1 to 4, and B¹¹ may be same or different when n is equal to or more than 2.

Preferable examples of the aromatic hydrocarbon group include phenyl and naphthyl. Preferable examples of the substituent of the aromatic hydrocarbon group include optionally-substituted alkyls, optionally-substituted alkoxys, hydroxy, nitro, halogen atoms, optionally-substituted aminos, optionally-substituted acylaminos and cyano. Among these, optionally-substituted alkyls, optionally-substituted alkoxys and halogen atoms are more preferable; and methyl and halogen atoms are even more preferable.

The aromatic heterocyclic group may be preferably derived from a monocyclic or bicyclic hetero-ring. The atom, embedded in the aromatic heterocyclic group, other than a carbon atom may be a nitrogen, sulfur or oxygen atom. Two or more hetero atoms embedded in the aromatic heterocyclic group may be same or different from each other. Examples of the aromatic heterocyclic group include pyridyl, quinolyl, isoquinolyl, benzothiadiazole, phthalimide, and thienothiazole. Among these, thienothiazole is more preferable.

Examples of the substituent of the aromatic heterocyclic group include alkyls such as methyl and ethyl; alkoxys such as methoxy and ethoxy; aminos such as non-substituted amino and methyl amino; acetylaminos, acylaminos, nitro, hydroxy, cyano and halogen atoms. Among these substituents, regarding each of those having a carbon atom(s), the preferable range of the number of carbon atoms therein is same as that of the substituent represented by each of R¹¹ to R¹⁴.

Preferable examples of the azo dye include those represented by any one of formulas (Ia) to (Ib).

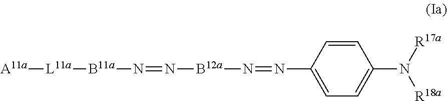

In the formula, R^{17a} and R^{18a} respectively represent a hydrogen atom, methyl or ethyl; L^{11a} represents —N═N—, —N═CH—, —O(C═O)— or —CH═CH—; A^{11a} represents a group (Ia-II) or (Ia-III); and B^{11a} and B^{12a} respectively represent a group (Ia-IV), (Ia-V) or (Ia-VI).

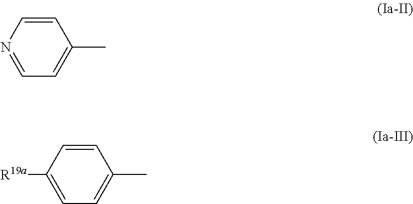

In the formula, R^{19a} represent an optionally-substituted alkyl, an optionally-substituted aryl, an optionally-substituted alkoxy, an optionally-substituted oxycarbonyl, or an optionally-substituted acyloxy.

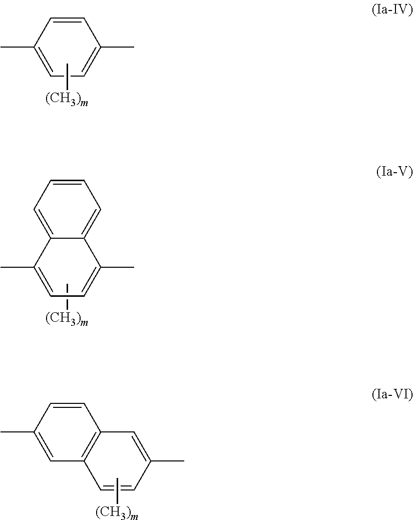

In the formulas, m represents an integer of from 0 to 2.

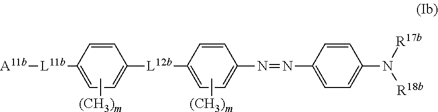

In the formula, R^{17b} and R^{18b} respectively represent a hydrogen atom, methyl or ethyl; L^{11b} represents —N═N— or —(C═O)O—; L^{12b} represents —N═CH—, —(C═O)O— or —O(C═O)—; A^{11b} represents a group (Ib-II) or (Ib-III); and m represents an integer of from 0 to 2.

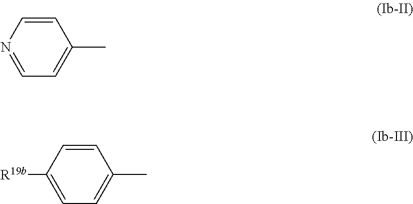

In the formula, R^{19a} represents an optionally-substituted alkyl, an optionally-substituted aryl, an optionally-substituted alkoxy, an optionally-substituted oxycarbonyl, or an optionally-substituted acyloxy.

Examples of the substituent of each of the groups in formulas (Ia) and (Ib) include those exemplified above as a substituent of any of R¹¹ to R¹⁴. Among these substituents, regarding each of those (such as alkyls) having a carbon atom(s), the preferable range of the number of carbon atoms therein is same as that of the substituent represented by each of R¹¹ to R¹⁴.

The compound represented by formula (I), (Ia) and (Ib) may have one or more polymerizable groups as a substituent. Using the compound having one or more polymerizable groups may contribute to improvement in hardenability. Examples of the polymerizable group include an unsaturated polymerizable group, epoxy group and aziridinyl group; an unsaturated polymerizable group is preferable; and an ethylene unsaturated polymerizable group is more preferable. Examples of the ethylene unsaturated polymerizable group include an acryloyl group and a methacryloyl group.

Preferably, the polymerizable group(s) exists at the molecular end, that is, preferably, the polymerizable group(s) exists as a substituent of R¹⁵ and/or R¹⁶ or as a substituent of A¹¹ in formula (I).

Examples of the compound represented by formula (I) include, but are not limited to, those described below.

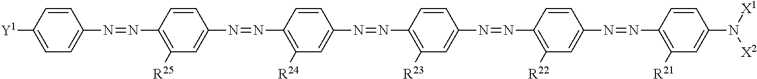

| No. | X¹ | X² | R²¹ | R²² | R²³ | R²⁴ | R²⁵ | Y¹ |
|---|---|---|---|---|---|---|---|---|
| A-1 | —C₂H₅ | —C₂H₅ | —H | —CH₃ | —H | —H | —H | C₄H₉ |
| A-2 | —C₂H₅ | —C₂H₅ | —H | —CH₃ | —CH₃ | —CH₃ | —H | C₄H₉ |
| A-3 | —CH₃ | —CH₃ | —H | —CH₃ | —H | —H | —H | C₄H₉ |

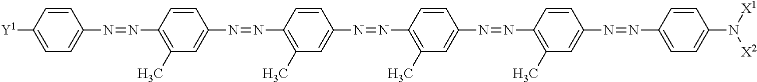

| No. | X¹ | X² | Y¹ |
|---|---|---|---|
| A-4 | —C₂H₅ | —C₂H₅ | 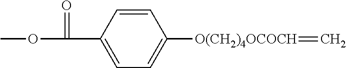 |
| A-5 | —C₂H₅ | —C₂H₅ | 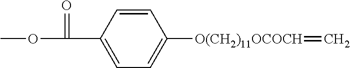 |

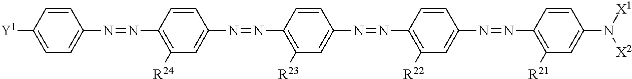

| No. | X¹ | X² | R²¹ | R²² | R²³ | R²⁴ | Y¹ |
|---|---|---|---|---|---|---|---|
| A-9 | —C₂H₅ | —C₂H₅ | —H | —CH₃ | —H | —H | C₄H₉ |
| A-10 | —C₂H₅ | —C₂H₅ | —CH₃ | —CH₃ | —H | —H | C₄H₉ |
| A-11 | —C₂H₅ | —C₂H₅ | —H | —CH₃ | —CH₃ | —CH₃ | C₄H₉ |
| A-15 | —C₂H₅ | —C₂H₅ | —H | —CH₃ | —CH₃ | —CH₃ | 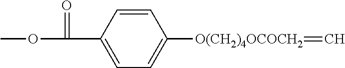 |

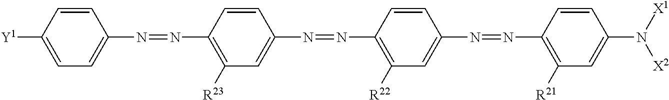

| No. | X¹ | X² | R²¹ | R²² | R²³ | Y¹ |
|---|---|---|---|---|---|---|
| A-16 | —C₂H₅ | —C₂H₅ | —H | —CH₃ | —H | C₄H₉ |
| A-17 | —C₂H₅ | —C₂H₅ | —H | —CH₃ | —CH₃ | C₄H₉ |
| A-18 | —C₂H₅ | —C₂H₅ | —H | —CH₃ | —H | 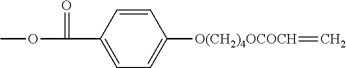 |
| A-19 | —C₂H₅ | —C₂H₅ | —H | —CH₃ | —H | 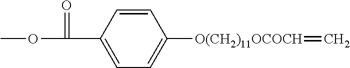 |
| A-24 | —C₂H₅ | —C₂H₅ | —OCH₃ | —CH₃ | —H | C₄H₉ |
| A-25 | —C₂H₅ | —C₂H₅ | —H | —CH₃ | —CH₃ | 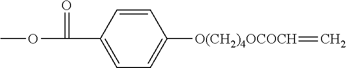 |

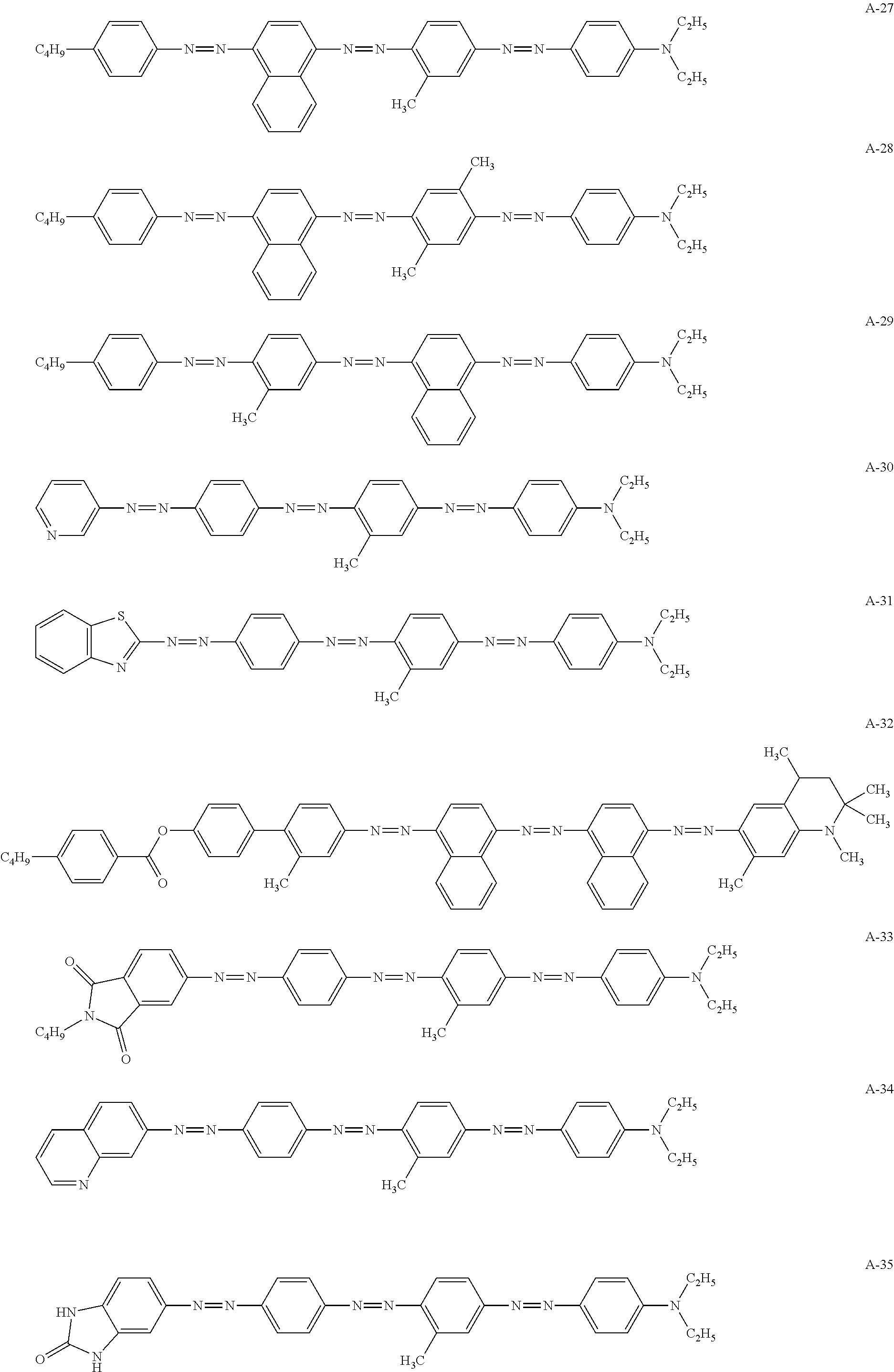

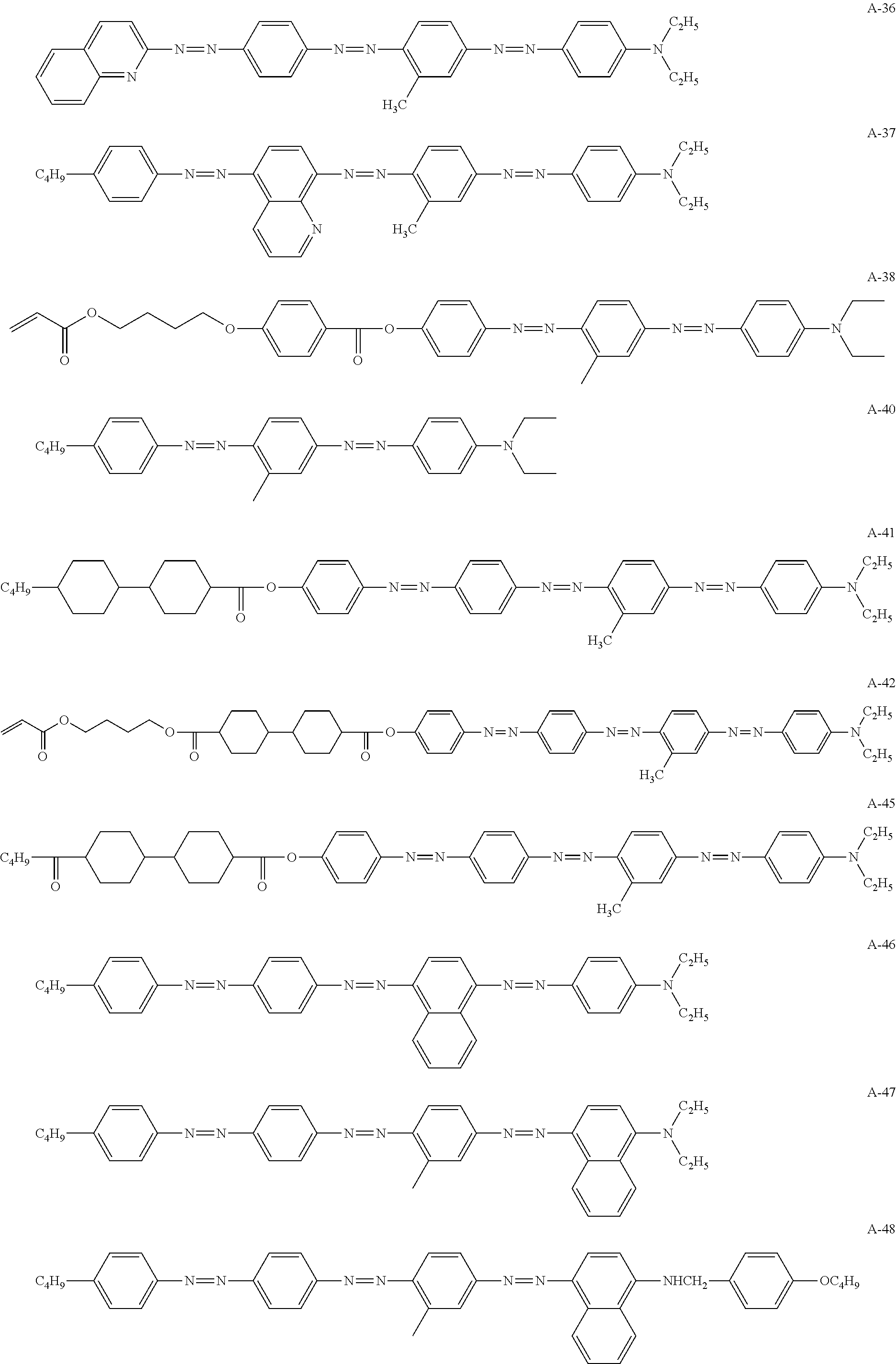

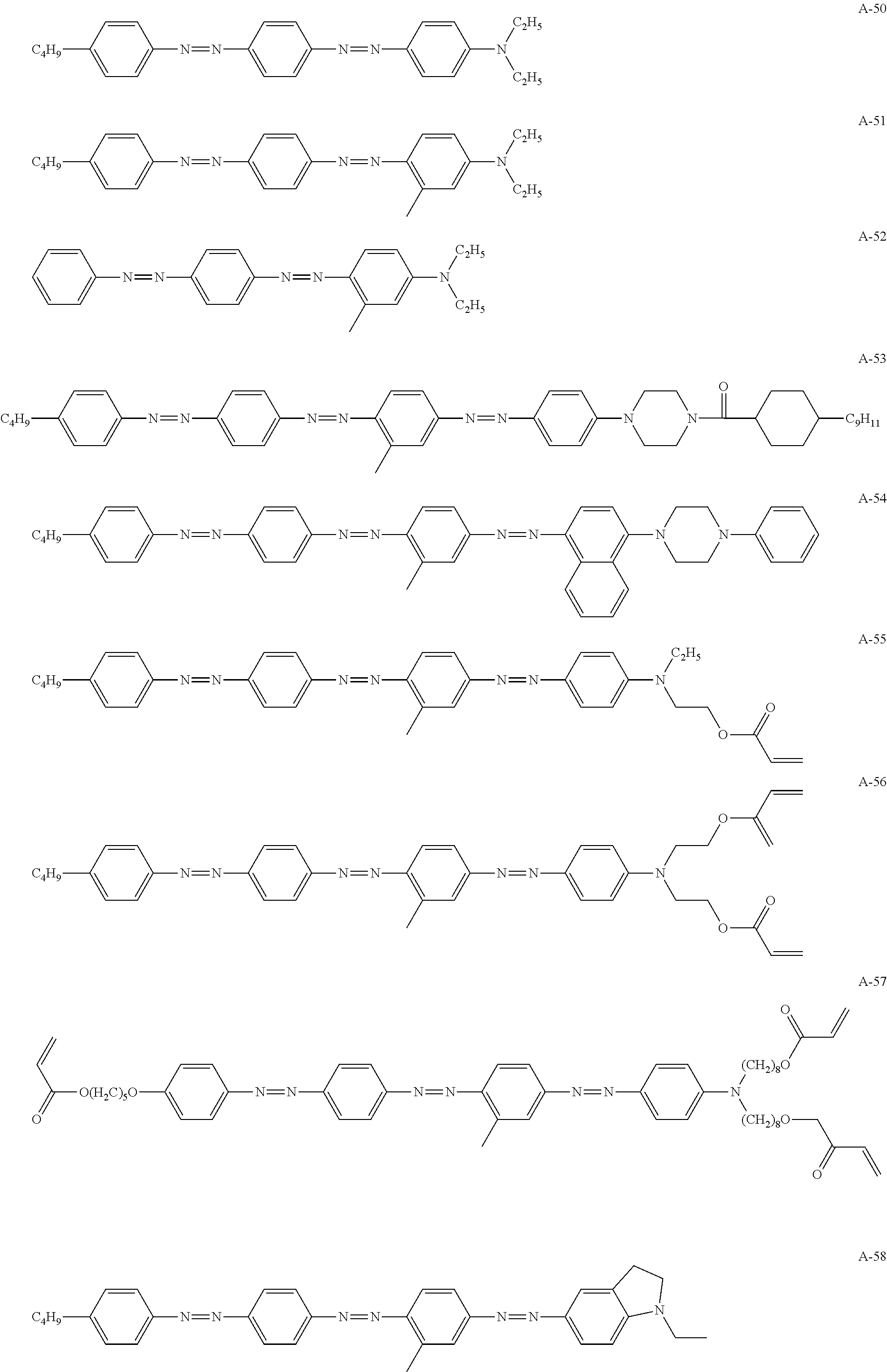

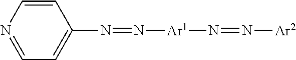

| compound | Ar¹ | Ar² |
|---|---|---|
| B-1 | 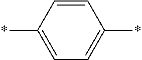 [SMILES: *c1ccc(*)cc1] | 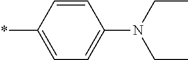 [SMILES: *c1ccc(N(CC)CC)cc1] |
| B-2 | 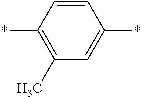 [SMILES: *c1ccc(*)c(C)c1] | 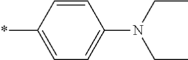 [SMILES: *c1ccc(N(CC)CC)cc1] |
| B-3 | 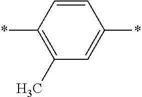 [SMILES: *c1ccc(*)c(C)c1] | 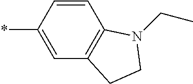 [SMILES: *c1ccc2c(c1)CCN2CC] |

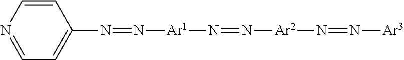

| compound | Ar¹ | Ar² | Ar³ |
|---|---|---|---|
| B-4 | 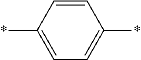 [SMILES: *c1ccc(*)cc1] | 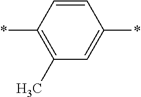 [SMILES: *c1ccc(*)c(C)c1] | 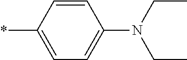 [SMILES: *c1ccc(N(CC)CC)cc1] |
| B-5 | 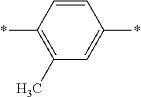 [SMILES: *c1ccc(*)c(C)c1] | 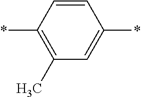 [SMILES: *c1ccc(*)c(C)c1] | 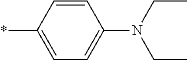 [SMILES: *c1ccc(N(CC)CC)cc1] |
| B-6 | 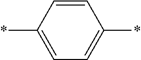 [SMILES: *c1ccc(*)cc1] | 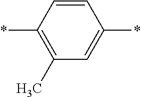 [SMILES: *c1ccc(*)c(C)c1] | 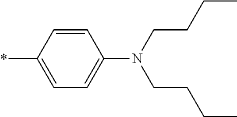 [SMILES: *c1ccc(N(CCCC)CCCC)cc1] |
| B-7 | 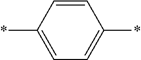 [SMILES: *c1ccc(*)cc1] | 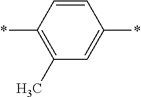 [SMILES: *c1ccc(*)c(C)c1] | 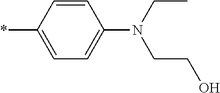 [SMILES: *c1ccc(N(CC)CCO)cc1] |
| B-8 | 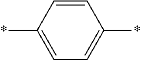 [SMILES: *c1ccc(*)cc1] | 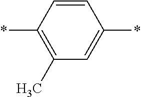 [SMILES: *c1ccc(*)c(C)c1] | 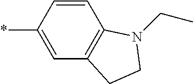 [SMILES: *c1ccc2c(c1)CCN2CC] |
| B-9 | 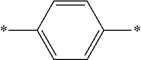 [SMILES: *c1ccc(*)cc1] | 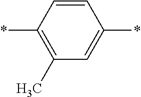 [SMILES: *c1ccc(*)c(C)c1] | 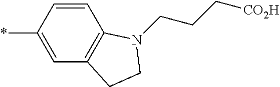 [SMILES: *c1ccc2c(c1)CCN2CCCC(=O)O] |

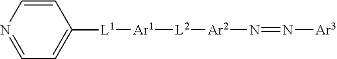

| compound | L¹ | Ar¹ | L² | Ar² | Ar³ |
|---|---|---|---|---|---|
| B-10 | *—N═N—* | 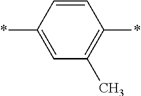 [SMILES: *c1ccc(*)c(C)c1] | 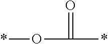 [SMILES: *OC(*)=O] | 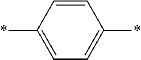 [SMILES: *c1ccc(*)cc1] | 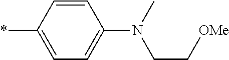 [SMILES: *c1ccc(N(C)CCOC)cc1] |
| B-11 | *—N═N—* | 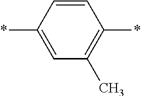 [SMILES: *c1ccc(*)c(C)c1] | 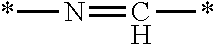 [SMILES: *C=N*] | 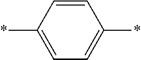 [SMILES: *c1ccc(*)cc1] | 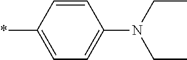 [SMILES: *c1ccc(N(CC)CC)cc1] |
| B-12 | 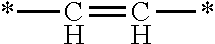 [SMILES: *C=C*] | 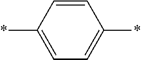 [SMILES: *c1ccc(*)cc1] | 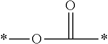 [SMILES: *OC(*)=O] | 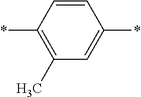 [SMILES: *c1ccc(*)c(C)c1] | 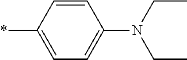 [SMILES: *c1ccc(N(CC)CC)cc1] |

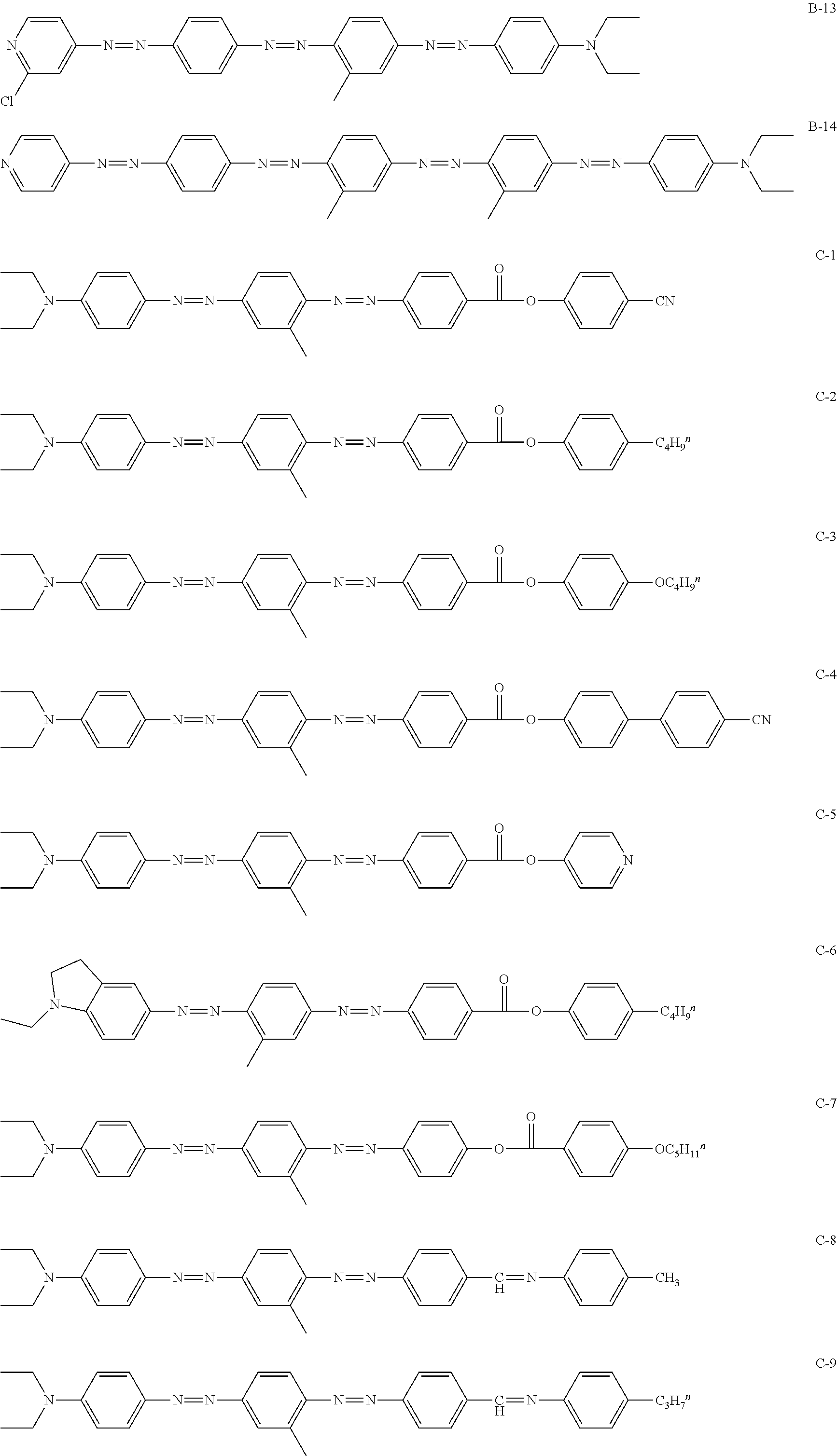

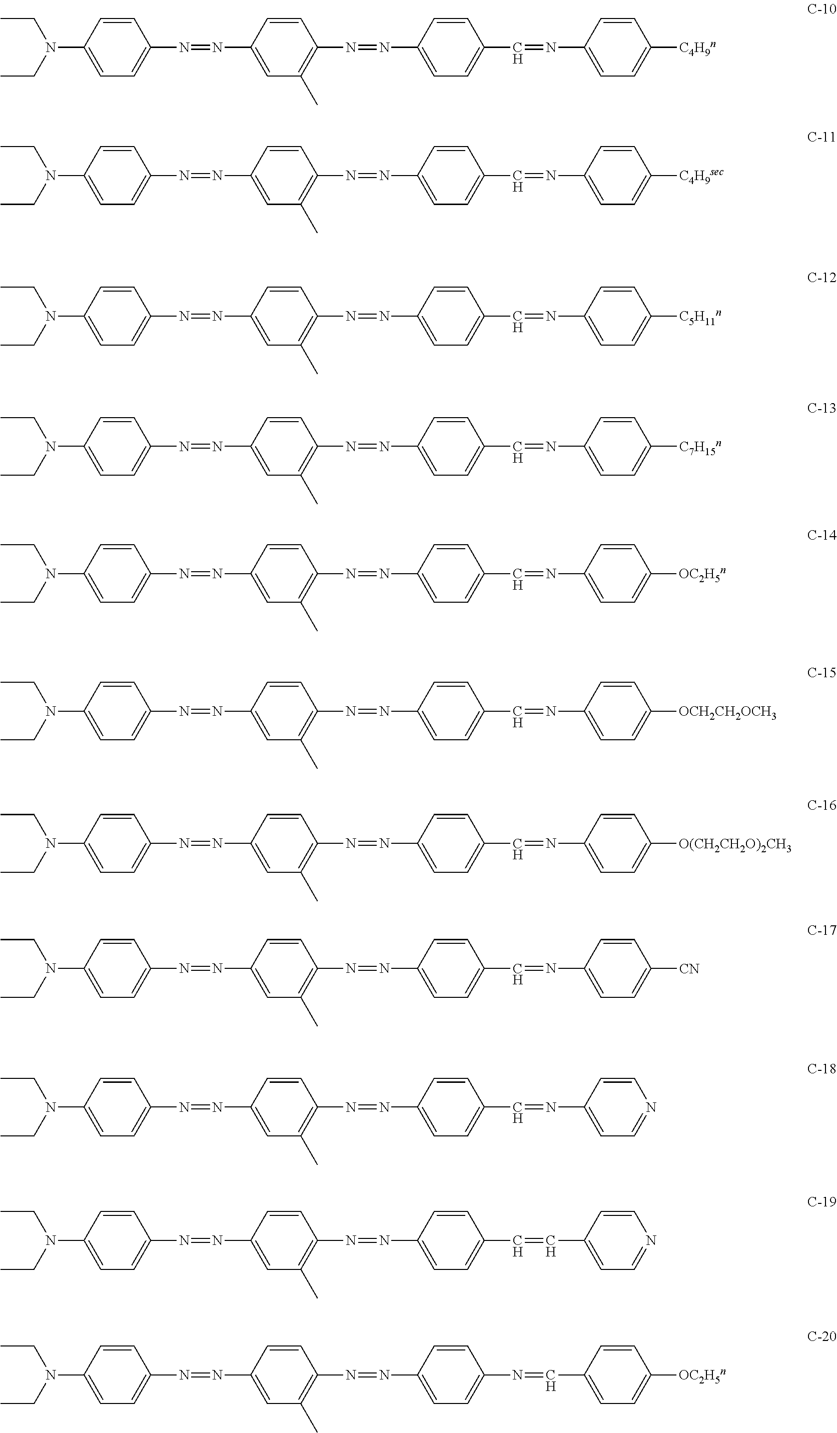

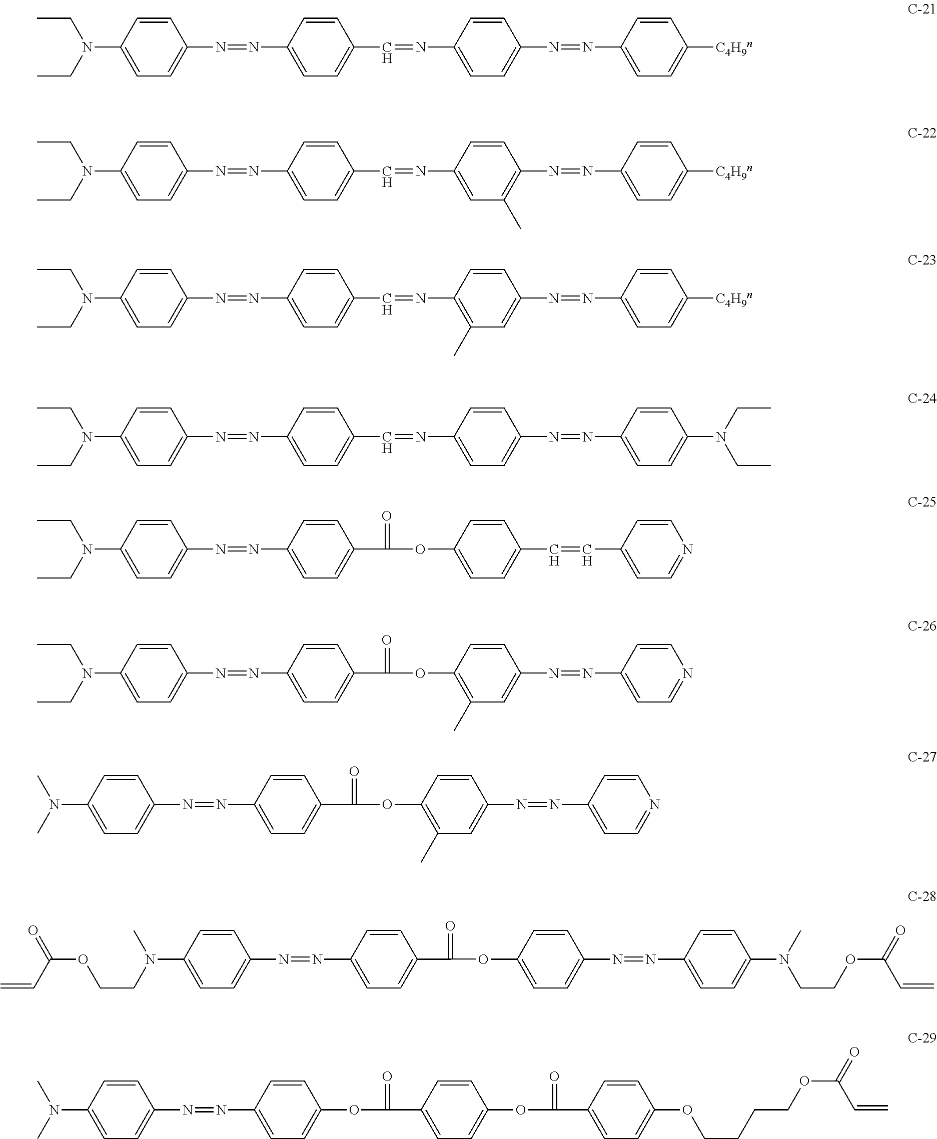

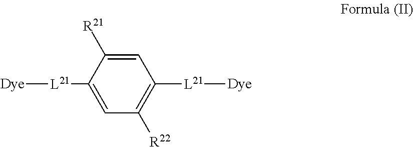

In the formula, R²¹ and R²² each represent a hydrogen atom, an alkyl group, an alkoxy group or a substituent represented by -L²²-Y provided that at least one of them represents a group other than a hydrogen atom. L²² represents an alkylene group, and one CH₂ group or non-adjacent two or more CH₂ groups present in the alkylene group may each be substituted with —O—, —COO—, —OCO—, —OCOO—, —NRCOO—, —OCONR—, —CO—, —S—, —SO₂—, —NR—, —NRSO₂— or —SO₂NR— (R represents a hydrogen atom or an alkyl group having 1 to 4 carbons). Y represents a hydrogen atom, a hydroxy group, an alkoxy group, a carboxyl group, a halogen atom or a polymerizable group.

Particularly, it is preferable that one of R²¹ and R²² is a hydrogen atom or an approximately C₁ to C₄ short chain substituent and the other of R²¹ and R²² is an approximately C₅ to C₃₀ long chain substituent, since solubility is further improved in this case. In general, it is well known that the molecular shape and anisotropy of polarizability and the like significantly affect realization of liquid crystallinity, and details thereof are described in the Liquid Crystal Handbook (2000, Maruzen) and the like. A typical skeleton of a rod-shaped liquid crystal molecule is composed of a rigid mesogen and flexible end chains along the molecular long axis direction, and in general, lateral substituents along the molecular short axis direction corresponding to R²¹ and R²² in the formula (II) are small substituents not disrupting rotation of the molecule, or substituents are not present. As examples characterized in lateral substituents, examples of stabilization of a smectic phase by introducing a hydrophilic (for example, ionic) lateral substituent are known, however, there are scarcely known examples realizing a stable nematic phase. Particularly, examples in which solubility is improved without lowering the degree of orientation order, by introducing a long chain substituent into a specific substitution position of a rod-shaped liquid crystalline molecule realizing a nematic phase are not known at all.

The alkyl group each represented by R²¹ and R²² includes C₁ to C₃₀ alkyl groups. As examples of the above-described short chain alkyl group, C₁ to C₉ groups are preferable and C₁ to C₄ groups are more preferable. On the other hand, as the above-described long chain alkyl group, C₅ to C₃₀ groups are preferable, C₁₀ to C₃₀ groups are more preferable and C₁₀ to C₂₀ groups are further preferable.

The alkoxy group each represented by R²¹ and R²² includes C₁ to C₃₀ alkoxy groups. As examples of the above-described short chain alkoxy group, C₁ to C₈ groups are preferable and C₁ to C₃ groups are more preferable. On the other hand, as the above-described long chain alkoxy group, C₅ to C₃₀ groups are preferable, C₁₀ to C₃₀ groups are more preferable and C₁₀ to C₂₀ groups are further preferable.

As the alkylene group represented by L²² in the substituent represented by -L²²-Y each represented by R²¹ and R²², C₅ to C₃₀ groups are preferable, C₁₀ to C₃₀ groups are more preferable and C₁₀ to C₂₀ groups are further preferable. One CH₂ group or non-adjacent two or more CH₂ groups present in the above-described alkylene group may each be substituted with at least one selected from the group of divalent groups consisting of —O—, —COO—, —COO—, —OCOO—, —NRCOO—, —OCONR—, —CO—, —S—, —SO₂—, —NR—, —NRSO₂— and —SO₂NR— (R represents a hydrogen atom or an alkyl group having 1 to 4 carbons). Of course, one CH₂ group or non-adjacent two or more CH₂ groups may also be substituted with two or more groups selected from the group of the above-described divalent groups. CH₂ situated at the end of L²² and linking to Y may be substituted with any of the above-described divalent groups. Further, CH₂ situated at the end of L²² and linking to a phenyl group may be substituted with any of the above-described divalent groups.

Particularly, it is preferable that L²² is an alkyleneoxy group or contains an alkyleneoxy group, and it is further preferable that L²² is a polyethyleneoxy group represented by —(OCH₂CH₂)ₚ— (here, p represents a number of 3 or more, preferably 3 to 10, more preferably 3 to 6) or contains a polyethyleneoxy group, from the standpoint of improvement in solubility.

Examples of -L²²- include, but are not limited to, the following examples. In the following formulae, q is a number of 1 or more, preferably 1 to 10, more preferably 2 to 6. r is 5 to 30, preferably 10 to 30, more preferably 10 to 20.

—(OCH₂CH₂)ₚ—

—(OCH₂CH₂)ₚ—O—(CH₂)_{q}—

—(OCH₂CH₂)ₚ—OC(═O)—(CH₂)_{q}—

—(OCH₂CH₂)ₚ—OC(═O)NH—(CH₂)_{q}—

—O(CH₂)ᵣ—

—(CH₂)ᵣ—

Y in the substituent represented by -L²²-Y each represented by R²¹ and R²² represents a hydrogen atom, a hydroxy group, an alkoxy group (preferably a C₁ to C₁₀ alkoxy group, more preferably a C₁ to C₅ alkoxy group), a carboxyl group, a halogen atom or a polymerizable group.

By combining L²² with Y, the end of -L²²-Y can be, for example, a substituent reinforcing the intermolecular interaction such as a carboxyl group, an amino group, an ammonium group and the like, and can be a leaving group such as a sulfonyloxy group, a halogen atom and the like.

The end of -L²²-Y may be a substituent forming a covalent bond to another molecule, such as a crosslinkable group, a polymerizable group and the like, and may also be a polymerizable group such as, for example, —O—C(═O)CH═CH₂, —O—C(═O)C(CH₃)═CH₂ and the like.

When used as a material for a curing film, Y is preferably a polymerizable group (however, here, even if the compound of the above-described formula (II) has no polymerizable group, when a compound to be used together is polymerizable, the alignment of the compound of the formula (II) can be fixed by promoting the polymerization reaction of the other compound). The polymerization reaction is preferably an addition polymerization (including ring-opening polymerization) or a condensation polymerization. That is, it is preferable that the polymerizable group is a functional group capable of performing an addition polymerization reaction or a condensation polymerization reaction. Examples of the polymerizable group represented by the above-described formula include an acrylate group represented by the following formula (M-1) and a methacrylate group represented by the following formula (M-2).

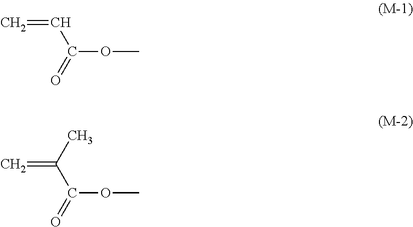

Also, ring-opening polymerizable groups are preferable, and for example, cyclic ether groups are preferable, an epoxy group or an oxetanyl group is more preferable and an epoxy group is particularly preferable.

L²¹s in the above-described formula (II) each represent a linking group selected from the group consisting of an azo group (—N═N—), a carbonyloxy group (—C(═O)O—), an oxycarbonyl group (—O—C(═O)—), an imino group (—N═CH—) and a vinylene group (—C═C—). Among them, a vinylene group is preferable.

Dyes in the above-described formula (II) each represent an azo dye residue represented by the following formula (IIa).

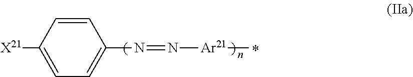

In the formula (IIa), * represents a linkage part to L²¹; X²¹ represents a hydroxy group, a substituted or un-substituted alkyl group, a substituted or un-substituted alkoxy group, an un-substituted amino group or a mono or dialkylamino group; Ar²¹s each represent an aromatic hydrocarbon ring optionally having a substituent or aromatic hetero ring optionally having a substituent; n represents an integer of 1 to 3, and when n is 2 or more, a plurality of Ar²¹s may be mutually the same or different.

The alkyl group represented by X²¹ is preferably a C₁ to C₁₂ alkyl group and more preferably a C₁ to C₆ alkyl group. Specifically, a methyl group, an ethyl group, a propyl group, a butyl group and the like are mentioned. The alkyl group may have a substituent, and examples of the substituent include a hydroxy group, a carboxyl group and a polymerizable group. Preferable examples of the polymerizable group are the same as the preferable examples of the polymerizable group represented by described above.

The alkoxy group represented by X²¹ is preferably a C₁ to C₂₀ alkoxy group, more preferably a C₁ to C₁₀ alkoxy group and further preferably a C₁ to C₆ alkoxy group. Specifically, a methoxy group, an ethoxy group, a propyloxy group, a butoxy group, a pentaoxy group, a hexaoxy group, a heptaoxy group, an octaoxy group and the like are mentioned. The alkoxy group may have a substituent, and examples of the substituent include a hydroxy group, a carboxyl group and a polymerizable group. Preferable examples of the polymerizable group are the same as the preferable examples of the polymerizable group represented by Y described above.

The substituted or un-substituted amino group represented by X²¹ is preferably a C₀ to C₂₀ amino group, more preferably a C₀ to C₁₀ amino group and further preferably a C₀ to C₆ amino group. Specifically, an un-substituted amino group, a methylamino group, a dimethylamino group, a diethylamino group, a methyl hexylamino group, an anilino group and the like are mentioned.

Among them, X²¹ is preferably an alkoxy group.

In the above-described formula (II), Ar²¹ represents an aromatic hydrocarbon ring group optionally having a substituent or aromatic heterocyclic group optionally having a substituent. Examples of the aromatic hydrocarbon ring group and the aromatic heterocyclic group include a 1,4-phenylene group, a 1,4-naphthylene group, a pyridine ring group, a pyrimidine ring group, a pyrazine ring group, a quinoline ring group, a thiophene ring group, a thiazole ring group, a thiadiazole ring group, a thienothiazole ring group and the like. Among them, a 1,4-phenylene group, a 1,4-naphthylene group and a thienothiazole ring group are preferable and a 1,4-phenylene group is most preferable.

The substituent that Ar²¹ optionally has includes preferably an alkyl group having 1 to 10 carbons, a hydroxy group, an alkoxy group having 1 to 10 carbons, a cyano group and the like, more preferably an alkyl group having 1 to 2 carbons and an alkoxy group having 1 to 2 carbons.

n is preferably 1 or 2 and more preferably 1.

Examples of the compound represented by the above-described formula (II) include compounds represented by the following formula (IIb). The meaning of each symbol in the formula is the same as those in the formula (II), and also the preferable range thereof is the same as for the formula (II).

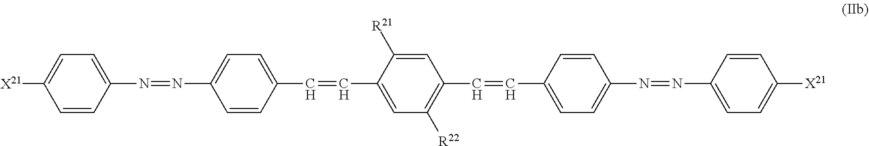

In the formula, it is preferable that X²¹s are mutually the same or different and represent a C₁₋₁₂ alkoxy group; it is preferable that R²¹ and R²² are mutually different, and it is preferable that one of R²¹ and R²² is a hydrogen atom or a C₁ to C₄ short chain substituent (an alkyl group, an alkoxy group or a substituent represented by -L²²-Y) and the other of R²¹ and R²² is a C₅ to C₃₀ long chain substituent (an alkyl group, an alkoxy group or a substituent represented by -L²²-Y). Alternatively, it is also preferable that R²¹ and R²² each represent a substituent represented by -L²²-Y and L²² is an alkyleneoxy group or contains an alkyleneoxy group.

Specific examples of the compound represented by the above-described formula (II) include, but are not limited to, the following compound examples.

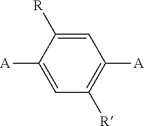

| | A | R | R′ |
|---|---|---|---|
| A2-1 | 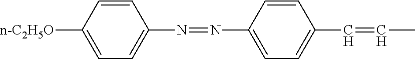 | MeO | —(OCH₂CH₂)₃—OMe |
| A2-2 | 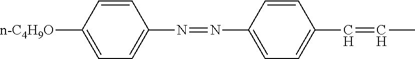 | MeO | —(OCH₂CH₂)₃—OMe |
| A2-3 | 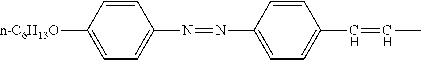 | MeO | —(OCH₂CH₂)₃—OMe |
| A2-4 | 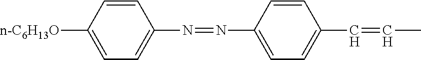 | MeO | —(OCH₂CH₂)₃—OH |
| A2-5 | 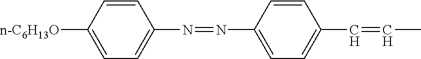 | MeO | —(OCH₂CH₂)₆—OH |
| A2-6 | 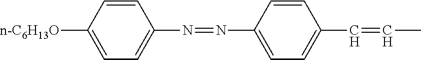 | MeO | 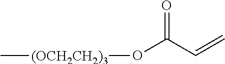 |
| A2-7 | 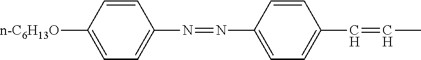 | MeO | 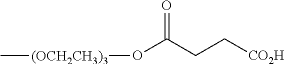 |
| A2-8 | 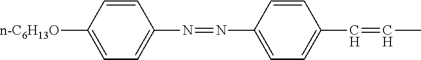 | MeO | 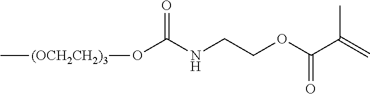 |
| A2-9 | 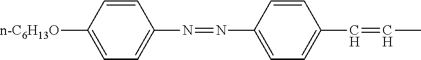 | MeO | —OC₁₈H₃₇-n |
| A2-10 | 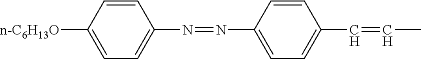 | —(OCH₂CH₂)₃—OMe | —(OCH₂CH₂)₃—OMe |
| A2-11 | 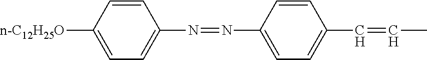 | MeO | —(OCH₂CH₂)₃—OMe |
| A2-12 | 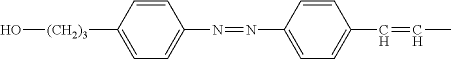 | MeO | —(OCH₂CH₂)₃—OH |
| A2-13 | 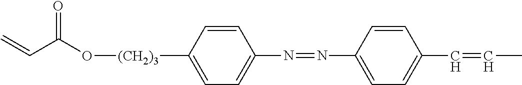 | MeO | 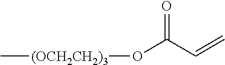 |
| A2-14 | 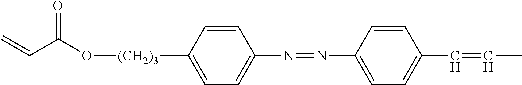 | MeO | —(OCH₂CH₂)₃—OMe |
| A2-15 | 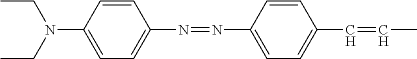 | MeO | —(OCH₂CH₂)₃—OH |
| A2-16 | 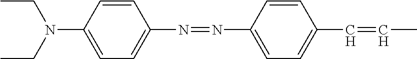 | MeO | —OC₁₈H₃₇-n |
| A2-17 | 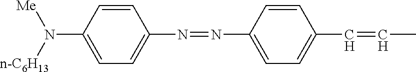 | MeO | —(OCH₂CH₂)₃—OH |
| A2-18 | 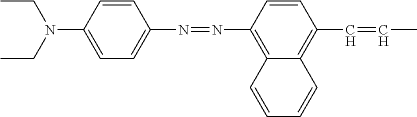 | MeO | —(OCH₂CH₂)₃—OH |
| A2-19 | 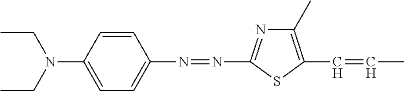 | MeO | —(OCH₂CH₂)₃—OH |
| A2-20 | 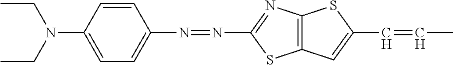 | MeO | —(OCH₂CH₂)₃—OH |
| A2-21 | 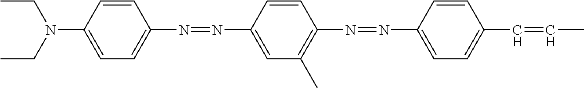 | MeO | —(OCH₂CH₂)₃—OH |
| A2-22 | 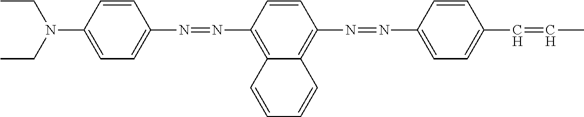 | MeO | —(OCH₂CH₂)₃—OH |
| A2-23 | 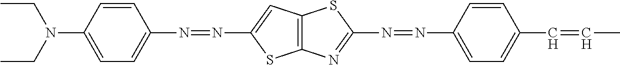 | MeO | —(OCH₂CH₂)₃—OH |
| A2-24 | 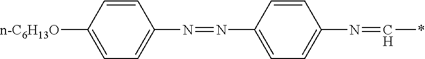 | MeO | *—(OCH₂CH₂)₃—OH |
| A2-25 | 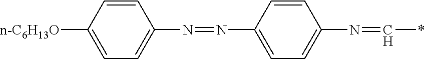 | MeO | *—OC₁₂H₂₅-n |
| A2-26 | 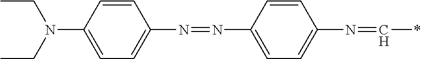 [SMILES: *C=Nc1ccc(N=Nc2ccc(N(CC)CC)cc2)cc1] | MeO | *—(OCH₂CH₂)₃—OH |
| A2-27 | 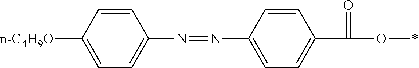 | MeO | *—(OCH₂CH₂)₆—OH |
| A2-28 | 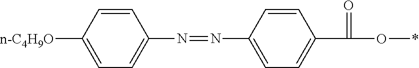 | H | *—OC₁₈H₃₇-n |
| A2-29 | 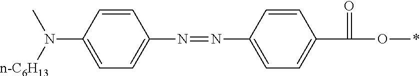 | MeO | *—(OCH₂CH₂)₃—OMe |
| A2-30 | 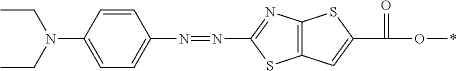 [SMILES: *OC(=O)c1cc2sc(N=Nc3ccc(N(CC)CC)cc3)nc2s1] | MeO | *—(OCH₂CH₂)₃—OH |
| A2-31 | 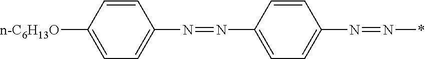 | MeO | *—(OCH₂CH₂)₃—OH |
| A2-32 | 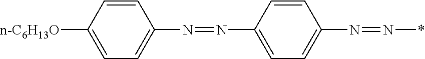 | MeO | *—(OCH₂CH₂CH₂)₃—OH |
| A2-33 | 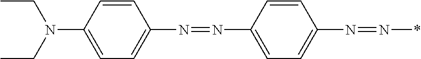 [SMILES: *N=Nc1ccc(N=Nc2ccc(N(CC)CC)cc2)cc1] | MeO | *—(OCH₂CH₂)₃—OMe |
| A2-34 | 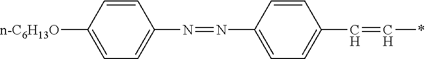 | MeO | MeO |

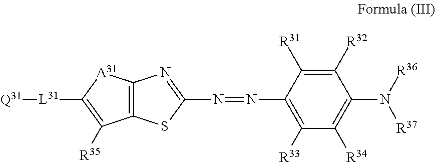

In the formula, R³¹ to R³⁵ each represent independently a hydrogen atom or a substituent; R³⁶ and R³⁷ each represent independently a hydrogen atom or an alkyl group optionally having a substituent; Q³¹ represents an aromatic hydrocarbon group optionally having a substituent, an aromatic heterocyclic group optionally having a substituent or a cyclohexane ring group optionally having a substituent; L³¹ represents a divalent linking group; A³¹ represents an oxygen atom or a sulfur atom.

Examples of the substituent represented by R³¹ to R³⁵ are the same as the examples of the substituent each represented by R¹¹ to R¹⁴ in the above-described formula (I). The examples thereof include preferably a hydrogen atom, an alkyl group, an alkoxy group and a halogen atom, particularly preferably a hydrogen atom, an alkyl group and an alkoxy group and most preferably a hydrogen atom or methyl group.

The alkyl group optionally having a substituent represented by R³⁶ and R³⁷ in the above-described formula (III) is an alkyl group preferably having 1 to 20 carbons, more preferably having 1 to 12 carbons and particularly preferably having 1 to 8 carbons, and examples thereof include a methyl group, an ethyl group, an n-octyl group and the like. The substituent on the alkyl group represented by R³⁶ and R³⁷ is the same as the substituent represented by R³¹ to R³⁵ described above. When R³⁶ and R³⁷ represent an alkyl group, they may be mutually linked to form a cyclic structure. When R³⁶ or R³⁷ represents an alkyl group, each of them may be linked to R³² or R³⁴ form a cyclic structure.

The group represented by R³⁶ and R³⁷ is particularly preferably a hydrogen atom or an alkyl group and further preferably a hydrogen atom, a methyl group or an ethyl group.

In the above-described formula (III), Q³¹ represents an aromatic hydrocarbon group optionally having a substituent (preferably having 1 to 20 carbons and more preferably having 1 to 10 carbons, and examples thereof include a phenyl group, a naphthyl group and the like), an aromatic heterocyclic group optionally having a substituent or a cyclohexane ring group optionally having a substituent.

The substituent optionally carried on the group represented by Q³¹ is preferably a group introduced to enhance solubility or nematic liquid crystallinity of an azo compound, group having an electron donative property or an electron withdrawing property introduced to adjust the color tone as a dye or a group having a polymerizable group introduced to fix alignment, and specifically, is the same as the substituent represented by R³¹ to R³⁵ described above. Preferable are an alkyl group optionally having a substituent, an alkenyl group optionally having a substituent, an alkynyl group optionally having a substituent, an aryl group optionally having a substituent, an alkoxy group optionally having a substituent, an oxycarbonyl group optionally having a substituent, an acyloxy group optionally having a substituent, an acylamino group optionally having a substituent, an amino group optionally having a substituent, an alkoxycarbonylamino group optionally having a substituent, a sulfonylamino group optionally having a substituent, a sulfamoyl group optionally having a substituent, a carbamoyl group optionally having a substituent, an alkylthio group optionally having a substituent, a sulfonyl group optionally having a substituent, a ureide group optionally having a substituent, a nitro group, a hydroxy group, a cyano group, an imino group, an azo group and a halogen atom, and particularly preferable are an alkyl group optionally having a substituent, an alkenyl group optionally having a substituent, an aryl group optionally having a substituent, an alkoxy group optionally having a substituent, an oxycarbonyl group optionally having a substituent, an acyloxy group optionally having a substituent, a nitro group, an imino group and an azo group. The preferable range of the number of carbon atoms of the above-mentioned substituents having a carbon atom is the same as the preferable range of the number of carbon atoms for the substituents represented by R³¹ to R³⁵.

The aromatic hydrocarbon group, the aromatic heterocyclic group or the cyclohexane ring group may have 1 to 5 of these substituents, and preferably, has one substituent. When Q³¹ is a phenyl group, it is preferable that one substituent is carried at a para-position with respect to L³¹, and when Q³¹ is a cyclohexane ring group, it is preferable that one substituent is carried in trans configuration at a 4-position with respect to L³¹.

As the aromatic heterocyclic group represented by Q³¹, groups derived from monocyclic or bicyclic hetero rings are preferable. The atoms other than carbon, constituting the aromatic heterocyclic group, include a nitrogen atom, a sulfur atom and an oxygen atom. When the aromatic heterocyclic group has two or more ring constituent atoms other than carbon, these may be the same or different. The aromatic heterocyclic group includes, specifically, a pyridyl group, a quinolyl group, a thiophenyl group, a thiazolyl group, a benzothiazolyl group, a thiadiazolyl group, a quinolonyl group, a naphthalimidyl group, a thienothiazolyl group and the like.

The aromatic heterocyclic group is preferably a pyridyl group, a quinolyl group, a thiazolyl group, a benzothiazolyl group, a thiadiazolyl group or a thienothiazolyl group, particularly preferably a pyridyl group, a benzothiazolyl group, a thiadiazolyl group or a thienothiazolyl group, most preferably a pyridyl group, a benzothiazolyl group or a thienothiazolyl group.

The group represented by Q³¹ is particularly preferably a phenyl group optionally having a substituent, a naphthyl group optionally having a substituent, a pyridyl group optionally having a substituent, a benzothiazolyl group optionally having a substituent, a thienothiazolyl group optionally having a substituent or a cyclohexane ring group optionally having a substituent, more preferably a phenyl group, a pyridyl group, a benzothiazolyl group or a cyclohexane ring group.

The linking group represented by L³¹ in the above-described formula (III) includes a single bond, alkylene groups (preferably having 1 to 20 carbons, more preferably having 1 to 10 carbons and particularly preferably having 1 to 6 carbons, and examples thereof include a methylene group, an ethylene group, a propylene group, a butylene group, a pentylene group, a cyclohexane-1,4-diyl group and the like), alkenylene groups (preferably having 2 to 20 carbons, more preferably having 2 to 10 carbons and particularly preferably having 2 to 6 carbons, and examples thereof include an ethenylene group and the like), alkynylene groups (preferably having 2 to 20 carbons, more preferably having 2 to 10 carbons and particularly preferably having 2 to 6 carbons, and examples thereof include an ethynylene group and the like), alkyleneoxy groups (preferably having 1 to 20 carbons, more preferably having 1 to 10 carbons and particularly preferably having 1 to 6 carbons, and examples thereof include a methyleneoxy group and the like), an amide group, an ether group, an acyloxy group (—C(═O)O—), an oxycarbonyl group (—OC(═O)—), an imino group (—CH═N— or —N═CH—), a sulfoamide group, a sulfonate group, a ureide group, a sulfonyl group, a sulfinyl group, a thioether group, a carbonyl group, an —NR— group (here, R represents a hydrogen atom, an alkyl group or an aryl group), an azo group, an azoxy group, or divalent linking groups having 0 to 60 carbons constituted by combining two or more of them.

The group represented by L³¹ is particularly preferably a single bond, an amide group, an acyloxy group, an oxycarbonyl group, an imino group, an azo group or an azoxy group, more further preferably an azo group, an acyloxy group, an oxycarbonyl group or an imino group.

In the above-described formula (III), A³¹ represents an oxygen atom or a sulfur atom, preferably a sulfur atom.

The compound represented by the above-described formula (III) may have a polymerizable group as a substituent. It is preferable to have a polymerizable group since a film curing property is improved. Examples of the polymerizable group include unsaturated polymerizable groups, an epoxy group and an aziridinyl group, and unsaturated polymerizable groups are preferable and an ethylenically unsaturated polymerizable group is particularly preferable. Examples of the ethylenically unsaturated polymerizable group include an acryloyl group and a methacryloyl group.

It is preferable that the polymerizable group is situated at the molecular end, that is, it is preferable that, in the formula (III), the polymerizable group is present as a substituent of R³⁶ and/or R³⁷ and as a substituent of Q¹.

Among compounds represented by the above-described formula (III), particularly preferable are compounds represented by the following formula (IIIa).

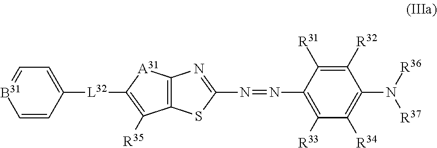

In the formula, R³¹ to R³⁵ are the same as those in the above-described formula (III), and also the preferable range thereof is the same as for the formula (III). B³¹ represents a nitrogen atom or a carbon atom optionally having a substituent; L³² represents an azo group, an acyloxy group (—C(═O)O—), an oxycarbonyl group (—OC(═O)—) or an imino group.

In the above-described formula (IIIa), R³⁵ represents preferably a hydrogen atom or a methyl group and more preferably a hydrogen atom.

The substituent optionally carried when B³¹ is a carbon atom in the above-described formula (IIIa) is the same as the substituent optionally carried on Q³¹ in the above-described formula (III), and also the preferable range thereof is the same as for the formula (III).

In the above-described formula (IIIa), L³² represents an azo group, an acyloxy group, an oxycarbonyl group or an imino group, preferably an azo group, an acyloxy group or an oxycarbonyl group and more preferably an azo group.

Specific examples of the compound represented by the formula (III) include, but are not limited to, the following specific examples.

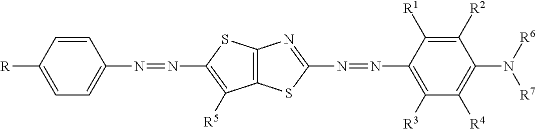

| No. | R¹ | R² | R³ | R⁴ | R⁵ | R⁶ | R⁷ | R |
|---|---|---|---|---|---|---|---|---|
| A3-1 | —H | —H | —H | —H | —H | —C₂H₅ | —C₂H₅ | —C₄H₉ |
| A3-2 | —H | —H | —H | —H | —H | —C₂H₅ | —C₂H₅ | —C₆H₁₃ |
| A3-3 | —H | —H | —H | —H | —H | —C₂H₅ | —C₂H₅ | —C₇H₁₅ |
| A3-4 | —H | —H | —H | —H | —H | —C₂H₅ | —C₂H₅ | —OC₄H₉ |
| A3-5 | —H | —H | —H | —H | —H | —C₂H₅ | —C₂H₅ | —CF₃ |
| A3-6 | —H | —H | —H | —H | —H | —C₂H₅ | —C₂H₅ | —OH |
| A3-7 | —H | —H | —H | —H | —H | —C₂H₅ | —C₂H₅ | —CN |
| A3-8 | —H | —H | —H | —H | —H | —C₂H₅ | —C₂H₅ | —NO₂ |
| A3-9 | —H | —H | —H | —H | —H | —C₂H₅ | —C₂H₅ | —F |
| A3-10 | —H | —H | —H | —H | —H | —C₂H₅ | —C₂H₅ | —Br |
| A3-11 | —H | —H | —H | —H | —H | —C₂H₅ | —C₂H₅ | —I |
| A3-12 | —H | —H | —H | —H | —H | —CH₃ | —H | —C₄H₉ |
| A3-13 | —H | —H | —H | —H | —H | —CH₃ | —CH₃ | —C₄H₉ |
| A3-14 | —H | —H | —H | —H | —H | —CH₃ | —C₆H₁₃ | —C₄H₉ |
| A3-15 | —H | —H | —H | —H | —H | —CH₃ | —CH₂CH₂OH | —C₄H₉ |
| A3-16 | —H | —H | —H | —H | —H | —CH₃ | —CH₂CH₂OCH₃ | —C₄H₉ |
| A3-17 | —H | —H | —H | —H | —H | —CH₃ | —CH₂CH₂OCOCH═CH₂ | —C₄H₉ |
| A3-18 | —H | —H | —H | —H | —H | —CH₃ | —CH₂CH₂CN | —C₄H₉ |
| A3-19 | —H | —H | —H | —H | —H | —CH₂CH₂OCOCH═CH₂ | —CH₂CH₂OCOCH═CH₂ | —C₄H₉ |
| A3-20 | —CH₃ | —H | —H | —H | —H | —C₂H₅ | —C₂H₅ | —C₄H₉ |
| A3-21 | —F | —H | —H | —H | —H | —C₂H₅ | —C₂H₅ | —C₄H₉ |
| A3-22 | —Cl | —H | —H | —H | —H | —C₂H₅ | —C₂H₅ | —C₄H₉ |
| A3-23 | —OH | —H | —H | —H | —H | —C₂H₅ | —C₂H₅ | —C₄H₉ |
| A3-24 | —OCH₃ | —H | —H | —H | —H | —C₂H₅ | —C₂H₅ | —C₄H₉ |
| A3-25 | —H | —OCH₃ | —OCH₃ | —H | —H | —C₂H₅ | —C₂H₅ | —C₄H₉ |
| A3-26 | —H | —H | —H | —H | —CH₃ | —C₂H₅ | —C₂H₅ | —C₄H₉ |

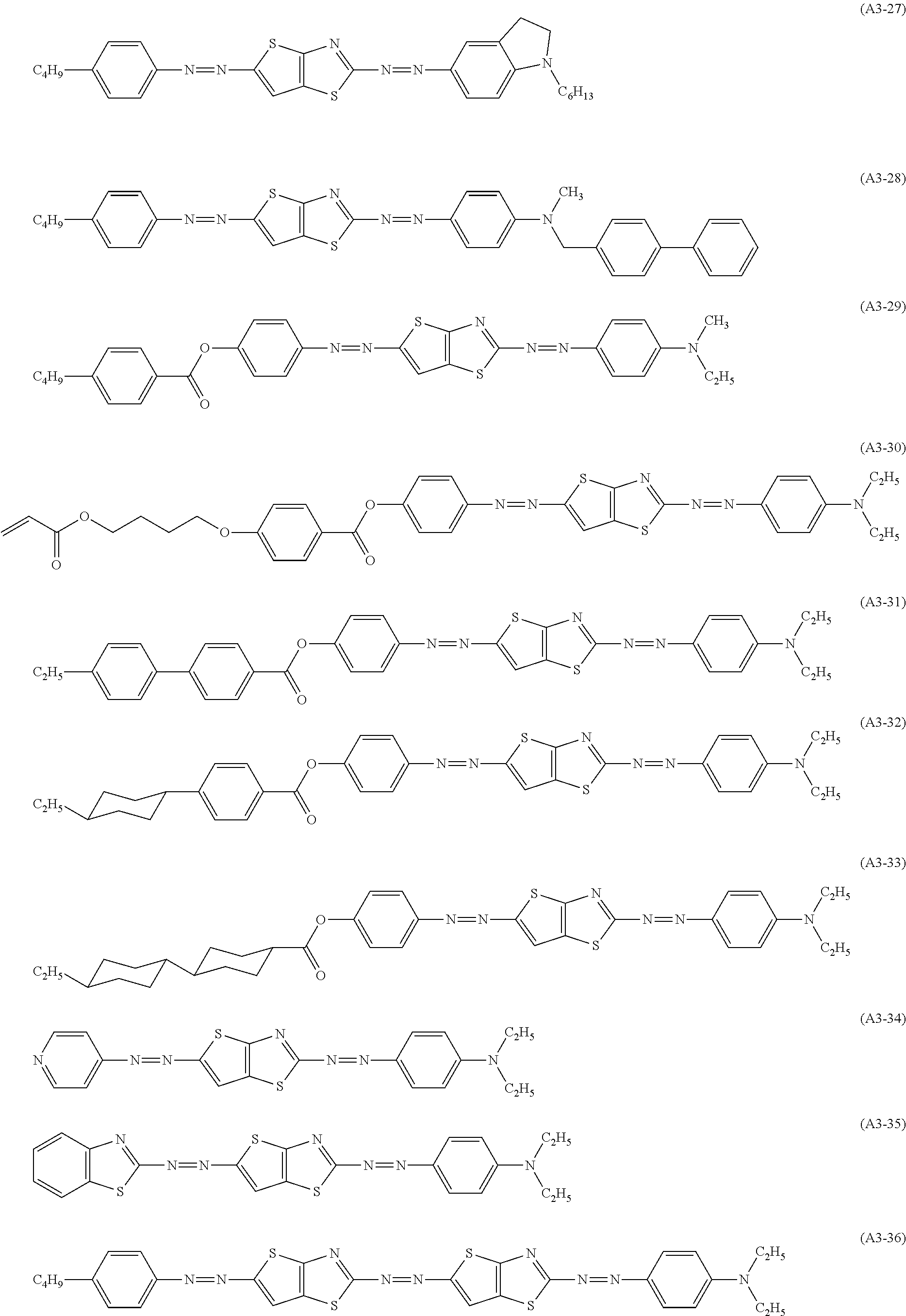

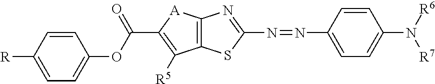

| No. | A | R⁵ | R⁶ | R⁷ | R |
|---|---|---|---|---|---|
| A3-37 | S | —H | —C₂H₅ | —C₂H₅ | —C₄H₉ |
| A3-38 | S | —H | —C₂H₅ | —C₂H₅ | —C₇H₁₅ |
| A3-39 | S | —H | —C₂H₅ | —C₂H₅ | —CN |
| A3-40 | S | —H | —C₂H₅ | —C₂H₅ | —Br |
| A3-41 | S | —CH₃ | —C₂H₅ | —C₂H₅ | —C₄H₉ |
| A3-42 | S | —H | —CH₃ | —CH₃ | —C₄H₉ |
| A3-43 | O | —H | —C₂H₅ | —C₂H₅ | —C₄H₉ |

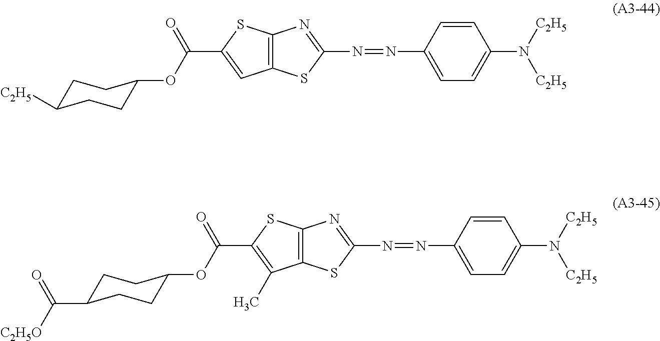

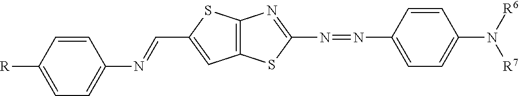

| NO. | R⁶ | R⁷ | R |
|---|---|---|---|
| A3-46 | —C₂H₅ | —C₂H₅ | —C₄H₉ |
| A3-47 | —C₂H₅ | —C₂H₅ | —OC₄H₉ |
| A3-48 | —C₂H₅ | —C₂H₅ | —CF₃ |
| A3-49 | —C₂H₅ | —C₂H₅ | —F |
| A3-50 | —CH₃ | —CH₃ | —C₄H₉ |

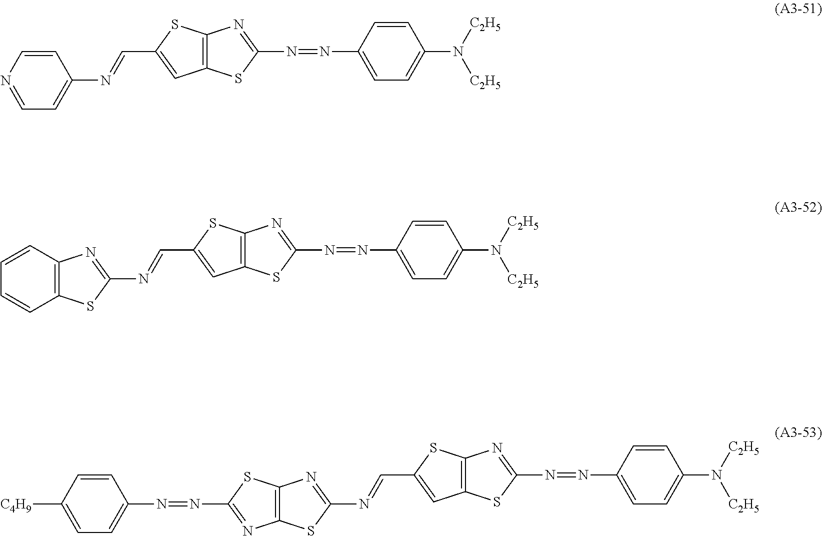

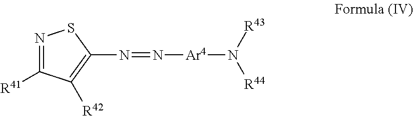

In the formula, R⁴¹ and R⁴² each represent a hydrogen atom or a substituent, and may be mutually linked to form a ring; Ar⁴ represents an optionally substituted divalent aromatic hydrocarbon group or aromatic heterocyclic group; R⁴³ and R⁴⁴ each represent a hydrogen atom or an optionally substituted alkyl group, and may be mutually linked to form a hetero ring.

Examples of the substituent each represented by R⁴¹ and R⁴² in the formula (IV) are the same as examples of the substituent each represented by R¹¹ to R¹⁴ in the above-described formula (I). R⁴¹ and R⁴² include preferably a hydrogen atom, an alkyl group, an alkoxy group, a halogen atom, a cyano group, a nitro group and a sulfo group, more preferably a hydrogen atom, an alkyl group, a halogen atom, a cyano group and a nitro group, further preferably a hydrogen atom, an alkyl group and a cyano group and more further preferably a hydrogen atom, a methyl group and a cyano group.

It is also preferable that R⁴¹ and R⁴² are mutually linked to form a ring. Particularly, it is preferable to form an aromatic hydrocarbon group or an aromatic heterocyclic group. As the aromatic heterocyclic group, groups derived from monocyclic or bicyclic hetero rings are preferable. The atoms other than carbon, constituting the aromatic heterocyclic group, include a nitrogen atom, a sulfur atom and an oxygen atom. When the aromatic heterocyclic group has two or more ring constituent atoms other than carbon, these may be the same or different. The aromatic heterocyclic group includes, specifically, a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, a thienothiazole ring and the like.

The cyclic group formed by mutually linking R⁴¹ and R⁴² is preferably a benzene ring, a naphthalene ring, a pyridine ring, a pyrazine ring, a pyrimidine ring or a pyridazine ring, more preferably a benzene ring or a pyridine ring and most preferably a pyridine ring.

The cyclic group formed by mutually linking R⁴¹ and R⁴² may have a substituent, and the range thereof is the same as the range of the group represented by R¹ and R², and also the preferable range thereof is the same as for the group represented by R¹ and R².

Examples of the compound represented by the above-described formula (IV) include compounds represented by the following formula (IV′).

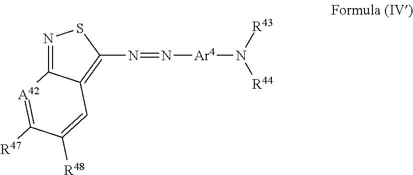

In the formula, the same symbols as in the formula (IV) have the same meanings, and also the preferable range thereof is the same. A⁴² represents N or CH, and R⁴⁷ and R⁴⁸ each represent a hydrogen atom or a substituent. It is preferable that one of R⁴⁷ and R⁴⁸ is a substituent, and it is also preferable that R⁴⁷ and R⁴⁸ both represent a substituent. Preferable examples of the substituent are the same as examples of the substituent represented by R⁴¹ and R⁴², that is, preferable are an alkyl group, an alkoxy group, a halogen atom, a cyano group, a nitro group and a sulfo group, more preferable are an alkyl group, a halogen atom, a cyano group and a nitro group, further preferable are an alkyl group and a cyano group and most preferable are a methyl group and a cyano group. For example, compounds in which one of R⁴⁷ and R⁴⁸ is an alkyl group having the number of carbon atoms of 1 to 4 and the other is a cyano group are also preferable.

As the aromatic heterocyclic group represented by Ar⁴ in the formula (IV′), groups derived from monocyclic or bicyclic hetero rings are preferable. The atoms other than carbon, constituting the aromatic heterocyclic group, include a nitrogen atom, a sulfur atom and an oxygen atom. When the aromatic heterocyclic group has two or more ring constituent atoms other than carbon, these may be the same or different. The aromatic heterocyclic group includes, specifically, a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, a thienothiazole ring and the like.

The group represented by Ar⁴ is preferably a benzene ring, a naphthalene ring, a pyridine ring, a pyrazine ring, a pyrimidine ring, a pyridazine ring, a quinoline ring or a thiophene ring, more preferably a benzene ring, a naphthalene ring, a pyridine ring or a thiophene ring and most preferably a benzene ring.

Ar⁴ may have a substituent, and the range thereof is the same as for the group represented by R⁴¹ and R⁴² described above.

The substituent optionally carried on Ar⁴ is preferably an alkyl group, an alkoxy group or a halogen atom, more preferably a hydrogen atom, an alkyl group or an alkoxy group, more further preferably a methyl group. It is also preferable that Ar⁴ has no substituent.

It is preferable that a linkage of Ar⁴ and an amino group is parallel to a linkage of Ar⁴ and an azo group, since linearity of a molecule is enhanced and a larger molecular length and larger aspect ratio are obtained in this condition. For example, when Ar⁴ contains a 6-membered ring linked to an azo group and amino group, it is preferable that an amino group is linked to 4-position with respect to an azo group, and when Ar⁴ contains a 5-membered ring linked to an azo group and amino group, it is preferable that an amino group is linked to 3- or 4-position with respect to an azo group.

The range of the alkyl group represented by R⁴³ and R⁴⁴ in the formula (IV′) is the same as for the alkyl group represented by R⁴¹ and R⁴² described above. The alkyl group may have a substituent, and examples of the substituent are the same as examples of the substituent represented by R⁴¹ and R⁴². When R⁴³ and R⁴⁴ represent an optionally substituted alkyl group, these may be mutually linked to form a hetero ring. If possible, these may be linked to the substituent carried on Ar⁴ to form a ring.

It is preferable that R⁴³ and R⁴⁴ are mutually linked to form a ring. A 6-membered ring or a 5-membered ring is preferable and a 6-membered ring is more preferable. The cyclic group may have an atom other than carbon as the constituent atom, together with carbon. The constituent atom other than carbon includes a nitrogen atom, a sulfur atom and an oxygen atom. When the cyclic group has two or more ring constituent atoms other than carbon, these may be the same or different.

The cyclic group composed of R⁴³ and R⁴⁴ includes, specifically, a 3-pyrroline ring, a pyrrolidine ring, a 3-imidazoline ring, an imidazolidine ring, a 4-oxazoline ring, an oxazolidine ring, a 4-thiazoline ring, a thiazolidine ring, a piperidine ring, a piperazine ring, a morpholine ring, a thiomorpholine ring, an azepan ring, an azocan ring and the like.

The cyclic group composed of R⁴³ and R⁴⁴ is preferably a pyrrolidine ring, a piperidine ring, a piperazine ring or a morpholine ring, more preferably a piperidine ring or a piperazine ring and most preferably a piperazine ring.

The cyclic group composed of R⁴³ and R⁴⁴ may have a substituent, and the range thereof is the same as for the group represented by R⁴¹ and R⁴². It is preferable that the cyclic group has one rigid linear substituent and a linkage of the cyclic group and the substituent is parallel to a linkage of the cyclic group and Ar⁴, since linearity of a molecule is enhanced and a larger molecular length and larger aspect ratio are obtained in this condition.

Among dichroic dyes represented by the formula (IV), particularly preferable are dichroic dyes represented by the following formula (IVa).

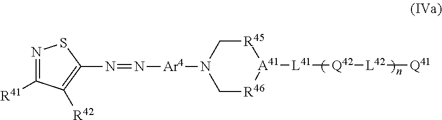

In the formula, R⁴¹ and R⁴² each represent a hydrogen atom or a substituent, and may be mutually linked to form a ring; Ar⁴ represents an optionally substituted divalent aromatic hydrocarbon group or aromatic heterocyclic group; A⁴¹ represents a carbon atom or a nitrogen atom; L⁴¹, L⁴², R⁴⁵ and R⁴⁶ represent a single bond or a divalent linking group; Q⁴¹ represents an optionally substituted cyclic hydrocarbon group or heterocyclic group; Q⁴² represents an optionally substituted divalent cyclic hydrocarbon group or heterocyclic group; n represents an integer of 0 to 3, and when n is 2 or more, a plurality of L⁴²s and a plurality of Q⁴²s may each be mutually the same or different.

The range of the group represented by R⁴¹ and R⁴² in the formula (IVa) is the same as for R⁴¹ and R⁴² in the formula (IVa), and also the preferable range thereof is the same as in the formula (IVa).

The range of the divalent aromatic hydrocarbon group or the aromatic heterocyclic group represented by Ar⁴ in the formula (IVa) is the same as for Ar⁴ in the formula (IV), and also the preferable range thereof is the same as in the formula (IV).

In the formula (IVa), A⁴¹ is preferably a nitrogen atom.

The linking group represented by L⁴¹, L⁴², R⁴⁵ and R⁴⁶ in the formula (IVa) includes alkylene groups (preferably having 1 to 20 carbons, more preferably having 1 to 10 carbons and particularly preferably having 1 to 6 carbons, and examples thereof include a methylene group, an ethylene group, a propylene group, a butylene group, a pentylene group, a cyclohexane-1,4-diyl group and the like), alkenylene groups (preferably having 2 to 20 carbons, more preferably having 2 to 10 carbons and particularly preferably having 2 to 6 carbons, and examples thereof include an ethenylene group and the like), alkynylene groups (preferably having 2 to 20 carbons, more preferably having 2 to 10 carbons and particularly preferably having 2 to 6 carbons, and examples thereof include an ethynylene group and the like), alkyleneoxy groups (preferably having 1 to 20 carbons, more preferably having 1 to 10 carbons and particularly preferably having 1 to 6 carbons, and examples thereof include a methyleneoxy group and the like), an amide group, an ether group, an acyloxy group (—C(═O)O—), an oxycarbonyl group (—OC(═O)—), an imino group (—CH═N— or —N═CH—), a sulfoamide group, a sulfonate group, a ureide group, a sulfonyl group, a sulfinyl group, a thioether group, a carbonyl group, an —NR— group (here, R represents a hydrogen atom, an alkyl group or an aryl group), an azo group, an azoxy group, or divalent linking groups having 0 to 60 carbons constituted of two or more of them in combination.

The linking group represented by L⁴¹ includes preferably a single bond, an alkylene group, an alkenylene group, an alkyleneoxy group, an oxycarbonyl group, an acyl group and a carbamoyl group, more preferably a single bond and an alkylene group and further preferably a single bond and an ethylene group.

The linking group represented by L⁴² includes preferably a single bond, an alkylene group, an alkenylene group, an oxycarbonyl group, an acyl group, an acyloxy group, a carbamoyl group, an imino group, an azo group and an azoxy group, more preferably a single bond, an oxycarbonyl group, an acyloxy group, an imino group, an azo group and an azoxy group and further preferably a single bond, an oxycarbonyl group and an acyloxy group.

The linking group represented by R⁴⁵ and R⁴⁶ includes preferably a single bond, an alkylene group, an alkenylene group, an alkyleneoxy group and an acyl group, more preferably a single bond and an alkylene group and further preferably a single bond and a methylene group.

The number of constituent atoms of the ring formed of a nitrogen atom, a methylene group, R⁴⁵, R⁴⁶ and A⁴¹ in the formula (IVa) is determined by R⁴⁵ and R⁴⁶, and for example, when R⁴⁵ and R⁴⁶ both represent a single bond, the ring can be a 4-membered ring; when one of them is a single bond and the other is a methylene group, it can be a 5-membered ring; and further, when R⁴⁵ and R⁴⁶ both represent a methylene group, it can be a 6-membered ring.

In the formula (IVa), the ring formed of a nitrogen atom, a methylene group, R⁴⁵, R⁴⁶ and A⁴¹ is preferably a 6-membered ring or a 5-membered ring and more preferably a 6-membered ring.

The group represented by Q⁴¹ in the formula (IVa) includes preferably an aromatic hydrocarbon group (preferably having 1 to 20 carbons and more preferably having 1 to 10 carbons, and examples thereof include a phenyl group, a naphthyl group and the like), an aromatic heterocyclic group and a cyclohexane ring group.

The aromatic heterocyclic group represented by Q⁴¹ is preferably a group derived from a monocyclic or bicyclic hetero ring. The atom other than carbon constituting the aromatic heterocyclic group includes a nitrogen atom, a sulfur atom and an oxygen atom. When the aromatic heterocyclic group has two or more ring constituent atoms other than carbon, these may be the same or different. The aromatic heterocyclic group includes specifically a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, a thienothiazole ring and the like.

The group represented by Q⁴¹ includes preferably a benzene ring, a naphthalene ring, a pyridine ring, a pyrazine ring, a pyrimidine ring, a pyridazine ring, a thiazole ring, a benzothiazole ring, a thiadiazole ring, a quinoline ring, a thienothiazole ring and a cyclohexane ring, more preferably a benzene ring, a naphthalene ring, a pyridine ring, a thiazole ring, a benzothiazole ring, a thiadiazole ring and a cyclohexane ring and most preferably a benzene ring, a pyridine ring and a cyclohexane ring.

Q⁴¹ may have a substituent, and the range thereof is the same as the range of the group represented by R⁴¹ and R⁴² described above.

The substituent optionally carried on Q⁴¹ includes preferably an alkyl group optionally having a substituent, an alkenyl group optionally having a substituent, an alkynyl group optionally having a substituent, an aryl group optionally having a substituent, an alkoxy group optionally having a substituent, an oxycarbonyl group optionally having a substituent, an acyloxy group optionally having a substituent, an acylamino group optionally having a substituent, an amino group optionally having a substituent, an alkoxycarbonylamino group optionally having a substituent, a sulfonylamino group optionally having a substituent, a sulfamoyl group optionally having a substituent, a carbamoyl group optionally having a substituent, an alkylthio group optionally having a substituent, a sulfonyl group optionally having a substituent, a ureide group optionally having a substituent, a nitro group, a hydroxy group, a cyano group, an imino group, an azo group and a halogen atom, more preferably an alkyl group optionally having a substituent, an alkenyl group optionally having a substituent, an aryl group optionally having a substituent, an alkoxy group optionally having a substituent, an oxycarbonyl group optionally having a substituent, an acyloxy group optionally having a substituent, a nitro group, an imino group and an azo group. The preferable range of the number of carbon atoms of one having carbon atoms among the above-described substituents is the same as the preferable range of the number of carbon atoms of the group represented by R⁴¹ and R⁴² described above.

It is preferable that Q⁴¹ has one substituent and a linkage of Q⁴¹ and the substituent is parallel to a linkage of Q⁴¹ and L⁴¹ or L⁴², since linearity of a molecule is enhanced and a larger molecular length and larger aspect ratio are obtained under this condition. Particularly when n=0, it is preferable that Q⁴¹ has a substituent at the above-described position.

In the formula (IVa), Q⁴² represents an optionally substituted divalent cyclic hydrocarbon group or heterocyclic group.

The divalent cyclic hydrocarbon group represented by Q⁴² may be aromatic or non-aromatic. Preferable examples of the divalent cyclic hydrocarbon group include aromatic hydrocarbon groups (preferably having 1 to 20 carbons and more preferably having 1 to 10 carbons, and examples thereof include a phenyl group, a naphthyl group and the like) and a cyclohexane ring group.

The divalent cyclic heterocyclic group represented by Q⁴² may also be aromatic or non-aromatic. The heterocyclic group is preferably a group derived from a monocyclic or bicyclic hetero ring. The atom other than carbon constituting the heterocyclic group includes a nitrogen atom, a sulfur atom and an oxygen atom. When the heterocyclic group has two or more ring constituent atoms other than carbon, these may be the same or different. The heterocyclic group includes specifically a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, a thienothiazole ring, a 3-pyrroline ring, a pyrrolidine ring, a 3-imidazoline ring, an imidazolidine ring, a 4-oxazoline ring, an oxazolidine ring, a 4-thiazoline ring, a thiazolidine ring, a piperidine ring, a piperazine ring, a morpholine ring, a thiomorpholine ring, an azepan ring, an azocan ring and the like.

The group represented by Q⁴² is preferably a benzene ring, a naphthalene ring, a pyridine ring, a pyrazine ring, a pyrimidine ring, a pyridazine ring, a piperidine ring, a piperazine ring, a quinoline ring, a thiophene ring, a thiazole ring, a benzothiazole ring, a thiadiazole ring, a quinolone ring, a naphthalimide ring, a thienothiazole ring or a cyclohexane ring, more preferably a benzene ring, a naphthalene ring, a pyridine ring, a piperidine ring, a piperazine ring, a thiazole ring, a thiadiazole ring or a cyclohexane ring and more further preferably a benzene ring, a cyclohexane ring or a piperazine ring.

Q⁴² may have substituent, and the range thereof is the same as for the group represented by R⁴¹ and R⁴² described above.

The range of the substituent optionally carried on Q⁴² is the same as for the substituent optionally carried on Ar⁴ described above, and also the preferable range thereof is the same as for the substituent optionally carried on Ar⁴.

It is preferable that linkages of Q⁴² and L⁴¹ and L⁴² or two L⁴²s are parallel, since linearity of a molecule is enhanced and a larger molecular length and larger aspect ratio are obtained under this condition.

In the formula (IVa), n represents an integer of 0 to 3, preferably 0 to 2, more preferably 0 or 1 and most preferably 1.

Among dichroic dyes represented by the formula (IVa), dichroic dyes represented by the following formula (IVb) are particularly preferable.

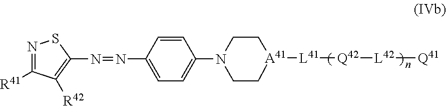

In the formula, R⁴¹ and R⁴² each represent a hydrogen atom or a substituent; A⁴¹ represents a carbon atom or a nitrogen atom; L⁴¹ and L⁴² each represent a single bond or a divalent linking group; Q⁴¹ represents an optionally substituted cyclic hydrocarbon group or optionally substituted heterocyclic group; Q⁴² represents an optionally substituted divalent cyclic hydrocarbon group or heterocyclic group; n represents an integer of 0 to 3, and when n is 2 or more, a plurality of L⁴²s and a plurality of Q⁴²s may each be mutually the same or different.

The range of the group represented by R⁴¹, R⁴², L⁴¹, L⁴², Q⁴¹ and Q⁴² in the formula (IVb) is the same as for R⁴¹, R⁴², L⁴¹, L⁴², Q⁴¹ and Q⁴² in the formula (IV), and also the preferable range thereof is the same as in the formula (IV).

In the formula (IVb), A⁴¹ is preferably a nitrogen atom.

Specific examples of the compound represented by the formula (IV) include, but are not limited to, the following specific examples.

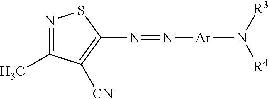

| No. | Ar | R³ | R⁴ |
|---|---|---|---|
| A4-1 | 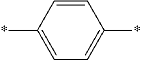 [SMILES: *c1ccc(*)cc1] | —CH₃ | —CH₂Ph |
| A4-2 | 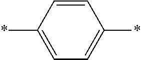 [SMILES: *c1ccc(*)cc1] | —CH₃ | —C₁₂H₂₅ |
| A4-3 | 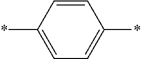 [SMILES: *c1ccc(*)cc1] | —CH₃ | —(CH₂CH₂O)₃CH₃ |
| A4-4 | 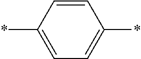 [SMILES: *c1ccc(*)cc1] | —CH₃ | —CH₂CH₂OCH₂Ph |
| A4-5 | 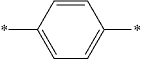 [SMILES: *c1ccc(*)cc1] | —H | —CH₂Ph |
| A4-6 | 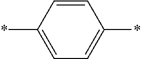 [SMILES: *c1ccc(*)cc1] | —C₂H₅ | —CH₂Ph |
| A4-7 | 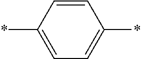 [SMILES: *c1ccc(*)cc1] | 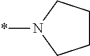 [SMILES: *N1CCCC1] | |
| A4-8 | 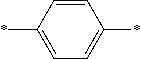 [SMILES: *c1ccc(*)cc1] | 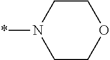 [SMILES: *N1CCOCC1] | |
| A4-9 | 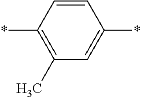 [SMILES: *c1ccc(*)c(C)c1] | —CH₃ | —CH₂Ph |
| A4-10 | 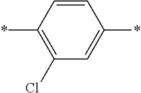 [SMILES: *c1ccc(*)c(Cl)c1] | —CH₃ | —CH₂Ph |
| A4-11 | 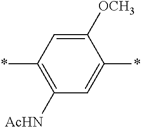 [SMILES: *c1cc(OC)c(*)cc1NC(C)=O] | —CH₃ | —CH₂Ph |
| A4-12 | 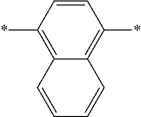 [SMILES: *c1ccc(*)c2ccccc12] | —CH₃ | —CH₂Ph |

| | | |
|---|---|---|
| A4-13 | 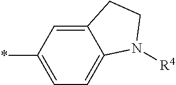 | —CH₂Ph |

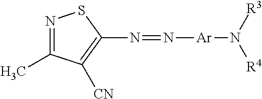

| No. | Ar | R3 | R4 |
|---|---|---|---|
| A4-14 | 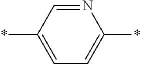 [SMILES: *c1ccc(*)nc1] | —CH₃ | —CH₂Ph |
| A4-15 | 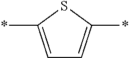 [SMILES: *c1ccc(*)s1] | —CH₃ | —CH₂CH₂OCH₂Ph |

| | | |
|---|---|---|
| A4-16 | 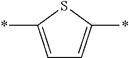 [SMILES: *c1ccc(*)s1] | 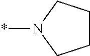 [SMILES: *N1CCCC1] |
| A4-17 | 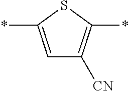 [SMILES: *c1cc(C#N)c(*)s1] | 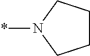 [SMILES: *N1CCCC1] |

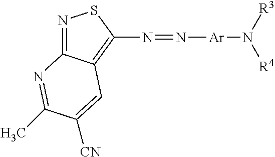

| No. | Ar | R³ | R⁴ |
|---|---|---|---|
| A4-18 | 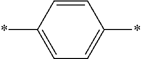 [SMILES: *c1ccc(*)cc1] | —CH₃ | —CH₂Ph |
| A4-19 | 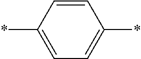 [SMILES: *c1ccc(*)cc1] | 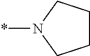 [SMILES: *N1CCCC1] | |
| A4-20 | 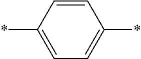 [SMILES: *c1ccc(*)cc1] | 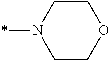 [SMILES: *N1CCOCC1] | |
| A4-21 | 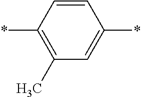 [SMILES: *c1ccc(*)c(C)c1] | —C₂H₅ | —C₂H₅ |
| A4-22 | 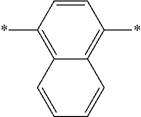 [SMILES: *c1ccc(*)c2ccccc12] | —C₂H₅ | —C₂H₅ |
| A4-23 | 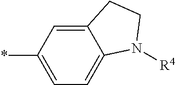 | | —CH₂Ph |
| A4-24 | 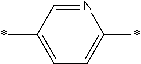 [SMILES: *c1ccc(*)nc1] | —CH₃ | —CH₂Ph |

| | | |
|---|---|---|
| A4-25 | 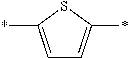 [SMILES: *c1ccc(*)s1] | 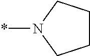 [SMILES: *N1CCCC1] |

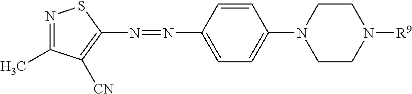

| No. | R⁹ |
|---|---|
| A4-26 | —C₅H₁₁ |
| A4-27 | —C₁₂H₂₅ |
| A4-28 | —CH₂CH(C₂H₅)C₄H₉ |
| A4-29 | —(CH₂CH₂O)₃CH₃ |
| A4-30 | —COOC₈H₁₇ |
| A4-31 | —C(═O)C₁₁H₂₃ |
| A4-32 | CONHC₈H₁₇ |

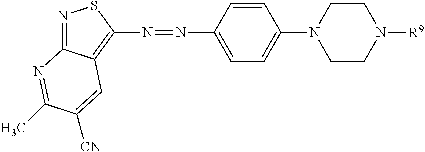

| No. | R⁹ |
|---|---|
| A4-33 | —C₅H₁₁ |
| A4-34 | —C₁₂H₂₅ |
| A4-35 | —CH₂CH(C₂H₅)C₄H₉ |
| A4-36 | —(CH₂CH₂O)₃CH₃ |
| A4-37 | —COOC₈H₁₇ |
| A4-38 | —C(═O)C₁₂H₂₅ |
| A4-39 | CONHC₈H₁₇ |

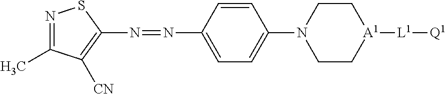

| No. | A¹ | L¹ | Q¹ |
|---|---|---|---|
| A4-40 | >CH— | — | —Ph |
| A4-41 | >N— | — | —Ph |
| A4-42 | >N— | — | 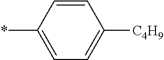 |
| A4-43 | >N— | — | 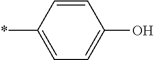 [SMILES: *c1ccc(O)cc1] |
| A4-44 | >N— | — | 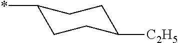 [SMILES: *C1CCC(CC)CC1] |
| A4-45 | >N— | —COO— | 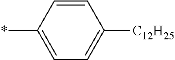 |
| A4-46 | >N— | —COOCH₂— | —Ph |
| A4-47 | >N— | —CONH— | 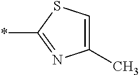 [SMILES: *c1nc(C)cs1] |
| A4-48 | >N— | —CONH— | 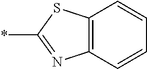 [SMILES: *c1nc2ccccc2s1] |
| A4-49 | >N— | —CO— | 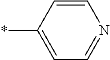 [SMILES: *c1ccncc1] |
| A4-50 | >N— | —CO— | 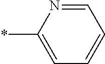 [SMILES: *c1ccccn1] |
| A4-51 | >N— | —CH₂CH₂— | —Ph |
| A4-52 | >N— | —CH₂CH₂O— | 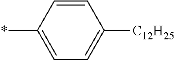 |
| A4-53 | >N— | —CH₂CH₂OCO— | 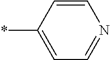 [SMILES: *c1ccncc1] |
| A4-54 | >N— | —CH₂CH₂OCO— | 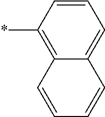 [SMILES: *c1cccc2ccccc12] |
| A4-55 | >N— | —CH₂CH₂OCO— | 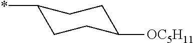 |

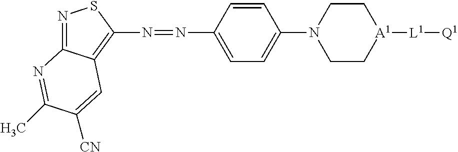

| No. | A¹ | L¹ | Q¹ |
|---|---|---|---|
| A4-56 | >CH— | — | —Ph |
| A4-57 | >N— | — | —Ph |
| A4-58 | >N— | — | 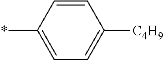 |
| A4-59 | >N— | — | 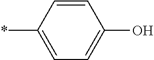 [SMILES: *c1ccc(O)cc1] |
| A4-60 | >N— | — | 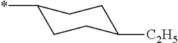 [SMILES: *C1CCC(CC)CC1] |
| A4-61 | >N— | —COO— | 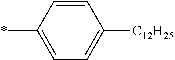 |
| A4-62 | >N— | —COOCH₂— | —Ph |
| A4-63 | >N— | —CONH— | 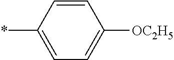 [SMILES: *c1ccc(OCC)cc1] |
| A4-64 | >N— | —CONH— | 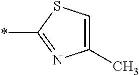 [SMILES: *c1nc(C)cs1] |
| A4-65 | >N— | —CONH— | 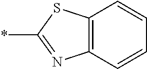 [SMILES: *c1nc2ccccc2s1] |
| A4-66 | >N— | —CO— | 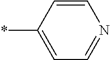 [SMILES: *c1ccncc1] |
| A4-67 | >N— | —CO— | 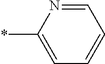 [SMILES: *c1ccccn1] |
| A4-68 | >N— | —CH₂CH₂— | —Ph |
| A4-69 | >N— | —CH₂CH₂O— | 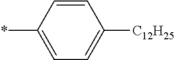 |
| A4-70 | >N— | —CH₂CH₂OCO— | 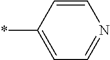 [SMILES: *c1ccncc1] |
| A4-71 | >N— | —CH₂CH₂OCO— | 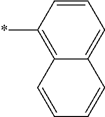 [SMILES: *c1cccc2ccccc12] |
| A4-72 | >N— | —CH₂CH₂OCO— | 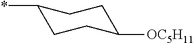 |

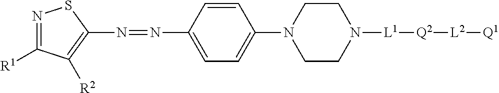

| No. | R¹ | R² | L¹ | Q² | L² | Q¹ |
|---|---|---|---|---|---|---|
| A4-73 | —CH₃ | —CN | — | 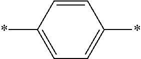 [SMILES: *c1ccc(*)cc1] | —CN | —Ph |
| A4-74 | —CH₃ | —CN | — | 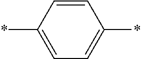 [SMILES: *c1ccc(*)cc1] | —CN | 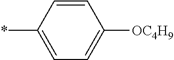 |
| A4-75 | —CH₃ | —CN | — | 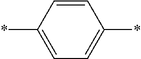 [SMILES: *c1ccc(*)cc1] | —COO— | 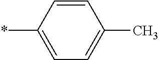 [SMILES: *c1ccc(C)cc1] |
| A4-76 | —CH₃ | —CN | — | 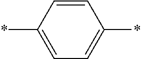 [SMILES: *c1ccc(*)cc1] | —COO— | 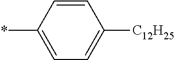 |
| A4-77 | —CH₃ | —CN | — | 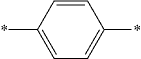 [SMILES: *c1ccc(*)cc1] | —COO— | 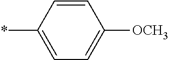 [SMILES: *c1ccc(OC)cc1] |
| A4-78 | —CH₃ | —CN | — | 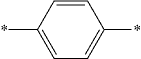 [SMILES: *c1ccc(*)cc1] | —COOCH₂— | —Ph |
| A4-79 | —CH₃ | —CN | — | 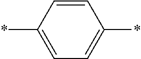 [SMILES: *c1ccc(*)cc1] | —CONH— | 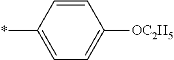 [SMILES: *c1ccc(OCC)cc1] |
| A4-80 | —CH₃ | —CN | — | 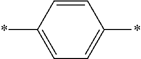 [SMILES: *c1ccc(*)cc1] | —CONH— | 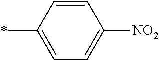 [SMILES: *c1ccc([N+](=O)[O-])cc1] |
| A4-81 | —CH₃ | —CN | — | 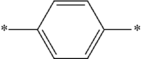 [SMILES: *c1ccc(*)cc1] | —CONH— | 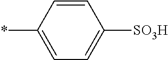 [SMILES: *c1ccc(S(=O)(=O)O)cc1] |
| A4-82 | —CH₃ | —CN | — | 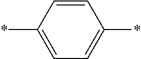 [SMILES: *c1ccc(*)cc1] | —OCO— | 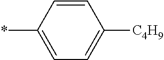 |
| A4-83 | —CH₃ | —CN | — | 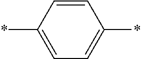 [SMILES: *c1ccc(*)cc1] | —OCO— | 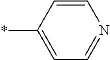 [SMILES: *c1ccncc1] |
| A4-84 | —CH₃ | —CN | — | 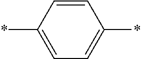 [SMILES: *c1ccc(*)cc1] | —NHCO— | 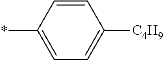 |
| A4-85 | —CH₃ | —CN | — | 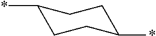 [SMILES: *C1CCC(*)CC1] | —OCO— | 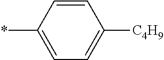 |
| A4-86 | —CH₃ | —CN | —COO— | 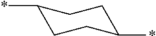 [SMILES: *C1CCC(*)CC1] | —OCO— | 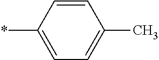 [SMILES: *c1ccc(C)cc1] |
| A4-87 | —CH₃ | —CN | —COO— | 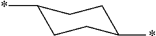 [SMILES: *C1CCC(*)CC1] | —COO— | 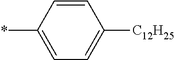 |
| A4-88 | —CH₃ | —CN | —CO— | 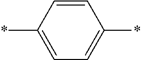 [SMILES: *c1ccc(*)cc1] | — | —Ph |
| A4-89 | —CH₃ | —CN | —CO— | 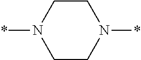 [SMILES: *N1CCN(*)CC1] | —COO— | 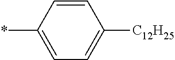 |
| A4-90 | —CH₃ | —CN | —CH₂CH₂— | 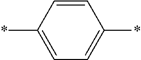 [SMILES: *c1ccc(*)cc1] | —OCO— | 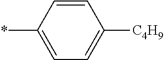 |
| A4-91 | —CH₃ | —CN | —CH₂CH₂— | 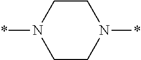 [SMILES: *N1CCN(*)CC1] | — | —Ph |
| A4-92 | —CH₃ | —CN | —CH₂CH₂— | 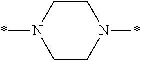 [SMILES: *N1CCN(*)CC1] | —COO— | 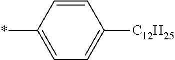 |
| A4-93 | —CH₃ | —CN | —CH₂CH₂— | 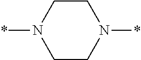 [SMILES: *N1CCN(*)CC1] | —CO— | 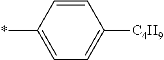 |
| A4-94 | —CH₃ | —CN | —CH₂CH₂— | 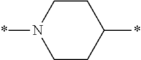 [SMILES: *C1CCN(*)CC1] | — | —Ph |
| A4-95 | —CH₃ | —CN | —CH₂CH₂O— | 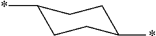 [SMILES: *C1CCC(*)CC1] | —OCO— | 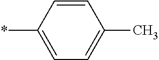 [SMILES: *c1ccc(C)cc1] |
| A4-96 | —CH₃ | —CN | —CH₂CH₂OCO— | 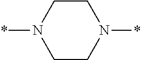 [SMILES: *N1CCN(*)CC1] | —COO— | 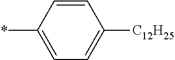 |
| A4-97 | —CH₃ | —H | —CH₂CH₂OCO— | 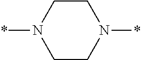 [SMILES: *N1CCN(*)CC1] | — | —Ph |
| A4-98 | —H | —H | —CH₂CH₂OCO— | 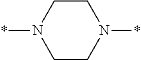 [SMILES: *N1CCN(*)CC1] | — | —Ph |
| A4-99 | —H | —Cl | —CH₂CH₂OCO— | 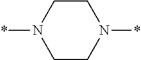 [SMILES: *N1CCN(*)CC1] | — | —Ph |
| A4-100 | —H | —SO₃H | —CH₂CH₂OCO— | 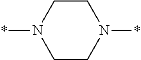 [SMILES: *N1CCN(*)CC1] | — | —Ph |
| A4-101 | —H | —NO₂ | —CH₂CH₂OCO— | 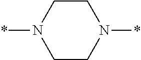 [SMILES: *N1CCN(*)CC1] | — | —Ph |

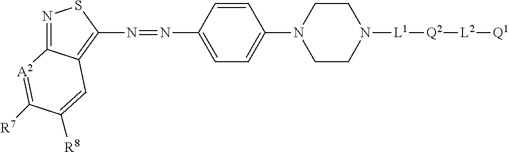

| No. | A² | R⁷ | R⁸ | L¹ | Q² | L² | Q¹ |
|---|---|---|---|---|---|---|---|
| A4-102 | —N═ | —CH₃ | —CN | — | 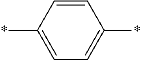 [SMILES: *c1ccc(*)cc1] | — | —Ph |
| A4-103 | —N═ | —CH₃ | —CN | — | 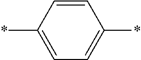 [SMILES: *c1ccc(*)cc1] | — | 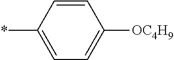 |
| A4-104 | —N═ | —CH₃ | —CN | — | 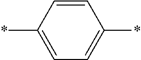 [SMILES: *c1ccc(*)cc1] | —COO— | 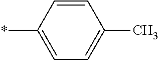 [SMILES: *c1ccc(C)cc1] |
| A4-105 | —N═ | —CH₃ | —CN | — | 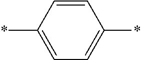 [SMILES: *c1ccc(*)cc1] | —COO— | 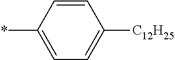 |
| A4-106 | —N═ | —CH₃ | —CN | — | 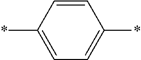 [SMILES: *c1ccc(*)cc1] | —COO— | 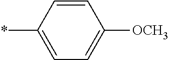 [SMILES: *c1ccc(OC)cc1] |
| A4-107 | —N═ | —CH₃ | —CN | — | 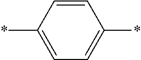 [SMILES: *c1ccc(*)cc1] | —COOCH₂— | —Ph |
| A4-108 | —N═ | —CH₃ | —CN | — | 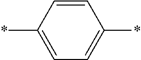 [SMILES: *c1ccc(*)cc1] | —CONH— | 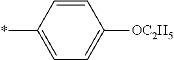 [SMILES: *c1ccc(OCC)cc1] |
| A4-109 | —N═ | —CH₃ | —CN | — | 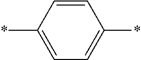 [SMILES: *c1ccc(*)cc1] | —CONH— | 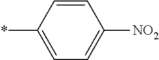 [SMILES: *c1ccc([N+](=O)[O-])cc1] |
| A4-110 | —N═ | —CH₃ | —CN | — | 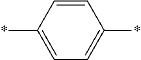 [SMILES: *c1ccc(*)cc1] | —CONH— | 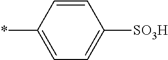 [SMILES: *c1ccc(S(=O)(=O)O)cc1] |
| A4-111 | —N═ | —CH₃ | —CN | — | 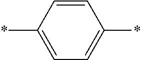 [SMILES: *c1ccc(*)cc1] | —OCO— | 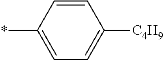 |
| A4-112 | —N═ | —CH₃ | —CN | — | 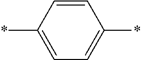 [SMILES: *c1ccc(*)cc1] | —OCO— | 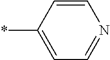 [SMILES: *c1ccncc1] |
| A4-113 | —N═ | —CH₃ | —CN | — | 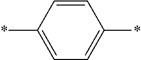 [SMILES: *c1ccc(*)cc1] | —NHCO— | 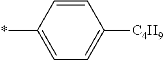 |
| A4-114 | —N═ | —CH₃ | —CN | — | 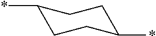 [SMILES: *C1CCC(*)CC1] | —OCO— | 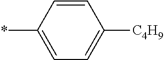 |
| A4-115 | —N═ | —CH₃ | —CN | —COO— | 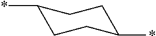 [SMILES: *C1CCC(*)CC1] | —OCO— | 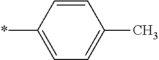 [SMILES: *c1ccc(C)cc1] |
| A4-116 | —N═ | —CH₃ | —CN | —COO— | 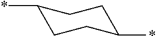 [SMILES: *C1CCC(*)CC1] | —COO— | 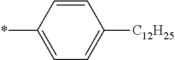 |
| A4-117 | —N═ | —CH₃ | —CN | —CO— | 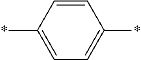 [SMILES: *c1ccc(*)cc1] | —COO— | —Ph |
| A4-118 | —N═ | —CH₃ | —CN | —CO— | 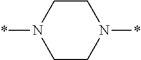 [SMILES: *N1CCN(*)CC1] | —COO— | 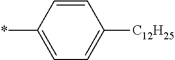 |
| A4-119 | —N═ | —CH₃ | —CN | —CH₂CH₂— | 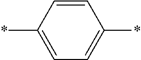 [SMILES: *c1ccc(*)cc1] | —OCO— | 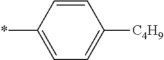 |
| A4-120 | —N═ | —CH₃ | —CN | —CH₂CH₂— | 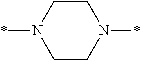 [SMILES: *N1CCN(*)CC1] | —OCO— | —Ph |

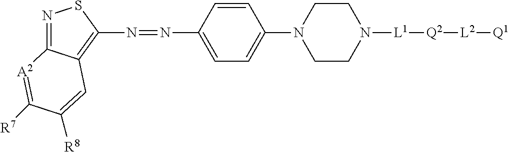

| No. | A² | R⁷ | R⁸ | L¹ | Q² | L² | Q¹ |
|---|---|---|---|---|---|---|---|
| A4-121 | —N═ | —CH₃ | —CN | —CH₂CH₂— | 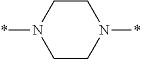 [SMILES: *N1CCN(*)CC1] | —COO— | 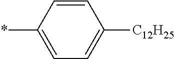 |
| A4-122 | —N═ | —CH₃ | —CN | —CH₂CH₂— | 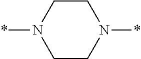 [SMILES: *N1CCN(*)CC1] | —CO— | 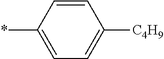 |
| A4-123 | —N═ | —CH₃ | —CN | —CH₂CH₂— | 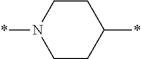 [SMILES: *C1CCN(*)CC1] | — | —Ph |
| A4-124 | —N═ | —CH₃ | —CN | —CH₂CH₂O— | 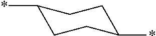 [SMILES: *C1CCC(*)CC1] | —OCO— | 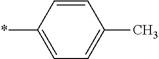 [SMILES: *c1ccc(C)cc1] |
| A4-125 | —N═ | —CH₃ | —CN | —CH₂CH₂OCO— | 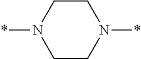 [SMILES: *N1CCN(*)CC1] | —COO— | 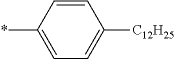 |
| A4-126 | —N═ | —CH₃ | —H | —CH₂CH₂— | 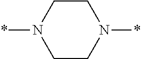 [SMILES: *N1CCN(*)CC1] | — | —Ph |
| A4-127 | —N═ | —H | —H | —CH₂CH₂— | 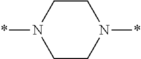 [SMILES: *N1CCN(*)CC1] | — | —Ph |
| A4-128 | —N═ | —H | —Cl | —CH₂CH₂— | 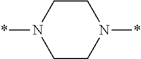 [SMILES: *N1CCN(*)CC1] | — | —Ph |
| A4-129 | —N═ | —H | —SO₃H | —CH₂CH₂— | 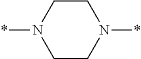 [SMILES: *N1CCN(*)CC1] | — | —Ph |
| A4-130 | —N═ | —H | —NO₂ | —CH₂CH₂— | 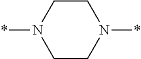 [SMILES: *N1CCN(*)CC1] | — | —Ph |
| A4-131 | —CH═ | —CH₃ | —CN | —CH₂CH₂— | 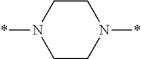 [SMILES: *N1CCN(*)CC1] | — | —Ph |
| A4-132 | —CH═ | —CH₃ | —H | —CH₂CH₂— | 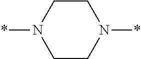 [SMILES: *N1CCN(*)CC1] | — | —Ph |
| A4-133 | —CH═ | —H | —H | —CH₂CH₂— | 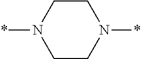 [SMILES: *N1CCN(*)CC1] | — | —Ph |
| A4-134 | —CH═ | —H | —Cl | —CH₂CH₂— | 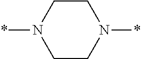 [SMILES: *N1CCN(*)CC1] | — | —Ph |
| A4-135 | —CH═ | —H | —SO₃H | —CH₂CH₂— | 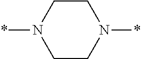 [SMILES: *N1CCN(*)CC1] | — | —Ph |
| A4-136 | —CH═ | —H | —NO₂ | —CH₂CH₂— | 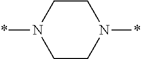 [SMILES: *N1CCN(*)CC1] | — | —Ph |

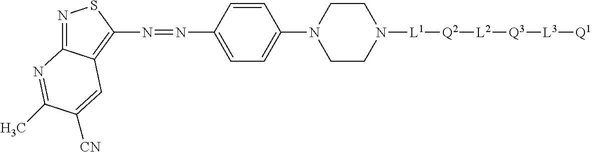

| No. | L¹ | Q² | L² | Q³ | L³ | Q¹ |
|---|---|---|---|---|---|---|
| A4-137 | — | 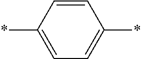 [SMILES: *c1ccc(*)cc1] | — | 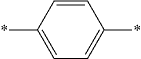 [SMILES: *c1ccc(*)cc1] | —COO— | 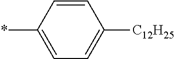 |
| A4-138 | — | 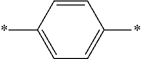 [SMILES: *c1ccc(*)cc1] | —COO— | 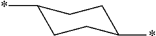 [SMILES: *C1CCC(*)CC1] | —OCO— | 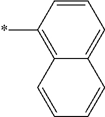 [SMILES: *c1cccc2ccccc12] |
| A4-139 | — | 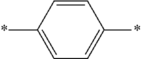 [SMILES: *c1ccc(*)cc1] | —OCO— | 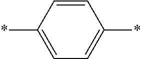 [SMILES: *c1ccc(*)cc1] | —CONH | 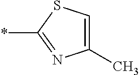 [SMILES: *c1nc(C)cs1] |
| A4-140 | —CH₂CH₂— | 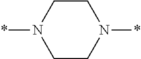 [SMILES: *N1CCN(*)CC1] | —COO— | 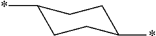 [SMILES: *C1CCC(*)CC1] | —OCO— | 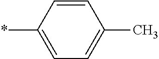 [SMILES: *c1ccc(C)cc1] |
| A4-141 | —CH₂CH₂— | 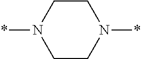 [SMILES: *N1CCN(*)CC1] | — | 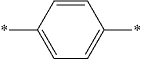 [SMILES: *c1ccc(*)cc1] | —N═N— | 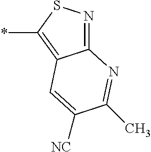 [SMILES: *c1snc2nc(C)c(C#N)cc12] |
| A4-142 | —COO— | 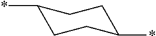 [SMILES: *C1CCC(*)CC1] | —OCO— | 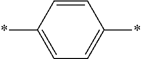 [SMILES: *c1ccc(*)cc1] | — | —Ph |

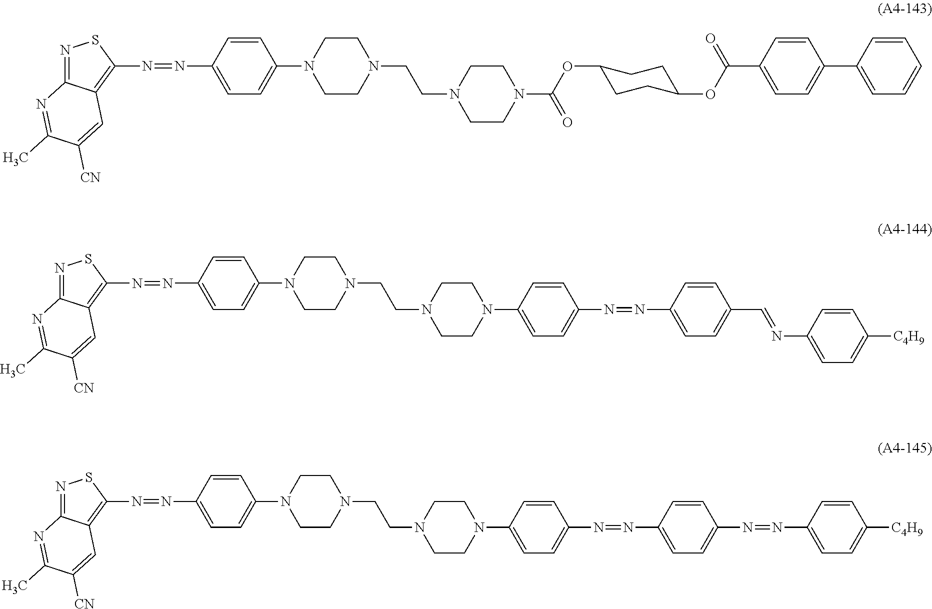

Compounds (azo dyes) described by the above-described formula (I), (II), (III) or (IV) can be synthesized by reference to methods described in “Dichroic Dyes for Liquid Crystal Display” (A. V. Ivashchenko ed., CRC, 1994), “Review on Synthetic Dyes (Sosetsu Gosei Senryo)” (Hiroshi Horiguchi ed., Sankyo Publishing, 1968) and literature cited in them.

Azo dyes represented by the above-described formula (I), (II), (III) or (IV) in the present invention can be synthesized easily according to methods described in the Journal of Materials Chemistry (1999), 9(11), 2755-2763 and the like.

The azo dye represented by the above-described formula (I), (II), (III) or (IV) is characterized by having a nature of easily realizing by itself liquid crystallinity, particularly nematic liquid crystallinity since the molecular shape is flat and has good linearity, has a rigid core part and a flexible side chain part, and a polar amino group is present at the molecular long axis end of the azo dye, as apparent from its molecular structure.

As described above, the dichroic dye composition containing at least one kind of dichroic dye represented by the above-described (I), (II), (III) or (IV) has liquid crystallinity, in the present invention.

Further, the azo dye represented by the above-described formula (I), (II), (III) or (IV) also has a nature of easily forming an associated state of molecules by the action of strong intermolecular interaction because of high flatness of the molecule.

The dichroic dye composition containing the azo dye represented by Formula (I), (II), (III), or (IV) according to the present invention not only exhibits high absorbance in a wide visible wavelength region due to the formation of the association, but also has liquid crystallinity, specifically, nematic liquid crystallinity. Accordingly, for example, a high degree of molecular alignment can be achieved through a lamination process such as coating over the surface of a polyvinyl alcohol alignment film treated by rubbing. Therefore, a stereo image print produced by forming the dichroic dye layer from the dichroic dye composition containing the azo dye represented by Formula (I), (II), (III), or (IV) according to the present invention exhibits high polarization characteristics and can provide a clear stereoscopic image without crosstalk or ghost images.

The dichroic dye composition can increase the dichroic dye ratio (D) calculated by the method described in the example described below to 15 or more, preferably to 18 or more.

The azo dye represented by Formula (I), (II), (III), or (IV) has liquid crystallinity to exhibit a nematic liquid crystal phase preferably at 10° C. to 300° C. and more preferably at 100° C. to 250° C.

The dichroic dye composition in the present invention preferably contains one or more azo dyes represented by Formula (I), (II), (III), or (IV). Though the composition may contain any combination of the azo dyes without particular limitation, two or more azo dyes may be mixed in order to allow the resulting stereo image print to achieve high degrees of polarization and hue.

The azo dye represented by Formula (Ia) is a magenta azo dye, the azo dyes represented by Formulae (Ib) and (II) are yellow or magenta azo dyes, and the azo dyes represented by Formulae (III) and (IV) are cyan azo dyes.

Furthermore, the dichroic dye may be any dye other than the azo dyes represented by Formula (I), (II), (III), or (IV). The dye other than the azo dyes represented by Formula (I), (II), (III), or (IV) is also preferably selected from compounds exhibiting liquid crystallinity. Examples of such a dye include cyanine dyes, azo metal complexes, phthalocyanine dyes, pyrylium dyes, thiopyrylium dyes, azulenium dyes, squarylium dyes, quinone dyes, triphenylmethane dyes, and triallylmethane dyes. Among them, squarylium dyes are preferable. In particular, those described in “Dichroic Dyes for Liquid Crystal Display” (A. V. Ivashchenko, published by CRC, 1994) can also be used.

In particular, the squarylium dyes that can be used in the present invention are preferably represented by Formula (VI):

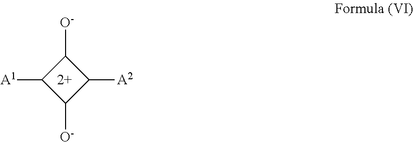

In Formula (VI), A¹ and A² each independently represent a substituted or unsubstituted hydrocarbon ring or heterocyclic group.

The hydrocarbon ring group is preferably a 5 to 20-membered monocyclic or condensed ring group. The hydrocarbon ring group may be an aromatic ring or a non-aromatic ring. Carbon atoms constituting the hydrocarbon ring may be replaced with atoms other than hydrogen atoms. For example, one or more carbon atoms constituting the hydrocarbon ring may be C═O, C═S, or C═NR(R represents a hydrogen atom or a C₁₋₁₀ alkyl group). Furthermore, one or more carbon atoms constituting the hydrocarbon ring may have substituents, and specific examples of the substituents can be selected from the Substituent Group G described below. Examples of the hydrocarbon ring group include, but not limited to, the following groups.

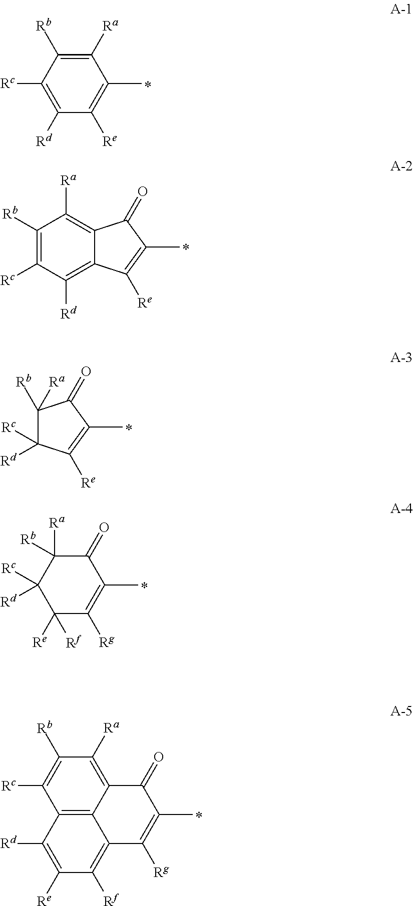

In the above-described formula, * represents a site linking to a squarylium skeleton, and R^{a} to R^{g} each represent a hydrogen atom or a substituent, and if possible, these may be mutually linked to form a cyclic structure. The substituent can be selected from the substituent Group G described later.

Particularly, the following examples are preferable.

Groups represented by the formula A-1 in which R^{c} —N(R^{c1})(R^{c2}), R^{c1} represents and R^{c2} each represent a hydrogen atom or a substituted or un-substituted alkyl group having 1 to 10 carbons and R^{b} and R^{d} represent a hydrogen atom, that is, groups represented by the following formula A-1a.

Groups represented by the formula A-2 in which R^{e} represents a hydroxy group, that is, groups represented by the following formula A-2a.

Groups represented by the formula A-3 in which R^{e} represents a hydroxy group and R^{e} and R^{d} represent a hydrogen atom, that is, groups represented by the following formula A-3a.

Groups represented by the formula A-4 in which R^{g} represents a hydroxy group and R^{a}, R^{b}, R^{e} and R^{f} represent a hydrogen atom, that is, groups represented by the following formula A-4a.

Groups represented by the formula A-5 in which R^{g} represents a hydroxy group, that is, groups represented by the following formula A-5a.

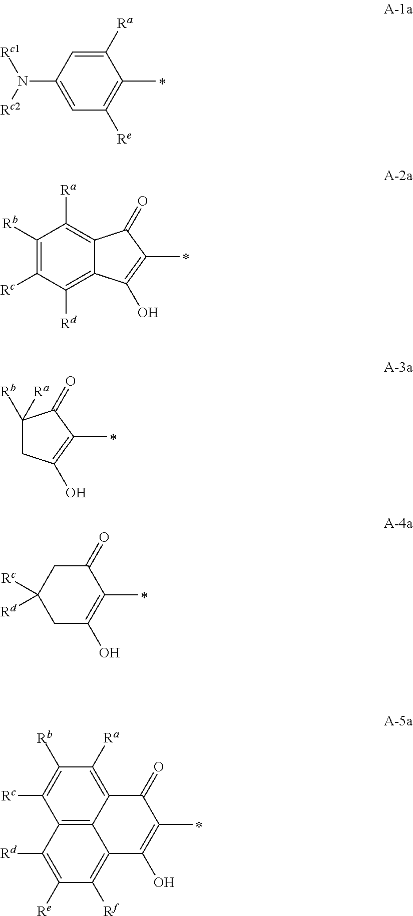

In the above-described formula A-1a, R^{c1} and R^{c2} each represent independently a hydrogen atom or a substituted or un-substituted alkyl group having 1 to 10 carbons; other symbols in the above-described formula have the same meaning as those in the above-described formulae A-1 to A-5, respectively. Examples of the substituent on the alkyl group include substituents in the substituent Group G described later, and also the preferable range thereof is the same as for the substituent Group G. When R^{c1} and R^{c2} represent a substituted or un-substituted alkyl group, these may be mutually linked to form a nitrogen-containing heterocyclic group. At least one of R^{c1} and R^{c2} may be linked to a carbon atom of a benzene ring in the formula A-1a to form a condensed ring. For example, the following formulae A-1b and A-1c may be used.

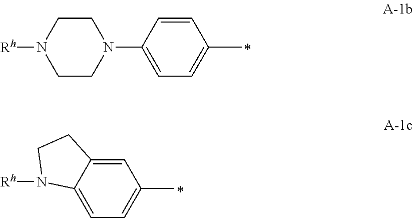

In the formula, * represents a site linking to a squarylium skeleton, and R^{h} represents a hydrogen atom or a substituent. Examples of the substituent include substituents in the substituent Group G described later. R^{h} is preferably a substituent containing at least one benzene ring.

The heterocyclic group is preferably a 5 to 20-membered monocyclic or condensed ring group. The heterocyclic group has at least one of a nitrogen atom, a sulfur atom and an oxygen atom as a ring constituent atom. At least one carbon atom may be contained as a ring constituent atom, and a hetero atom or a carbon atom constituting a hetero ring may be substituted with an atom other than a hydrogen atom. For example, at least one sulfur atom constituting a hetero ring may be a sulfur atom of S═O or S(O)₂, and at least one carbon atom constituting a hetero ring may be a carbon atom of C═O, C═S or C═NR(R represents a hydrogen atom or a C₁₋₁₀ alkyl group). The heterocyclic group may be an aromatic ring or a non-aromatic ring. At least one hetero atom and/or carbon atom constituting a heterocyclic group may have a substituent, and specific examples of the substituent can be selected from the substituent Group G described later. Examples of the above-described heterocyclic group include, but are not limited to, the following groups.

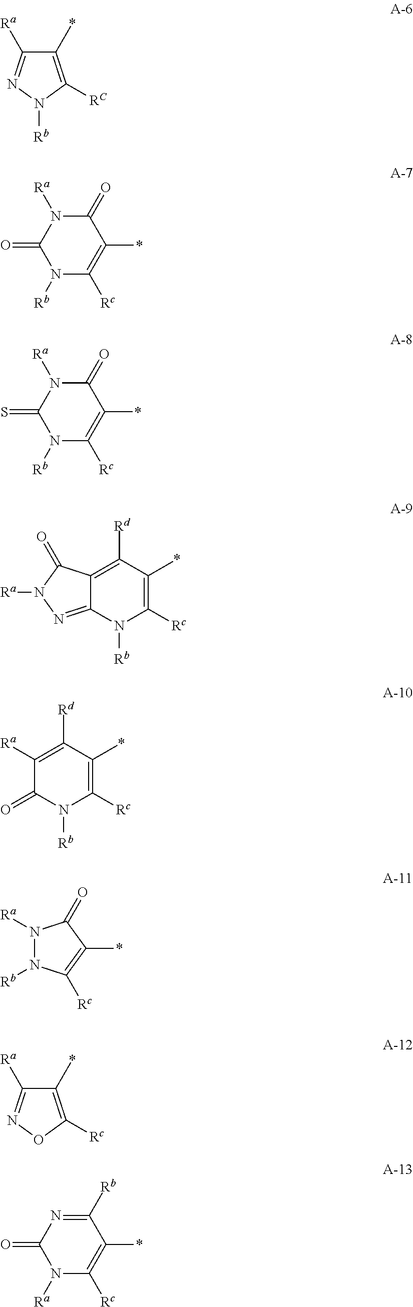

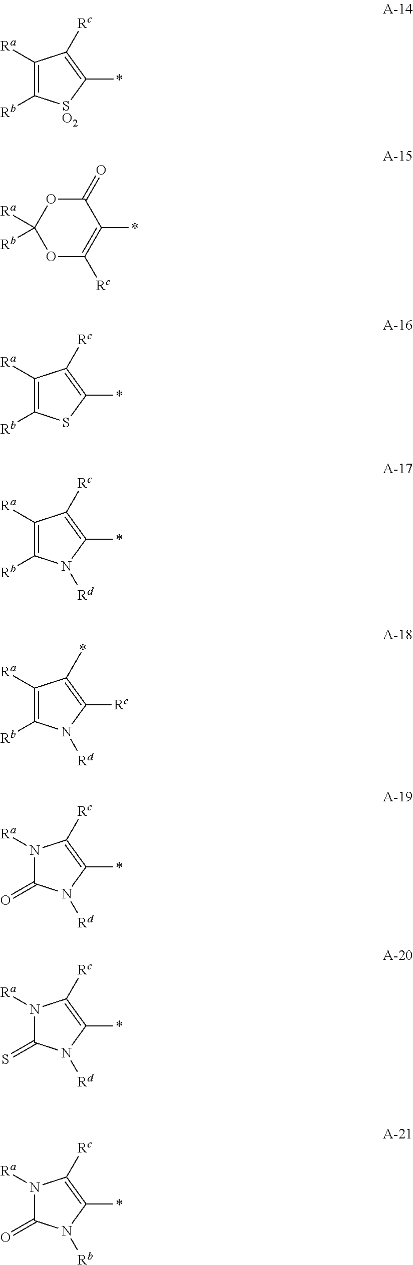

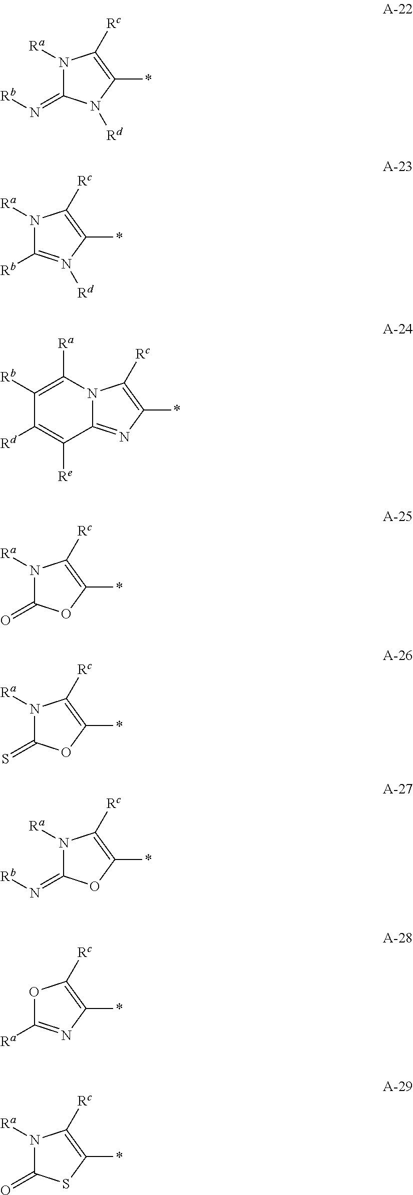

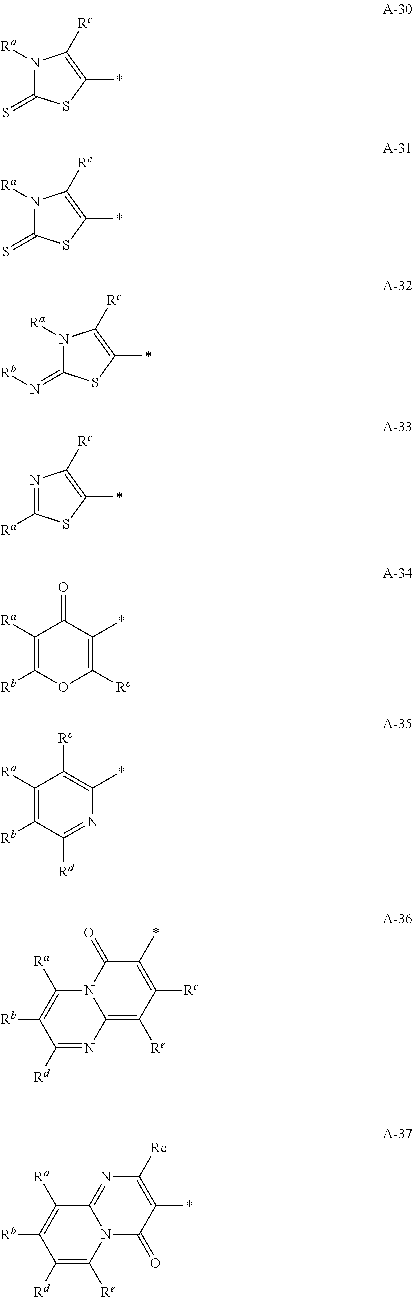

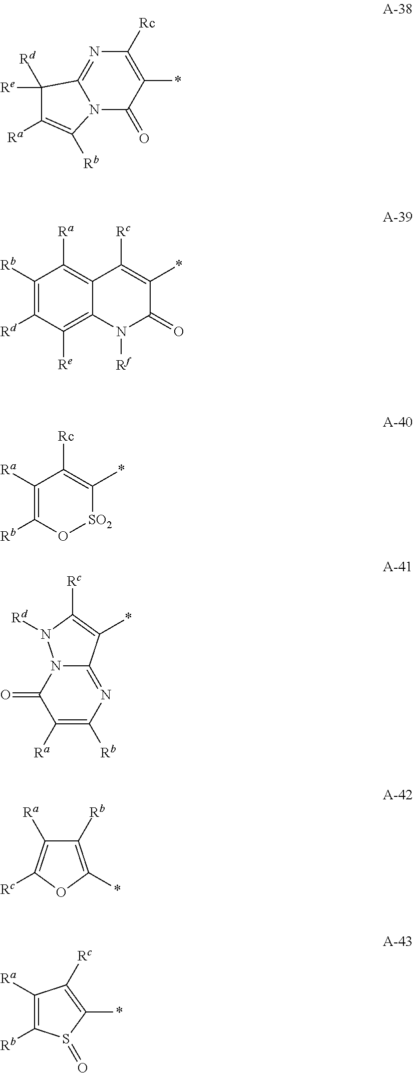

In the above-described formula, * represents a site linking to a squarylium skeleton, R^{a} to R^{f} each represent a hydrogen atom or a substituent, and if possible, these may be mutually linked to form a cyclic structure. The substituent can be selected from the substituent Group G described later.

In the formulae A-6 to A-43, Rc represents preferably a hydroxy group (OH) or a hydrothioxy group (SH).

Hydrocarbon ring groups represented by A-1, A-2 and A-4 are preferable. A-1a, A-2a and A-4a are more preferable. Hydrocarbon ring groups represented by A-1 and A-2 are particularly preferable, and A-1a and A-2a are more preferable. Hydrocarbon ring groups represented by A-1a are further preferable, and among them, hydrocarbon ring groups represented by A-1a in which R^{a} and R^{e} represent a hydrogen atom or a hydroxyl group are preferable.

Heterocyclic groups represented by A-6, A-7, A-8, A-9, A-10, A-11, A-14, A-24, A-34, A-37 and A-39 are preferable. Heterocyclic groups represented by A-6, A-7, A-8, A-9, A-11, A-14, A-34 and A-39 are particularly preferable. In these formulae, Rc represents more preferably a hydroxy group (OH) or a hydrothioxy group (SH).

It is particularly preferable that at least one of A¹ and A² in the above-described formula (VI) is A-1 (more preferably A-1a).

The above-described hydrocarbon ring group and the heterocyclic group may have at least one substituent, and examples of the substituent include substituents in the substituent Group G as described below.

### Substituent Group G:

substituted or un-substituted linear chain, branched chain or cyclic alkyl groups having 1 to 18 carbons (preferably having 1 to 8 carbons) (for example, methyl, ethyl, propyl, isopropyl, n-butyl, isobutyl, sec-butyl, t-butyl, cyclohexyl, methoxyethyl, ethoxycarbonylethyl, cyanoethyl, diethylaminoethyl, hydroxyethyl, chloroethyl, acetoxyethyl, trifluoromethyl and the like); substituted or un-substituted aralkyl groups having 7 to 18 carbons (preferably having 7 to 12 carbons) (for example, benzyl, carboxybenzyl and the like); substituted or un-substituted alkenyl groups having 2 to 18 carbons (preferably having 2 to 8 carbons) (for example, vinyl and the like); substituted or un-substituted alkynyl groups having 2 to 18 carbons (preferably having 2 to 8 carbons) (for example, ethynyl and the like); substituted or un-substituted aryl groups having 6 to 18 carbons (preferably having 6 to 10 carbons) (for example, phenyl, 4-methylphenyl, 4-methoxyphenyl, 4-carboxyphenyl, 3,5-dicarboxyphenyl and the like);

substituted or un-substituted acyl groups having 2 to 18 carbons (preferably having 2 to 8 carbons) (for example, acetyl, propionyl, butanoyl, chloroacetyl and the like); substituted or un-substituted alkyl or arylsulfonyl groups having 1 to 18 carbons (preferably having 1 to 8 carbons) (for example, methanesulfonyl, p-toluenesulfonyl and the like); alkylsulfinyl groups having 1 to 18 carbons (preferably having 1 to 8 carbons) (for example, methanesulfinyl, ethanesulfinyl, octanesulfinyl and the like); alkoxycarbonyl groups having 2 to 18 carbons (preferably having 2 to 8 carbons) (for example, methoxycarbonyl, ethoxycarbonyl and the like); aryloxycarbonyl groups having 7 to 18 carbons (preferably having 7 to 12 carbons) (for example, phenoxycarbonyl, 4-methylphenoxycarbonyl, 4-methoxyphenylcarbonyl and the like); substituted or un-substituted alkoxy groups having 1 to 18 carbons (preferably having 1 to 8 carbons) (for example, methoxy, ethoxy, n-butoxy, methoxyethoxy and the like); substituted or un-substituted aryloxy groups having 6 to 18 carbons (preferably having 6 to 10 carbons) (for example, phenoxy, 4-methoxyphenoxy and the like); alkylthio groups having 1 to 18 carbons (preferably having 1 to 8 carbons) (for example, methylthio, ethylthio and the like); arylthio groups having 6 to 10 carbons (for example, phenylthio and the like);

substituted or un-substituted acyloxy groups having 2 to 18 carbons (preferably having 2 to 8 carbons) (for example, acetoxy, ethylcarbonyloxy, cyclohexylcarbonyloxy, benzoyloxy, chloroacetyloxy and the like); substituted or un-substituted sulfonyloxy groups having 1 to 18 carbons (preferably having 1 to 8 carbons) (for example, methanesulfonyloxy and the like); substituted or un-substituted carbamoyloxy groups having 2 to 18 carbons (preferably having 2 to 8 carbons) (for example, methylcarbamoyloxy, diethylcarbamoyloxy and the like); an un-substituted amino group or substituted amino groups having 1 to 18 carbons (preferably having 1 to 8 carbons) (for example, methylamino, dimethylamino, diethylamino, anilino, methoxyphenylamino, chlorophenylamino, morpholino, piperidino, pyrrolidino, pyridylamino, methoxycarbonylamino, n-butoxycarbonylamino, phenoxycarbonylamino, methylcarbamoylamino, phenylcarbamoylamino, ethylthiocarbamoylamino, methylsulfamoylamino, phenylsulfamoylamino, acetylamino, ethylcarbonylamino, ethylthiocarbonylamino, cyclohexylcarbonylamino, benzoylamino, chloroacetylamino, methanesulfonylamino, benzenesulfonylamino and the like);

substituted or un-substituted carbamoyl groups having 1 to 18 carbons (preferably having 1 to 8 carbons) (for example, un-substituted carbamoyl, methylcarbamoyl, ethylcarbamoyl, n-butylcarbamoyl, t-butylcarbamoyl, dimethylcarbamoyl, morpholinocarbamoyl, pyrrolidinocarbamoyl and the like); an un-substituted sulfamoyl group, substituted sulfamoyl groups having 1 to 18 carbons (preferably having 1 to 8 carbons) (for example, methylsulfamoyl, phenylsulfamoyl and the like); halogen atoms (for example, fluorine, chlorine, bromine and the like); a hydroxyl group; a nitro group; a cyano group; a carboxyl group; hetero ring groups (for example, oxazole, benzoxazole, thiazole, benzothiazole, imidazole, benzoimidazole, indolenine, pyridine, sulfolane, furan, thiophene, pyrazole, pyrrole, chromane, coumarin and the like).

Examples of the dichroic squarylium dye represented by the formula (VI) include, but are not limited to, the following exemplary compounds.

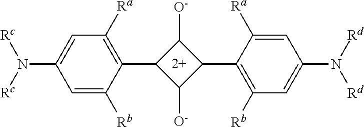

| No. | R^{a} | R^{b} | R^{c} | R^{d} |
|---|---|---|---|---|
| VI-1 | H | H | CH₃ | CH₃ |
| VI-2 | H | H | C₂H₅ | C₂H₅ |
| VI-3 | H | H | CH₃ | C₂H₅ |
| VI-4 | OH | H | CH₃ | CH₃ |
| VI-5 | OH | H | C₂H₅ | C₂H₅ |
| VI-6 | OH | H | CH₃ | C₂H5 |
| VI-7 | OH | OH | CH₃ | CH₃ |
| VI-8 | OH | OH | C₂H₅ | C₂H₅ |
| VI-9 | OH | OH | CH₃ | C₂H₅ |
| VI-10 | OH | CH3 | CH₃ | CH₃ |

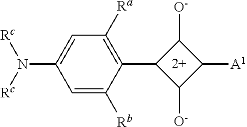

| No. | R^{a} | R^{b} | R^{c} | A |
|---|---|---|---|---|
| VI-11 | H | H | CH₃ | 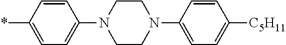 |
| VI-12 | H | H | C₂H₅ | 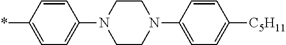 |
| VI-13 | OH | H | C₂H₅ | 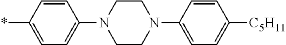 |
| VI-14 | OH | H | C₂H₅ | 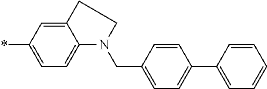 [SMILES: *c1ccc2c(c1)CCN2Cc1ccc(-c2ccccc2)cc1] |
| VI-15 | OH | H | C₂H₅ | 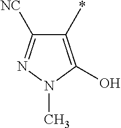 [SMILES: *c1c(C#N)nn(C)c1O] |
| VI-16 | OH | H | C₂H₅ | 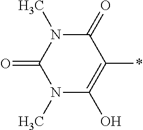 [SMILES: *c1c(O)n(C)c(=O)n(C)c1=O] |
| VI-17 | OH | H | C₂H₅ | 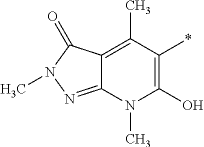 [SMILES: *c1c(C)c2c(=O)n(C)nc-2n(C)c1O] |
| VI-18 | OH | H | C₂H₅ | 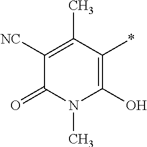 [SMILES: *c1c(C)c(C#N)c(=O)n(C)c1O] |
| VI-19 | OH | H | C₂H₅ | 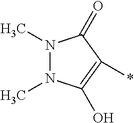 [SMILES: *c1c(O)n(C)n(C)c1=O] |
| VI-20 | OH | H | C₂H₅ | 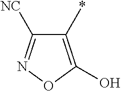 [SMILES: *c1c(C#N)noc1O] |
| VI-21 | OH | H | C₂H₅ | 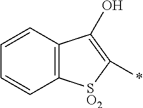 [SMILES: *C1=C(O)c2ccccc2S1(=O)=O] |
| VI-22 | OH | H | C₂H₅ | 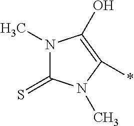 [SMILES: *c1c(O)n(C)c(=S)n1C] |
| VI-23 | OH | H | C₂H₅ | 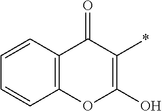 [SMILES: *c1c(O)oc2ccccc2c1=O] |
| VI-24 | OH | H | C₂H₅ | 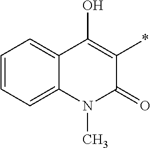 [SMILES: *c1c(O)c2ccccc2n(C)c1=O] |
| VI-25 | H | H | C₂H₅ | 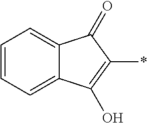 [SMILES: *C1=C(O)c2ccccc2C1=O] |
| VI-26 | H | H | C₂H₅ | 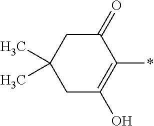 [SMILES: *C1=C(O)CC(C)(C)CC1=O] |

The dichroic squarylium dye represented by the above-described formula (VI) in the present invention can be easily synthesized according to methods described in the Journal of Chemical Society, Perkin Trans. 1 (2000), 599-603, Synthesis (2002), No. 3, 413-417 and the like.

In the dichroic dye to be used in the present invention, the angle made by the transition moment and the molecular long axis is preferably 0° or more and 20° or less, more preferably 0° or more and 15° or less, further preferably 0° or more and 10° or less, particularly preferably 0° or more and 5° or less. Here, the molecular long axis means an axis linking two atoms at which the interatomic distance is maximum in a compound. The direction of the transition moment can be determined by molecular orbital calculation, and the angle made by the molecular long axis can also be calculated therefrom.

The dichroic dye that is used in the present invention preferably has a rigid linear structure. Specifically, the molecular length is preferably 17 Å or more, more preferably 20 Å or more, and most preferably 25 Å or more. The aspect ratio is preferably 1.7 or more, more preferably 2 or more, and most preferably 2.5 or more. In such a case, satisfactory uniaxial alignment is achieved to provide a dichroic dye layer and a stereo image print exhibiting high polarization performance.

Here, the molecular length is the sum of the van der Waals radii of two atoms on both ends of a compound and the maximum interatomic distance in the compound. The aspect ratio is a value of the molecular length to the molecular width. The molecular width is the sum of the van der Waals radii of two atoms on both ends of a compound and the maximum atomic distance where each atom of the compound is projected onto a plane perpendicular to the molecular major axis.

The dichroic dye composition contains at least one kind of dye represented by Formula (I), (II), (III), (IV), or (VI) as the main component. Specifically, the content of the dye represented by Formula (I), (II), (III), (IV), or (VI) is preferably 80% by mass or more and most preferably 90% by mass or more relative to the total dye content. The upper limit is 100% by mass, i.e., all the dyes contained in the composition may be dyes represented by Formula (I), (II), (III), (IV), or (VI).

The content of the at least one kind of dichroic dye represented by Formula (I), (II), (III), (IV), or (VI) is preferably 20% by mass or more and most preferably 30% by mass or more relative to the total solid content excluding the solvent contained in the dichroic dye composition. Though the upper limit is not particularly defined, the content of the at least one kind of dichroic dye represented by Formula (I), (II), (III), (IV), or (VI) is preferably 95% by mass or less and more preferably 90% by mass or less relative to the total solid content excluding the solvent contained in the dichroic dye composition, in order to develop the advantageous effects of the additives, in the case containing other additives such as a surfactant mentioned below.

When a coating solution of the dichroic dye composition is applied onto an alignment film, the dichroic dye aligns at a tilt angle of the alignment film at the interface to the alignment film and at a tilt angle of the air interface at the interface to the air. After the application of the coating solution of the dichroic dye composition of the present invention onto the surface of the alignment film, the dichroic dye is uniformly aligned (monodomain alignment) to achieve horizontal alignment.

In the present invention, the tilt angle is defined by the long axis direction of the dichroic dye molecule and the interface (to the alignment film or the air). Preferred optical performance as a stereo image print can be effectively achieved by reducing the tilt angle on the alignment film side to some extent to horizontally align the dichroic dye. Accordingly, from the viewpoint of preventing crosstalk and ghost images, the tilt angle on the alignment film side is preferably 0° to 10°, more preferably 0° to 5°, more preferably 0° to 2°, and most preferably 0° to 1°. The tilt angle on the air surface side is preferably 0° to 10°, more preferably 0° to 5°, and most preferably 0° to 2°.

In general, the tilt angle of the dichroic dye on the interface to the air can be adjusted by selecting any optional additive (e.g., horizontal alignment enhancers described in Japanese Patent Laid-Open Nos. 2005-99248, 2005-134884, 2006-126768, and 2006-267183) to achieve a preferable horizontally aligned state in a dichroic dye layer of the present invention.

The tilt angle of the dichroic dye on the alignment film side can be controlled using an agent controlling the tilt angle of the alignment film.

The dichroic dye composition may contain one or more additives in addition to the dichroic dye. The dichroic dye composition may contain reagents having at least one function as a non-liquid crystalline multifunctional monomer having a radically polymerizable group, a polymerization initiator, a wind unevenness-preventing agent, a repelling-preventing agent, a saccharide, a fungicide, an antibacterial agent, or a germicide.

In a preferred stereo image print of the present invention, the X-ray diffractometry of the image layer shows a diffraction peak based on a periodic structure in the direction perpendicular to the alignment axis, where at least one diffraction peak has a period of 3.0 to 15.0 Å, and the maximum intensity of the diffraction peak is not present in the range of ±70° of the film normal direction in a plane perpendicular to the alignment axis.

Here, the alignment axis is the direction in which the image layer of a dichroic dye shows the highest absorbance for linearly polarized light and is usually coincident with the direction of alignment treatment. For example, in a film of the dichroic dye composition fixed in the horizontal alignment, the alignment axis is in the film surface plane and is coincident with the alignment treatment direction (in the present invention, in a rubbing alignment film, the alignment axis is coincident with the rubbing direction; and in a photoalignment film, the alignment axis is coincident with the direction of the highest birefringence developed by irradiation of the photoalignment film with light).

In general, the dichroic dye (in particular, azo dichroic dye) forming the image layer is composed of a rod-like molecule having a high aspect ratio (the length of the major axis of the molecule/the length of the minor axis of the molecule) and has a transition moment absorbing visible light in the direction approximately coincident with the direction of the molecular long axis (Non-Patent Literature: Dichroic Dyes for Liquid Crystal Displays). The image layer composed of the dichroic dye, therefore, has a higher dichroic ratio with decreases in the average angle defined by the long axis of the dichroic dye molecules and the alignment axis and the variation of the angle.

The image layer preferably shows a diffraction peak based on the period in the direction perpendicular to the alignment axis. The period corresponds to, for example, the intermolecular distance in the direction of the molecular minor axis of the dichroic dye aligned so as to have the molecular long axis in the alignment axis direction. In the present invention, the period is preferably in the range of 3.0 to 15.0 Å, more preferably 3.0 to 10.0 Å, more preferably 3.0 to 6.0 Å, and most preferably 3.3 to 5.5 Å.

Furthermore, it is preferred that no maximum value is observed in the intensity distribution of diffraction peaks of the dichroic image layer measured in the range of ±70° of the film normal direction in a plane perpendicular to the alignment axis. A maximum value of the diffraction peak intensity observed in such measurement indicates that the molecular packing is anisotropic in the direction perpendicular to the alignment axis, i.e., in the molecular minor axis direction. Specific examples of such an aggregation state include crystals, hexatic phases, and crystal phases. In anisotropic packing, the discontinuous packing generates domains and grain boundaries, which may cause haze, alignment disorder in each domain, and depolarization. In the image layer according to the present invention, since the packing in the direction perpendicular to the alignment axis is not anisotropic, a uniform film is formed without generating domains and grain boundaries. Specific examples of such an aggregation state include, but not limited to, nematic phases, smectic A phases, and supercooling states of these phases. Furthermore, the aggregation state may be a mixture of multiple aggregation states that can develop the above-described characteristics of diffraction peaks as a whole.

The image layer composed of the dichroic dye is generally used for incident light at an angle of perpendicular or approximately perpendicular to the film and therefore preferably has a high dichroic ratio in the in-plane direction. Accordingly, the image layer of the dichroic dye preferably has a periodic structure in the in-plane direction to show a diffraction peak based on the periodic structure.

The dichroic image layer preferably shows a diffraction peak based on the period in the direction parallel to the alignment axis. In particular, molecules adjacent to each other in the direction perpendicular to the alignment axis preferably form a layer that is laminated in the direction parallel to the alignment axis. Such an aggregation state is similar to a highly well-ordered smectic phase rather than a nematic phase and provides a high dichroic ratio. The period may be, for example, a length corresponding to the molecular length or twice thereof and is preferably in the range of 3.0 to 50.0 Å, more preferably 10.0 to 45.0 Å, more preferably 15.0 to 40.0 Å, and most preferably 25.0 to 35.0 Å.

The image layer of the dichroic dye preferably shows a diffraction peak having a half-value width of 1.0 Å or less.

Here, the half-value width in one diffraction peak obtained by X-ray diffractometry is a difference in period between two points, at a height half the peak height from the baseline, on both sides of the peak of the diffraction curve.

An image layer showing a diffraction peak having a half-value width of 1.0 Å or less in X-ray diffractometry is presumed to have a high dichroic ratio by the following reasons.

A large variation in angle defined by the long axis of dichroic dye molecules and an alignment axis makes a variation in intermolecular distance large. If a periodic structure is present, the periodic value of the structure also varies to make the diffraction peak obtained by X-ray diffractometry broad, resulting in a large half-value width.

In contrast, a sharp diffraction peak having a half-value width of less than a certain value indicates a small variation in the intermolecular distance and a small average angle defined by the major axis of dichroic dye molecules and an alignment axis, i.e., indicates that the molecules are aligned in a highly oriented state, in other words, they develop a high dichroic ratio.

In the present invention, the half-value width of the diffraction peak is 1.0 Å or less, preferably 0.90 Å or less, more preferably 0.70 Å or less, and most preferably 0.50 Å or less and preferably 0.05 Å or more. A half-value width exceeding the upper limit allows the variation in intermolecular distance of the dye large to inhibit the alignment from being well ordered, whereas a half-value width lower than the lower limit tends to cause alignment distortion to generate domains and grain boundaries, which may cause haze, alignment disorder in each domain, and depolarization.

The period and the half-value width of the diffraction peak of a dichroic image layer can be determined from an X-ray profile measured with an X-ray diffractometer for thin-film evaluation (manufactured by Rigaku Corp., trade name: “ATX-G”, an in-plane optical system) or an equivalent apparatus.

The X-ray diffractometry of an image layer according to the present invention is performed, for example, by the following procedure.

The image layer is subjected to in-plane measurement for every 15° in all directions. Diffraction is measured by rotating the sample in a plane parallel to the substrate under the state that the angle at which a peak is observed is fixed, i.e., by φ scan, and the direction showing high peak intensity in the substrate surface plane is determined. The period and half-value width can be determined using the peak of in-plane measurement in the resulting direction.

### Protective Layer

The protective layer protects the dichroic image of the image layer. For example, a polymer film can be used as the protective layer. The polymer film that can be used as the protective layer is the same as the polymer film that can be used as the transparent support. The protective layer preferably contains a UV absorber. The durability of the stereo image print can be improved by addition of a UV absorber to the protective layer. Any UV absorber can be used without particular limitation. Specifically, the UV absorbers described in Japanese Patent Laid-Open No. Hei 7-11056 can be used.

The protective layer may have a laminated structure of two or more layers. The protective layer may be a coating film or a hardened film formed by coating. Such a case is described below. In the case of a protective layer composed of two or more layers, at least one layer may contain a UV absorber.

### Patterned Retardation Layer

The retardation layer of the stereo image print of the present invention is patterned into first domains having an Re of 0 nm and second domains having an Re of a ½ wavelength such that the in-plane slow axes of the second domains define an angle of 45° with respect to the absorption axes of dichroic images in the first laminate and the second laminate. The retardation layer satisfying such characteristics is preferably formed by aligning a curable liquid crystal composition in a desired alignment state and fixing the state by facilitating hardening and is further preferably formed by pattern-exposing a film of the curable liquid crystal composition to cause expression or extinction of in-plane retardation and thereby form first and second domains. The retardation layer of this embodiment will now be described in detail.

The retardation layer of the embodiment can be composed of a liquid crystal compound, in particular, a curable composition containing a liquid crystal compound having at least one reactive group. The control of the slow axis direction by pattern exposure described below and the expression or extinction of in-plane retardation can be easily performed by forming the retardation layer from a curable composition containing a liquid crystal compound having at least one reactive group.

In general, liquid crystal compounds are classified into a rod type and a discotic type based on their shapes. Furthermore, each type includes a low-molecular type and a high-molecular type. The “high molecular type” generally means a polymer having a degree of polymerization of 100 or more (Kobunshi Butsuri Souten-i Dainamikusu (Polymer Physics and Phase Transition Dynamics), written by Masao Doi, p. 2, Iwanami Shoten, Publishers, 1992). In the present invention, any liquid crystal compound can be used, and can be a rod-like liquid crystal compound or a discotic liquid crystal compound. Furthermore, two or more rod-like liquid crystal compounds, two or more discotic liquid crystal compounds, or a mixture of rod-like and discotic liquid crystal compounds may be used. From the viewpoints of reducing changes in temperature and humidity, the optically-anisotropic layer is more preferably formed of a rod-like or discotic liquid crystal compound having one or more reactive groups. More preferably, at least one kind of liquid crystal compound has two or more reactive groups in one liquid crystal molecule. A mixture of two or more liquid crystal compounds may be used. In such a case, at least one kind of liquid crystal compound preferably has two or more reactive groups.

It is also preferred the liquid crystal compound have two or more reactive groups having different polymerization characteristics. In this case, a retardation layer containing a polymer having unreacted reactive groups can be produced through selective polymerization of the different reactive groups under controlled conditions. The difference in polymerization conditions may be a difference in wavelength region of ionizing radiation for polymerization immobilization or a difference in polymerization mechanism, but is preferably a difference in combination of a radical reactive group and a cationic reactive group, which is controllable by the type of a polymerization initiator. A combination of a radical reactive group of an acrylic and/or methacrylic group and a cationic reactive group of a vinyl ether, oxetane, and/or epoxy group facilitates the control of the reactivity and is therefore particularly preferred.

Examples of the rod-like liquid crystal compound preferably used include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans, and alkenylcyclohexyl benzonitriles. In addition to these low-molecular liquid crystal compounds, high-molecular liquid crystal compounds also can be used. The high-molecular liquid crystal compounds are polymerization products of low-molecular rod-like liquid crystal compounds having reactive groups. Particularly preferred examples of the low-molecular rod-like liquid crystal compounds having reactive groups are represented by the following Formula (I):

Q¹-L¹-A¹-L³-M-L⁴-A²-L²-Q² Formula (I)

where, Q¹ and Q² each independently represent a reactive group; L¹, L², L³, and L⁴ each independently represent a single bond or a divalent linker; A¹ and A² each independently represent a spacer having 2 to 20 carbon atoms; and M represents a mesogenic group.

Nonlimiting examples of the compound represented by Formula (I) are shown below. The compounds represented by Formula (I) can be synthesized by a method described in National Publication of International Patent Application No. Hei 11-513019 (WO97/00600).

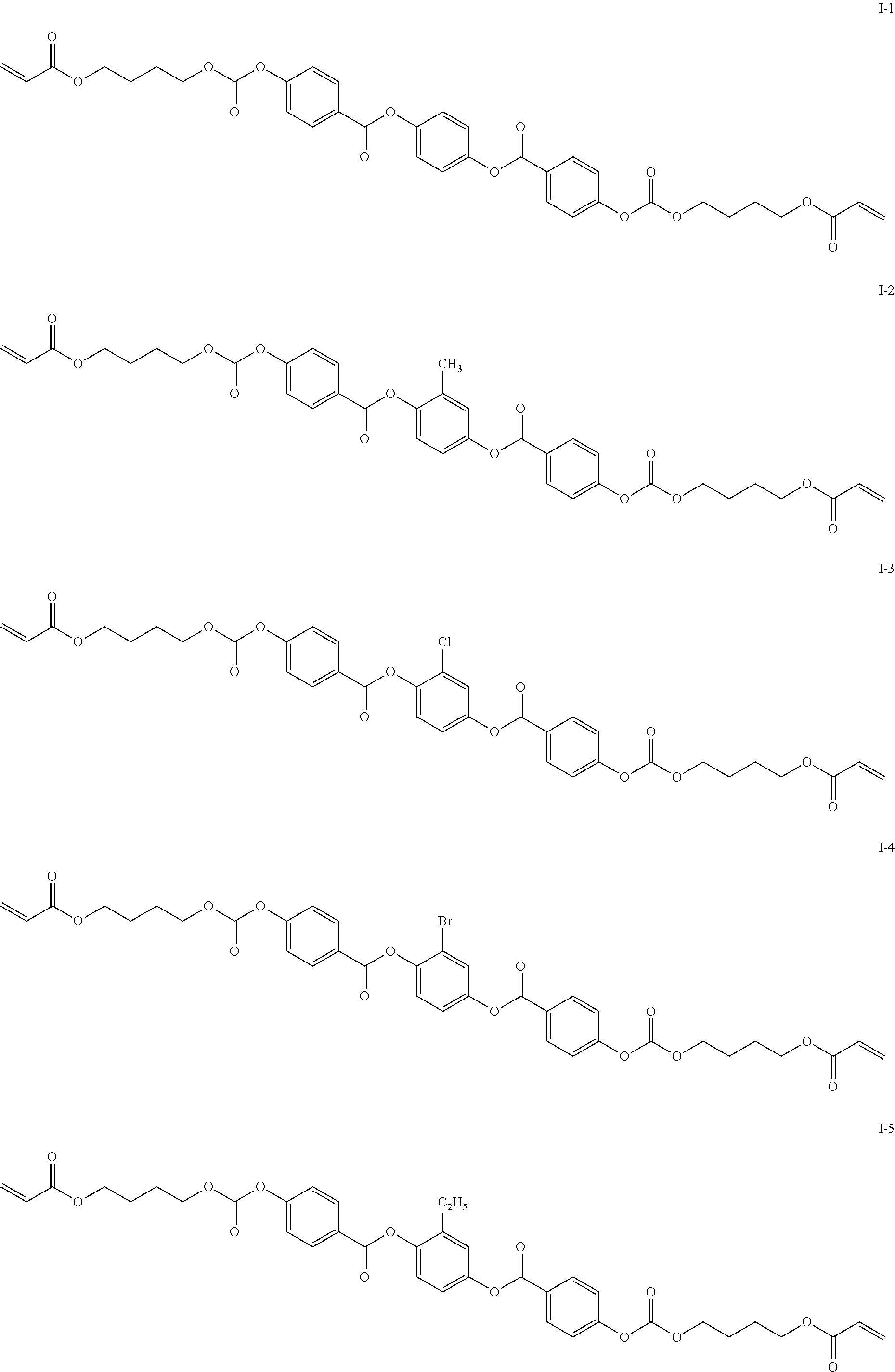

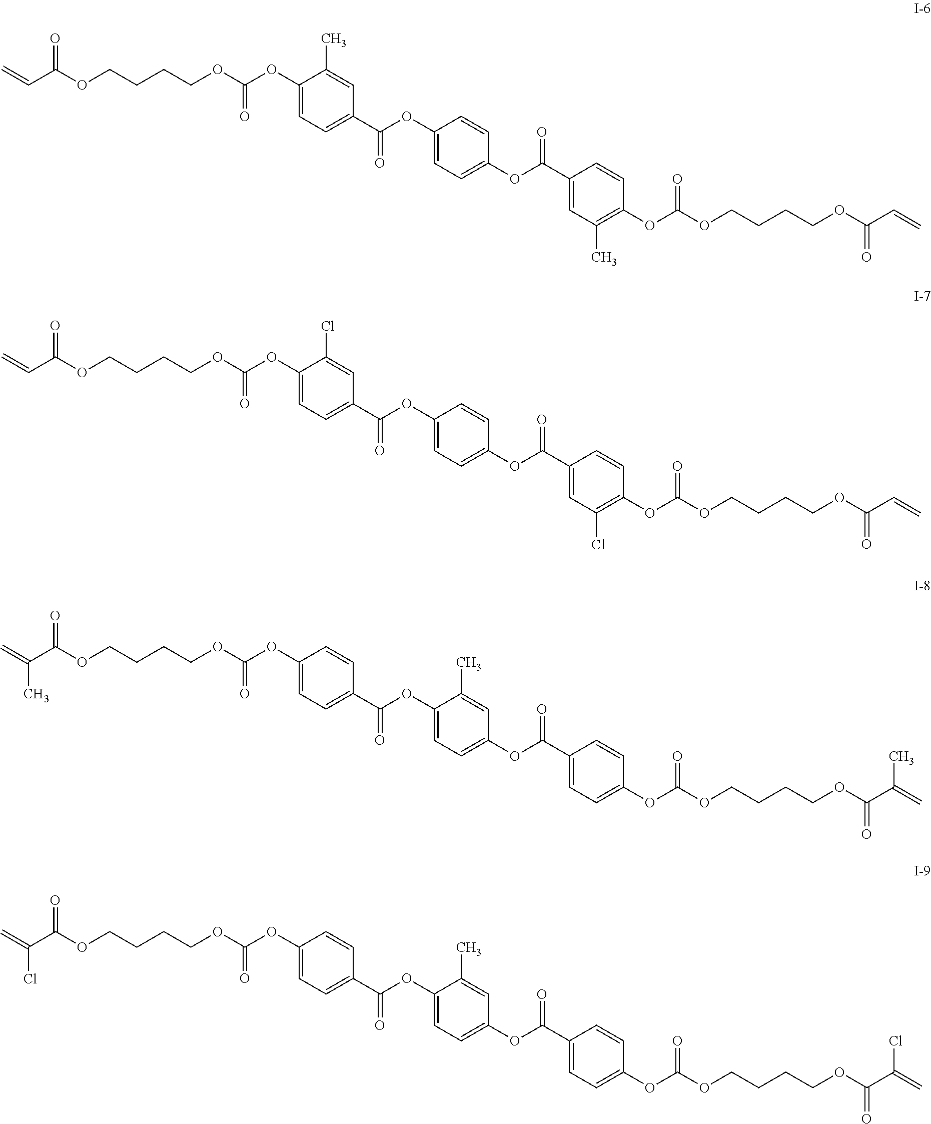

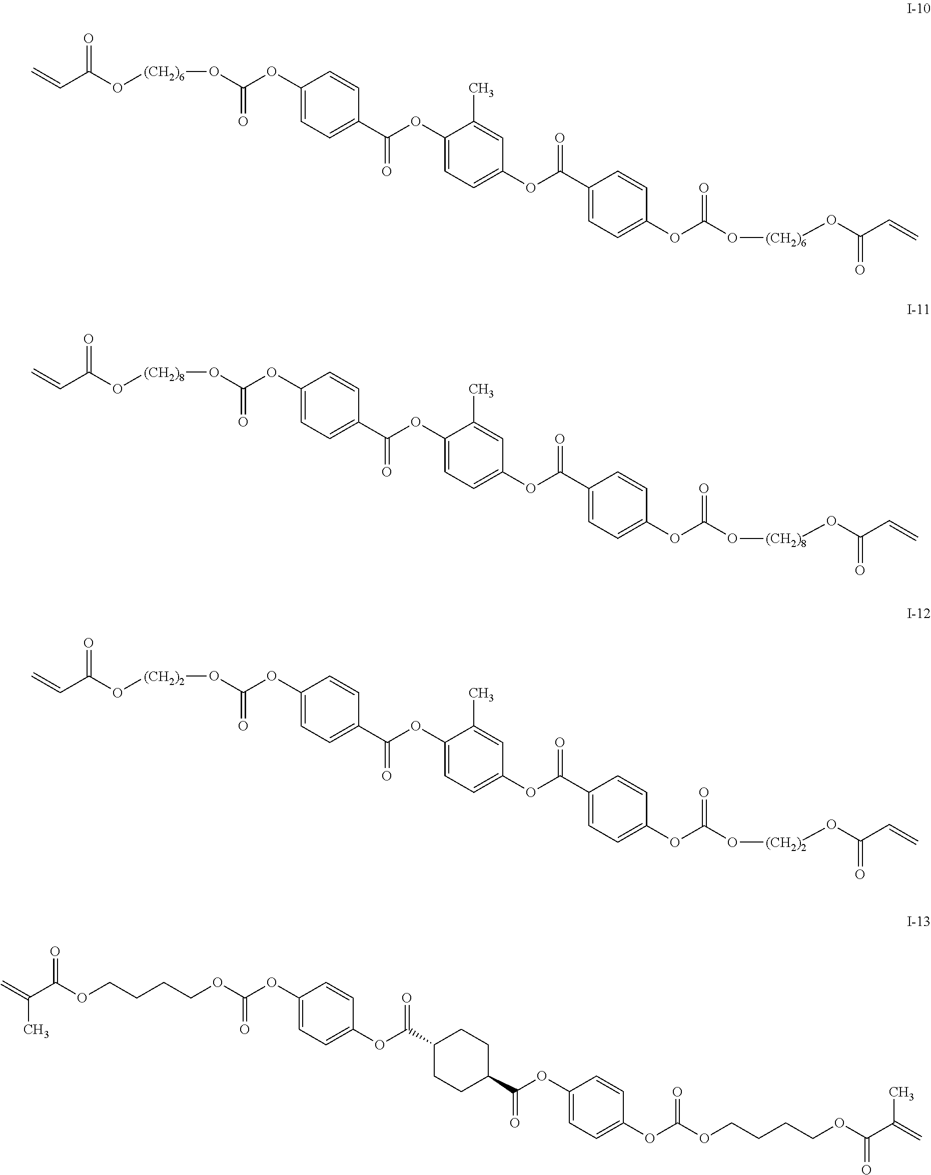

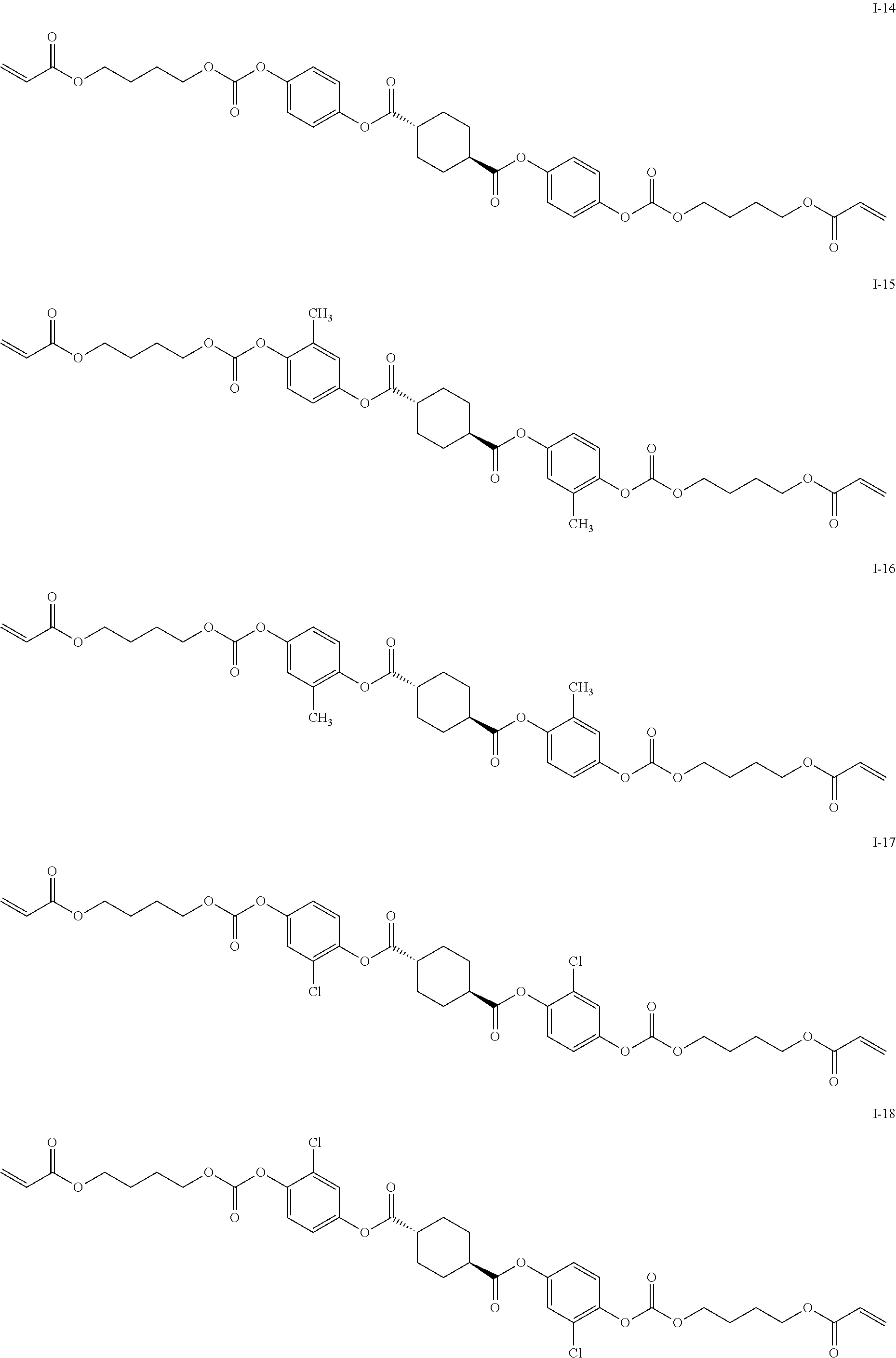

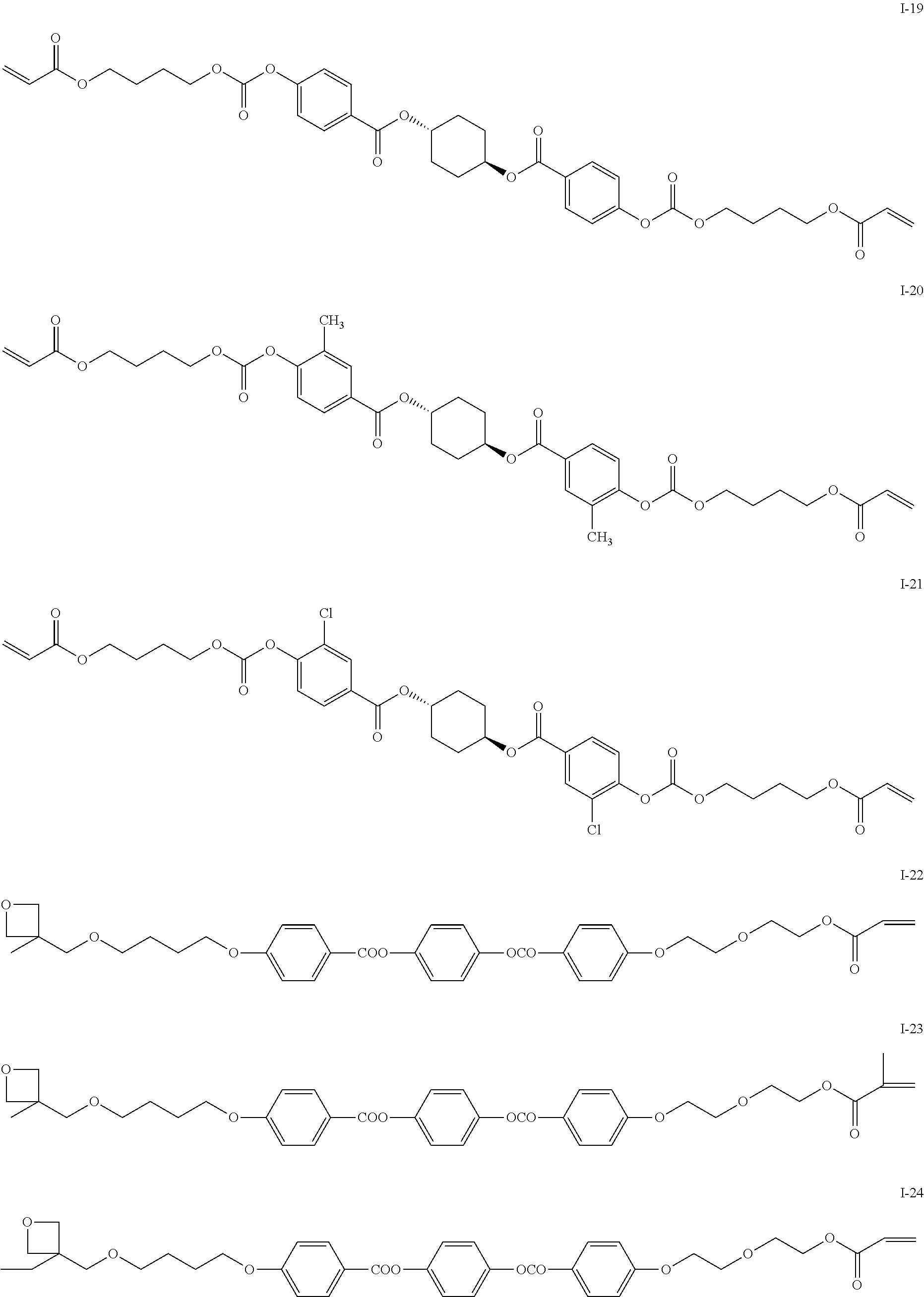

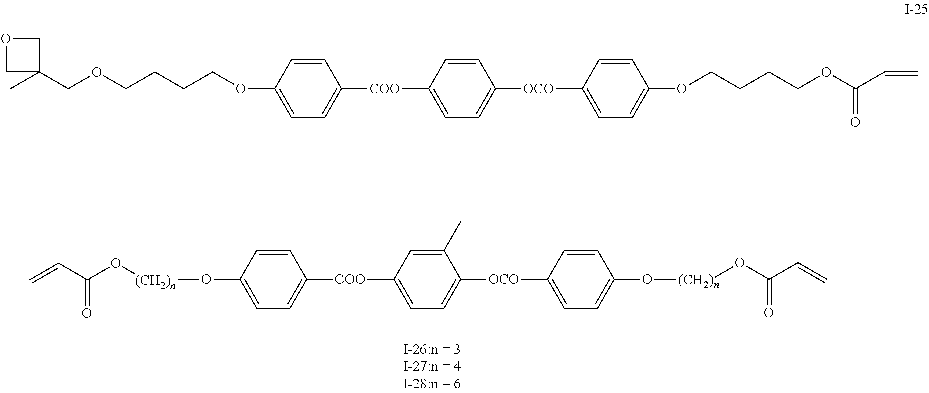

In another embodiment, discotic liquid crystals are used in the retardation layer. The retardation layer is preferably of a liquid crystal discotic compound having a low molecular weight, such as a monomer, or of a polymer prepared by polymerization (hardening) of a polymerizable liquid crystal discotic compound. Examples of the discotic (discoidal) compound include benzene derivatives reported by C. Destrade et al. in Mol. Cryst., vol. 71, p. 111 (1981); truxene derivatives reported by C. Destrade et al. in Mol. Cryst., vol. 122, p. 141 (1985) and in Physics Lett. A, vol. 78, p. 82 (1990); cyclohexane derivatives reported by B. Kohne et al. in Angew. Chem., vol. 96, p. 70 (1984); and azacrown and phenylacetylene microcycles reported by J. M. Lehn et al. in J. Chem. Commun., p. 1794 (1985) and by J. Zhang et al. in J. Am. Chem. Soc., vol. 116, p. 2655 (1994). These discotic (discoidal) compounds generally have a structure composed of a discoidal core at the center of the molecule and radially extending substituent groups (L's), such as linear alkyl groups, alkoxy groups, and substituted benzoyloxy groups. The discotic (discoidal) compounds show liquid crystallinity, and examples thereof include those generally called discotic liquid crystals. Though uniform alignment of aggregations of such molecules exhibits negative uniaxiality, the difference phase layer is not limited to this description. Furthermore, in the present invention, the formation from a discoidal compound does not require that the final product is a compound mentioned above and includes, for example, the cases in which the low molecular discotic liquid crystals having groups reactive to heat, light, etc. are polymerized or crosslinked through reaction by heat, light, etc. to increase the molecular weight and, as a result, lose the liquid crystallinity.

In the present invention, the discotic liquid crystal compound is preferably represented by Formula (III):

D(-L-P)ₙ Formula (III)

where D represents a discoidal core; L represents a divalent linker; P represents a polymerizable group; and n represents an integer of 4 to 12.

In Formula (III), preferable specific examples of the discoidal core (D), the divalent linker (L), and the polymerizable group (P) include (D1) to (D15), (L1) to (L25), and (P1) to (P18), respectively, described in Japanese Patent Laid-Open No. 2001-4837. The contents relating to the discoidal core (D), the divalent linker (L), and the polymerizable group (P) described in this patent application can be preferably incorporated herein.

Preferable examples of the discotic compound are shown below.

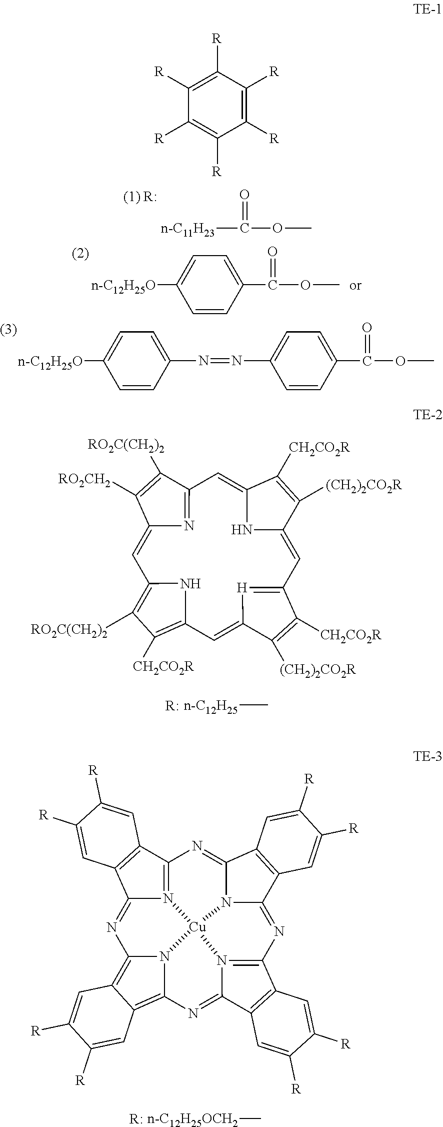

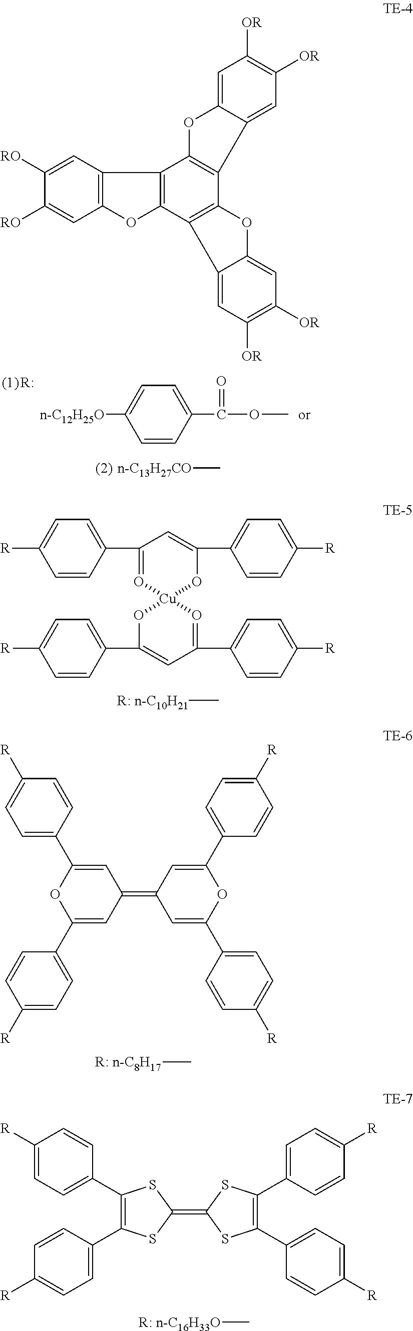

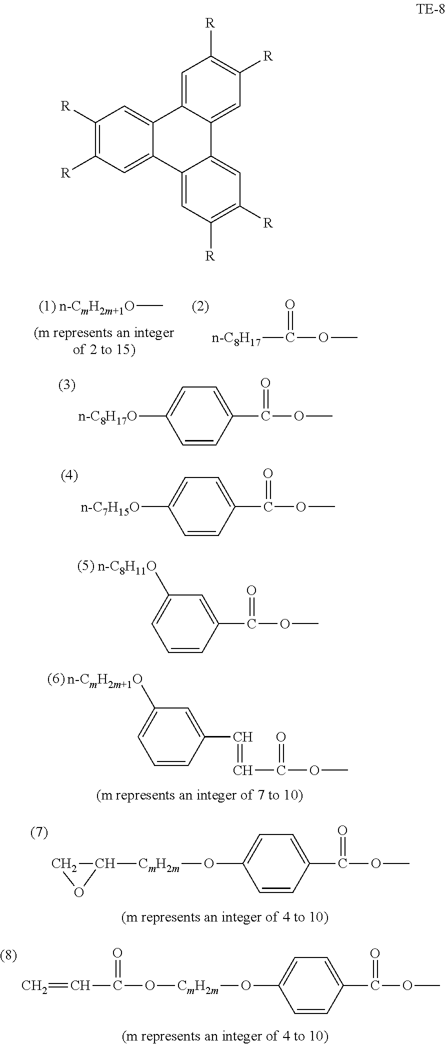

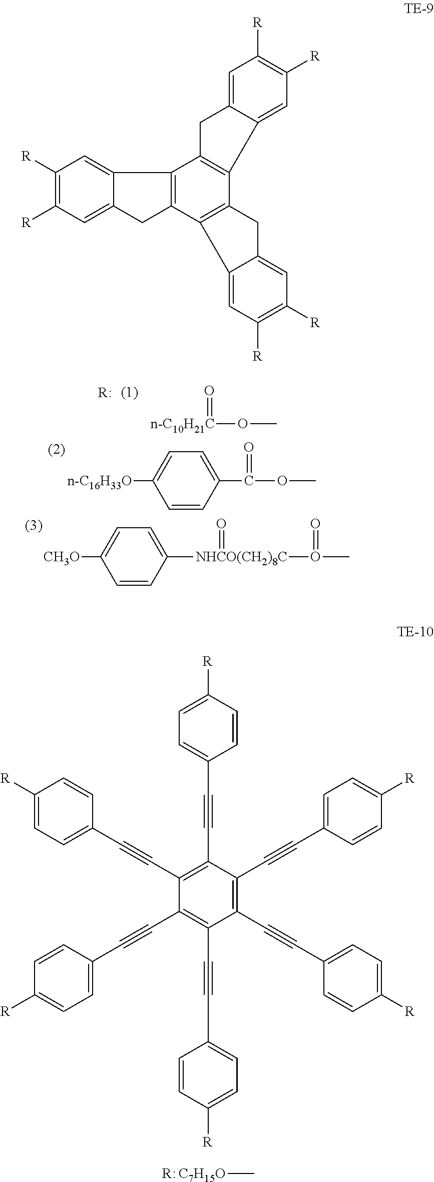

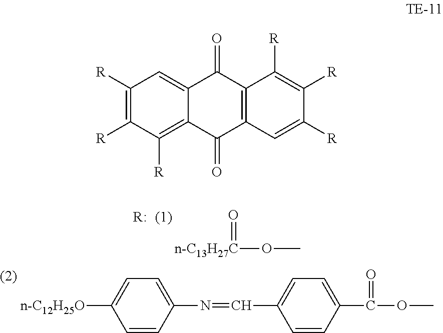

The retardation layer is preferably formed by applying a composition (e.g., coating solution) containing a liquid crystal compound to the surface of an alignment layer described below, aligning the applied composition into an alignment state showing a desired liquid crystal phase, and then fixing the alignment state by irradiation with heat or ionizing radiation.

When the liquid crystal compound is a rod-like liquid crystal compound having a reactive group, the liquid crystal compound is preferably horizontally aligned. When the liquid crystal compound is a discoidal liquid crystal compound having a reactive group, the liquid crystal compound is preferably vertically aligned. Throughout the specification, the term “horizontal alignment” refers to that the molecular major axis of a rod-like liquid crystal is parallel to the horizontal plane of the transparent support. The term “vertical alignment” refers to that the discoidal plane of the core of a discotic liquid crystal compound is perpendicular to the layer plane. In the present specification, however, it is not required to be strictly parallel or perpendicular, and a variation of less than 10 degrees is acceptable. The variation is preferably 0 to 5 degrees, more preferably 0 to 3 degrees, more preferably 0 to 2 degrees, and most preferably 0 to 1 degree.

The composition may contain an additive for facilitating horizontal alignment of liquid crystals. Examples of the additive include compounds described in paragraphs [0055] to [0063] in Japanese Patent Laid-Open No. 2009-223001.

The retardation layer is preferably formed by applying a composition (e.g., coating solution) containing a liquid crystal compound to the surface of an alignment layer described below, aligning the applied composition into an alignment state showing a desired liquid crystal phase, and then fixing the alignment state by irradiation with heat or ionizing radiation. The solvent used for preparing the coating solution is preferably an organic solvent. Examples of the organic solvent include amides (e.g., N,N-dimethylformamide), sulfoxides (e.g., dimethylsulfoxide), heterocycle compounds (e.g., pyridine), hydrocarbons (e.g., benzene and hexane), alkyl halides (e.g., chloroform and dichloromethane), esters (e.g., methyl acetate and butyl acetate), ketones (e.g., acetone and methyl ethyl ketone), and ethers (e.g., tetrahydrofuran and 1,2-dimethoxyethane). Alkyl halides and ketones are preferred. The organic solvents may be used in combination of two or more thereof.

The aligned liquid crystal compound is preferably fixed while maintaining the aligned state. The fixation is preferably performed by polymerization of the reactive groups introduced in the liquid crystal compound. Though polymerization includes thermal polymerization using a thermal polymerization initiator and photo polymerization using a photo polymerization initiator, photo polymerization is preferable. The photo polymerization may be radical polymerization or cationic polymerization. Examples of the photo-radical polymerization initiator include α-carbonyl compounds (described in U.S. Pat. Nos. 2,367,661 and 2,367,670), acyloin ethers (described in U.S. Pat. No. 2,448,828), α-hydrocarbon substituted aromatic acyloin compounds (described in U.S. Pat. No. 2,722,512), polynuclear quinone compounds (described in U.S. Pat. Nos. 3,046,127 and 2,951,758), combinations of triarylimidazole and p-aminophenyl ketone (described in U.S. Pat. No. 3,549,367), acridine and phenazine compounds (described in Japanese Patent Laid-Open No. Sho 60-105667 and U.S. Pat. No. 4,239,850), and oxadiazole compounds (described in U.S. Pat. No. 4,212,970). Examples of the photo-cationic polymerization initiator include organic sulfonium salts, iodonium salts, and phosphonium salts. Organic sulfonium salts are preferred, and triphenylsulfonium salts are particularly preferred. The counter ions of these compounds are preferably, for example, hexafluoroantimonate and hexafluorophosphate.

The amount of the photo polymerization initiator is preferably 0.01 to 20% by mass, more preferably 0.5 to 5% by mass, of the solid content of the coating solution.

The light used for irradiation of the liquid crystal compound for polymerization is preferably ultraviolet light. The irradiation energy is preferably 10 mJ/cm² to 10 J/cm² and more preferably 25 to 800 mJ/cm². The illuminance is preferably 10 to 1000 mW/cm², more preferably 20 to 500 mW/cm², and most preferably 40 to 350 mW/cm². The irradiation wavelength preferably has a peak in the range of 250 to 450 nm and more preferably 300 to 410 nm. In order to facilitate the photo polymerization, the light irradiation may be performed under an atmosphere of inert gas such as nitrogen or under heating.

In the retardation layer, the in-plane retardation may be expressed or increased by photoalignment through irradiation with polarized light. Though the photo polymerization process in the alignment fixation may be performed by this irradiation with polarized light, or fixation may be performed by irradiation with unpolarized light after irradiation with polarized light, or photoalignment by irradiation with polarized light may be performed after fixation by irradiation with unpolarized light irradiation, it is desirable to perform only irradiation with polarized light or to perform irradiation with polarized light and then irradiation with unpolarized light for fixation. When the photo polymerization process in the alignment fixation is performed by irradiation with polarized light using a radical polymerization initiator as the polymerization initiator, the irradiation with polarized light is preferably performed under an inert gas atmosphere of an oxygen concentration of 0.5% or less. The irradiation energy is preferably 20 mJ/cm² to 10 J/cm² and more preferably 100 to 800 mJ/cm². The illuminance is preferably 20 to 1000 mW/cm², more preferably 50 to 500 mW/cm², and most preferably 100 to 350 mW/cm². Though any liquid crystal compound that is hardened by irradiation with polarized light can be used without particular limitation, liquid crystal compounds having ethylene unsaturated groups as the reactive groups are preferable. The irradiation wavelength preferably has a peak in the range of 300 to 450 nm and more preferably 350 to 400 nm.

The retardation layer may be further irradiated with polarized or unpolarized ultraviolet light after the first irradiation (for photoalignment) with polarized light. The irradiation with polarized or unpolarized ultraviolet light after the first irradiation with polarized light increases the reflectance of the reactive groups (postcure), improves the adhesion and other properties, and allows production at high throughput. Though the postcure may be performed with polarized light or unpolarized light, polarized light is preferred. The postcure is preferably repeated twice or more and may be performed with only polarized light, only unpolarized light, or a combination of polarized light and unpolarized light. In the combination, it is preferable to perform irradiation with polarized light and then with unpolarized light. In irradiation with ultraviolet light, though inert-gas purging is not required, when a radical polymerization initiator is used as the polymerization initiator, however, the irradiation is preferably performed under an inert gas atmosphere of an oxygen concentration of 0.5% or less. The irradiation energy is preferably 20 mJ/cm² to 10 J/cm² and more preferably 100 to 800 mJ/cm². The illuminance is preferably 20 to 1000 mW/cm², more preferably 50 to 500 mW/cm², and most preferably 100 to 350 mW/cm². In the polarized light irradiation, the irradiation wavelength preferably has a peak in the range of 300 to 450 nm and more preferably 350 to 400 nm. In the unpolarized light irradiation, the irradiation wavelength preferably has a peak in the range of 200 to 450 nm and more preferably 250 to 400 nm.

A liquid crystal compound having two or more reactive groups that are polymerized under different conditions is also preferred. In such a compound, a retardation layer containing a polymer having unreacted reactive groups can be produced under selected polymerization conditions such that only limited ones of the several reactive groups are polymerized. As an example of such a liquid crystal compound, polymerization fixation conditions particularly suitable for the use of a liquid crystal compound having a radical reactive group and a cationic reactive group (specific examples are the above-mentioned I-22 to I-25) will now be described.

It is preferable to use only a photo polymerization initiator that acts on a reactive group intended to be polymerized as the polymerization initiator. That is, for selective polymerization of radical reactive groups, only a photo-radical polymerization initiator is preferably used, whereas for selective polymerization of cationic reactive groups, only a photo-cationic polymerization initiator is preferably used. The amount of the photo polymerization initiator used is preferably 0.01 to 20% by mass, more preferably 0.1 to 8% by mass, and most preferably 0.5 to 4% by mass relative to the solid content of the coating solution.

Subsequently, light irradiation for polymerization is preferably performed with ultraviolet light. On this occasion, if the irradiation energy and/or illuminance are too high, both the radical reactive group and the cationic reactive group may nonselectively react. Accordingly, the irradiation energy is preferably 5 to 500 mJ/cm², more preferably 10 to 400 mJ/cm², and most preferably 20 to 200 mJ/cm². The illuminance is preferably 5 to 500 mW/cm², more preferably 10 to 300 mW/cm², and most preferably 20 to 100 mW/cm². The irradiation wavelength preferably has a peak in the range of 250 to 450 nm and more preferably 300 to 410 nm.

In the photo polymerization, the reaction using a photo-radical polymerization initiator is inhibited by oxygen, but the reaction using a photo-cationic polymerization initiator is not inhibited by oxygen. Accordingly, in selective polymerization of one of a radical reactive group and a cationic reactive group of a liquid crystal compound, irradiation with light is preferably performed under an atmosphere of inert gas, such as nitrogen, for selectively polymerizing the radical reactive groups, and irradiation with light is preferably performed intentionally under an atmosphere containing oxygen (e.g., under the atmosphere) for selectively polymerizing the cationic reactive groups.

The retardation layer is preferably formed using an alignment layer. Since the alignment layer regulates the direction of alignment of the liquid crystal compound disposed thereon, a patterned retardation layer can be easily prepared by patterning the function of the alignment film. The alignment layer can be generally disposed on a support or a provisional support described below or on a undercoat layer on a support or a provisional support. The alignment layer may be any layer that can impart an aligning property to the retardation layer, and typical examples thereof include photoalignment layer and a rubbing alignment layer.

The rubbing alignment film can be formed by rubbing a film primarily made of polyvinyl alcohol or polyimide.

The photoalignment material to be formed into a photoalignment film by light irradiation is described in many documents. Preferred examples of the material for the alignment film of this embodiment include azo compounds described in Japanese Patent Laid-Open Nos. 2006-285197, 2007-76839, 2007-138138, 2007-94071, 2007-121721, 2007-140465, 2007-156439, 2007-133184, and 2009-109831 and Japanese Patent Nos. 3883848 and 4151746; aromatic ester compounds described in Japanese Patent Laid-Open No. 2002-229039; maleimide and/or alkenyl substituted nadimide compounds having photoalignment units described in Japanese Patent Laid-Open Nos. 2002-265541 and 2002-317013; photocrosslinking silane derivatives described in Japanese Patent Nos. 4205195 and 4205198; and photocrosslinking polyimides, polyamides, and esters described in PCT Japanese Translation Patent Publication Nos. 2003-520878 and 2004-529220 and Japanese Patent No. 4162850. Particularly preferred photoalignment materials are azo compounds and photocrosslinking polyimide, polyamides, and esters.

The photoalignment film composed of the material mentioned above is irradiated with linearly polarized light or unpolarized light to produce a photoalignment film.

Throughout the specification, the term “irradiation with linearly polarized light” refers to a process for generating a photoreaction of the photoalignment material. The wavelength of the irradiation light varies depending on the photoalignment material, and any wavelength causing the photoreaction can be used without limitation. The peak wavelength of the irradiation light is preferably 200 to 700 nm, and ultraviolet light having a peak wavelength of 400 nm or less is more preferred.

The light source for the light irradiation may be one that is usually used. Examples of the light source include lamps such as a tungsten lamp, a halogen lamp, a xenon lamp, a xenon flash lamp, a mercury lamp, a mercury-xenon lamp, and a carbon arc lamp; various lasers (e.g., a semiconductor laser, a helium-neon laser, an argon ion laser, a helium-cadmium laser, and a YAG laser); light-emitting diodes; and cathode-ray tubes.

The linearly polarized light can be generated by a method using a polarizing plate (e.g., an iodine polarizing plate, dichroic dye polarizing plate, or wire grid polarizing plate), a method using a prism element (e.g., a Glan-Thompson prism) or a reflection polarizer utilizing Brewstar's angle, or a method using light emitted from a polarized laser light source. Alternatively, only light having a necessary wavelength may be selectively employed for irradiation using, for example, a filter or wavelength converter.

The irradiation time is preferably 1 to 60 minutes and more preferably 1 to 10 minutes.

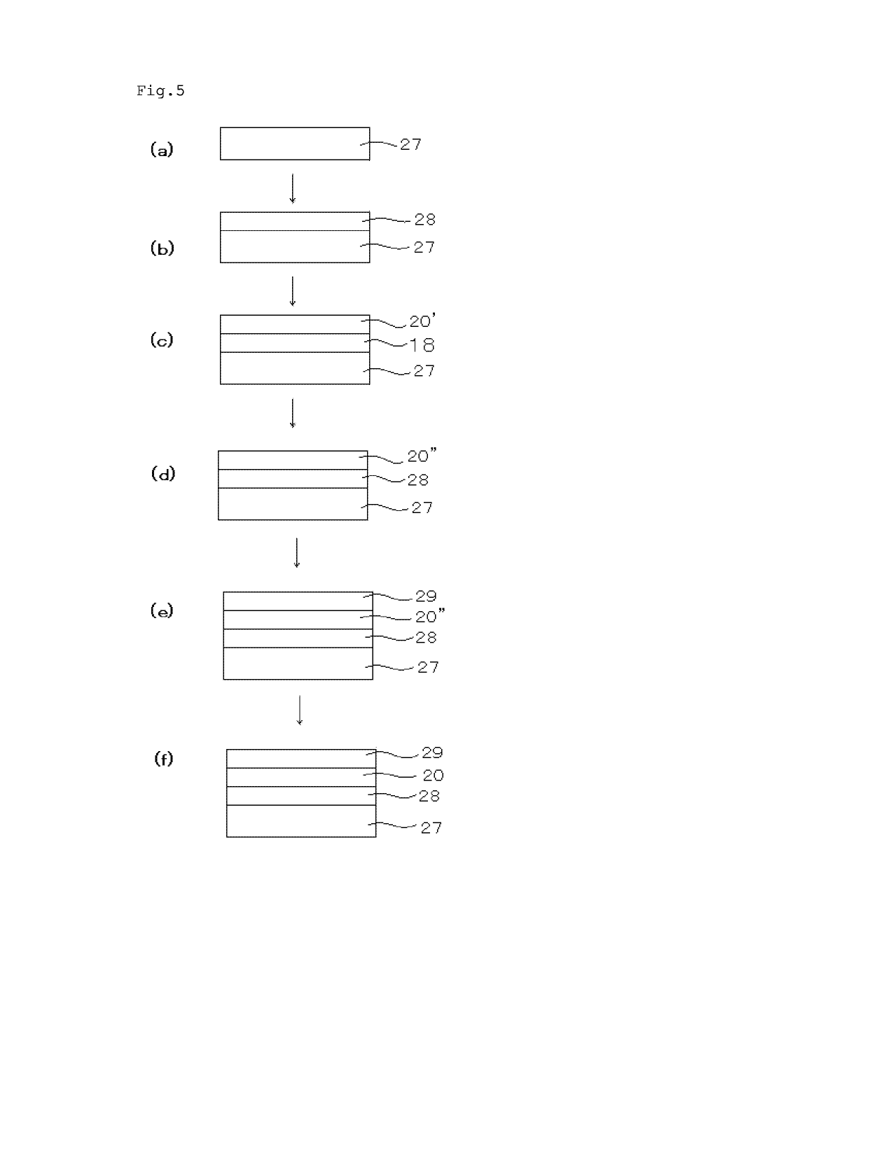

The patterned photoalignment layer is preferably prepared by pattern-exposing a film formed from a photoalignment material. In the pattern exposure, an exposure mask having a light-shielding portion and a light-transmitting portion is preferably used. For example, as shown in FIG. 5, exposure masks A and B may be used for the exposure. Alternatively, a pattern may be directly drawn by focusing a laser beam or electron beam on a predetermined position of the film without using any mask.

FIG. 5 schematically shows a flow of an example method of forming a patterned retardation layer that can be used in the present invention.

A support 27 such as a polyimide film is prepared (FIG. 5(a)). A material for an alignment film is applied onto the support to form an alignment film 28 (FIG. 5(b)). The alignment film 28 may be a rubbing alignment film or a photoalignment film. In order to enhance the releasability, a release layer may be formed between the support 27 and the alignment film 28. The alignment film 28 is optionally treated to develop an alignment-regulating force (e.g., rubbing treatment or linearly polarized light irradiation). Subsequently, a coating solution of a curable liquid crystal composition containing a liquid crystal compound having two different reactive groups (e.g., an oxetanyl group and a polymerizable ethylene unsaturated group) is applied onto the alignment film 28 to form a coating film 20′ (FIG. 5(c)). The solvent is removed from the coating film 20′ to generate a predetermined alignment state. Subsequently, the reaction of only one type of the reactive groups is allowed to proceed by irradiation with ultraviolet light, and the resulting state is fixed to form a pre-retardation layer 20″ (FIG. 5(d)).

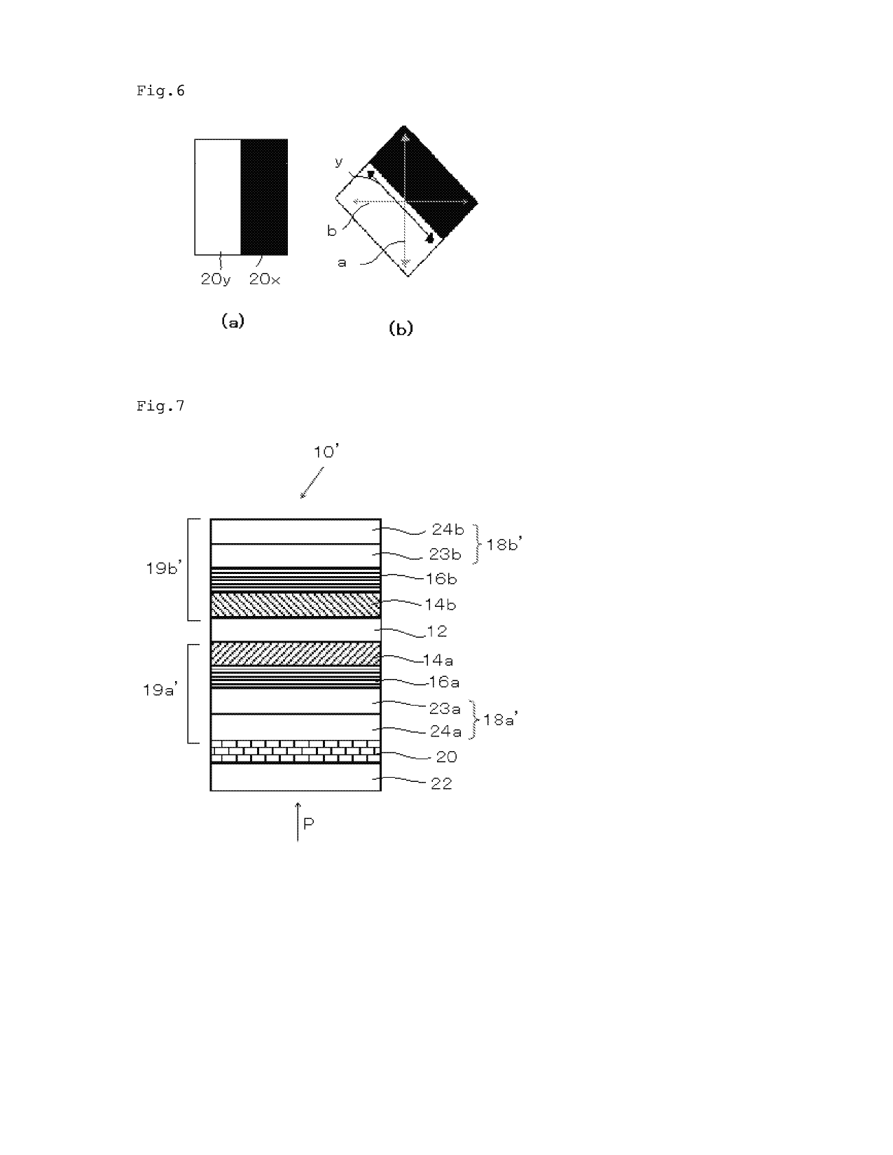

A composition containing a polymerization initiator that can initiate polymerization of the other type of the reactive groups is applied to the surface of the pre-retardation layer 20″ to form a polymerization initiator-supplying layer 29 (FIG. 5(e)). The polymerization initiator-supplying layer 29 is configured such that the polymerization initiator in the polymerization initiator-supplying layer 29 can permeate the pre-retardation layer 20″ disposed thereunder. Subsequently, for example, as shown in FIG. 6, irradiation with ultraviolet light is performed through an exposure mask having a light-shielding portion at the position corresponding to a first domain 20x portion and a light-transmitting portion at the position corresponding to a second domain 20y portion to expose only the portion corresponding to the light-transmitting portion to light. Exposure in the presence of the polymerization initiator permeated from the polymerization initiator-supplying layer 29 allows the reaction of the other type of the reactive groups of the liquid crystal compound in the exposed portion to proceed, and thereby the alignment state of the light-transmitting portion is firmly fixed. In the exposed portion, the liquid crystal compound is fixed in a predetermined alignment state to form a second domain 20y having an in-plane retardation of a ½ wavelength. In contrast, in the light-shielding portion, though the reaction of one type of the reactive groups proceeds by the first exposure, the liquid crystal compound is not subjected to the subsequent irradiation with light and maintains the other type of the reactive groups to be unreacted. Accordingly, heating the compound, to a temperature exceeding the isotropic phase temperature for allowing the reaction of the other type of the reactive groups to proceed fixes the light-shielding portion in an isotropic phase state. That is, a first domain having an in-plane retardation of 0 nm is formed. Thus, a patterned retardation layer 20 is formed (FIG. 5(f)).

The laminate containing the thus-formed patterned retardation layer can be incorporated into a stereo image print by bonding the surface of the polymerization initiator-supplying layer included in the laminate to the surface of the protective layer included in the first laminate via an adhesive layer. Subsequently, the support 27 may be removed, if possible. Alternatively, the surface of the polymerization initiator-supplying layer may be bonded to the linearly polarizing layer or its protective layer described below via an adhesive layer. Subsequently, the laminate can be incorporated into a stereo image print by bonding the back surface of the support 27 to the surface of the protective layer included in the first laminate. As shown in FIG. 6(b), the bonding is performed such that the absorption axis a of the dichroic image in the first laminate and the absorption axis b of the dichroic image in the second laminate each intersect the in-plane slow axis y of the second domain in the retardation layer at an angle of 45°.

### Linearly Polarizing Layer

The stereo image print of the present invention includes a linearly polarizing layer on the viewer-side surface of the patterned retardation layer. Any linearly polarizing layer that can linearly polarize light vibrating in any direction, such as natural light, can be used without particular limitation, and the linearly polarizing layer may be appropriately selected depending on the purpose. The polarizing layer preferably has a monolayer transmittance of 30% or more, more preferably 35% or more, and most preferably 40% or more. If the monolayer transmittance of the polarizing layer is less than 30%, the light utilization efficiency is considerably reduced. The polarizing layer preferably has an order parameter of 0.7 or more, more preferably 0.8 or more, and most preferably 0.9 or more. If the order parameter of the polarizing layer is less than 0.7, the light utilization efficiency is considerably reduced. The absorption axis of the polarizing layer preferably has an optical concentration of 1 or more, more preferably 1.5 or more, and most preferably 2 or more. If the optical concentration of the absorption axis of the polarizing layer is less than 1, the degree of polarization is considerably reduced to cause crosstalk and ghost images. The wavelength bandwidth of the polarizing layer preferably covers a range of 400 to 800 nm, from the viewpoint of converting the polarization of visible light. The polarizing layer may have any thickness without particular limitation. The thickness may be appropriately determined depending on the purpose, but is preferably 0.01 to 2 μm and more preferably 0.05 to 2 μm from the viewpoints of exhibiting intended optical characteristics, avoiding occurrence of parallax, and facilitating production.

The linearly polarizing layer may be made from any material and by any process. For example, an iodine polarizing plate, a dye polarizing plate containing a dichroic dye, or a polyene polarizing plate can be suitably used. The iodine polarizing plate and the dye polarizing plate can be generally produced by stretching a polyvinyl alcohol film and adsorbing iodine or a dichroic dye to the film. In this case, the transmission axis of the polarizing layer is in the direction perpendicular to the stretching direction of the film.

In addition to these polarizing plates of stretching type, the following linearly polarizing films can be also suitably used as the linearly polarizing layer in the present invention, from the viewpoint of having a relatively high degree of polarization. Preferable examples of such films include linearly polarizing plates utilizing polymerizable cholesteric liquid crystals described in Japanese Patent Laid-Open No. 2000-352611; guest-host-type linearly polarizing plates containing a dichroic dye and utilizing uniaxially aligned liquid crystals described in Japanese Patent Laid-Open Nos. Hei 11-101964, 2006-161051, and 2007-199237, PCT Japanese Translation Patent Publication Nos. 2002-527786, 2006-525382, 2007-536415, and 2008-547062, and Japanese Patent No. 3335173; wire grid polarizing plates utilizing a metal grid, such as aluminum, described in Japanese Patent Laid-Open No. Sho 55-95981; polarizing plates made of a polymer compound or liquid crystal compound in which carbon nanotubes are dispersed and aligned described in Japanese Patent Laid-Open No. 2002-365427; polarizing plates made of a polymer compound in which metal microparticles are dispersed and aligned described in Japanese Patent Laid-Open No. 2006-184624; polyvinylene-type linearly polarizing plates described in Japanese Patent Laid-Open No. Hei 11-248937 and PCT Japanese Translation Patent Publication Nos. Hei 10-508123, 2005-522726, 2005-522727, and 2006-522365; polarizing plates made of a lyotropic liquid crystalline dye represented by, for example, (chromogen) (SO₃M)ₙ described in Japanese Patent Laid-Open Nos. Hei 7-261024, Hei 8-286029, 2002-180052, 2002-90526, 2002-357720, 2005-154746, 2006-47966, 2006-48078, 2006-98927, 2006-193722, 2006-206878, 2006-215396, 2006-225671, 2006-328157, 2007-126628, 2007-133184, 2007-145995, 2007-186428, 2007-199333, 2007-291246, 2007-302807, and 2008-9417 and PCT Japanese Translation Patent Publication Nos. 2002-515075, 2006-518871, 2006-508034, 2006-531636, 2006-526013, and 2007-512236; and polarizing plates made of a dichroic dye described in Japanese Patent Laid-Open Nos. Hei 8-278409 and Hei 11-305036. Though the cholesteric liquid crystals usually can separate circularly polarized light, they can also function as a linearly polarizing plate in combination with a ¼ wavelength layer. In this case, the ¼ wavelength layer is preferably formed from a composition containing at least one kind of liquid crystal compound preferably by forming a liquid crystal phase from a composition containing at least one kind of liquid crystal compound having a polymerizable group and hardening the phase by application of heat and/or irradiation with ultraviolet light. From the viewpoint of the degree of polarization, the iodine polarizing plate, the dye polarizing plate containing a dichroic dye, the polarizing plate of a lyotropic liquid crystalline dye, and the polarizing plate of a dichroic dye are preferred.

In particular, in the present invention, the linearly polarizing layer is preferably a coating-type linearly polarizing layer formed by coating of a liquid crystal composition containing a dichroic dye from a viewpoint of reducing the thickness. The coating-type linearly polarizing layer is preferably formed from a liquid crystal composition containing a dichroic dye. Preferable examples of the dichroic dye are the same as those used in the formation of the dichroic images.

The linearly polarizing layer is bonded so as to be coincident with either the absorption axis of the dichroic image in the first laminate or the absorption axis of the dichroic image in the second laminate.

The linearly polarizing layer may be provided with protective layers each composed of a polymer film such as a cellulose acetate film on both surfaces. The polymer film that can be used as the protective layer preferably has low retardation or is optically isotropic. The range of preferred optical characteristics are the same as those of the protective layers included in the first and the second laminates, and preferred examples of the polymer film are also the same.

FIG. 7 is a schematic cross-sectional view of another example of a stereo image print of the present invention. The members that are the same as those in FIG. 1 are denoted with the same reference numerals, and detailed descriptions thereof will be omitted.

In the stereo image print 10′ shown in FIG. 7, the protective layers 18a′ and 18b′ respectively included in the first and the second laminates 19a′ and 19b′ are each composed of an oxygen-shielding layer 23a, 23b and a transparent resin hardened layer 24a, 24b formed by coating. The oxygen-shielding layers 23a and 23b have oxygen-shielding ability of preventing oxygen from penetrating into the image layers 16a and 16b and thereby preventing the dichroic dye and other components from being deteriorated and decolored. The transparent resin hardened layers 24a and 24b are disposed for increasing the physical strength and durability of the stereo image print or for imparting optical characteristics to the stereo image print. The oxygen-shielding layers 23a and 23b may be used as intermediate layers that contribute to prevention of mixing of interlaminar components at the coating step and during storage after the coating. The intermediate layer is referred to as “separation layer” in Japanese Patent Laid-Open No. Hei 5-72724 and it is incorporated herein.

The oxygen-shielding layer preferably shows low oxygen permeability and can be dispersed or dissolved in water or an aqueous alkali solution and can be appropriately selected from known films. In particular, the oxygen-shielding layer is preferably a film of which main component is polyvinyl alcohol, more preferably a film composed of a composition containing polyvinyl alcohol and polyvinyl pyrrolidone.

The oxygen-shielding layer preferably has a thickness in the range of 0.1 to 10 μm, more preferably 0.5 to 5 μm.

### Transparent Resin Hardened Layer

The transparent resin hardened layer preferably has a thickness in the range of 1 to 30 μm, more preferably 1 to 10 μm.

The transparent resin hardened layer is preferably formed by crosslinking or polymerization of an ionizing radiation hardening compound. The transparent resin hardened layer in the present invention can be formed by applying a composition containing an ionizing radiation hardening multifunctional monomer or oligomer to the surface of a layer such as a dichroic dye layer or an oxygen-shielding layer and crosslinking or polymerizing the multifunctional monomer or oligomer.

The ionizing radiation hardening multifunctional monomer and oligomer each preferably have a photo-, electron beam-, or radiation-polymerizable functional group, particularly, a photo-polymerizable functional group.

Examples of the photo-polymerizable functional group include unsaturated polymerizable functional groups such as a (meth)acryloyl group, a vinyl group, a styryl group, and an allyl group. In particular, a (meth)acryloyl group is preferred. The transparent resin hardened layer may contain inorganic microparticles.

Specific examples of the photo-polymerizable multifunctional monomer having a photo-polymerizable functional group include:

(meth)acrylate diesters of alkylene glycols such as neopentyl glycol acrylate, 1,6-hexanediol (meth)acrylate, and propylene glycol di(meth)acrylate;

(meth)acrylate diesters of polyoxy alkylene glycols such as triethylene glycol di(meth)acrylate, dipropylene glycol di(meth)acrylate, polyethylene glycol di(meth)acrylate, and polypropylene glycol di(meth)acrylate;

(meth)acrylate diesters of multivalent alcohols such as pentaerythritol di(meth)acrylate; and

(meth)acrylate diesters of ethylene or propylene oxide adducts such as 2,2-bis[4-(acryloxy diethoxy)phenyl]propane and 2-2-bis[4-(acryloxy polypropoxy)phenyl]propane.

Furthermore, epoxy (meth)acrylates, urethane (meth)acrylates, and polyester (meth)acrylates can also be preferably used as the photo-polymerizable multifunctional monomers.

In particular, esters of multivalent alcohols and (meth)acrylic acid are preferred. Multifunctional monomers having three or more (meth)acryloyl groups in one molecule are more preferred. Specific examples thereof include trimethylol propane tri(meth)acrylate, trimethylol ethane (meth)acrylate, 1,2,4-cyclohexane tetra(meth)acrylate, pentaglycerol triacrylate, pentaerythritol tetra(meth)acrylate, pentaerythritol tri(meth)acrylate, dipentaerythritol triacrylate, dipentaerythritol pentaacrylate, dipentaerythritol tetra(meth)acrylate, dipentaerythritol hexa(meth)acrylate, tripentaerythritol triacrylate, and tripentaerythritol hexatriacrylate. The multifunctional monomers may be used in combination of two or more thereof.

In the hardening reaction of the composition, a polymerization initiator is preferably used. The photo polymerization initiator is preferably a photo-radical polymerization initiator or a photo-cationic polymerization initiator, most preferably a photo-radical polymerization initiator.

Examples of the photo-radical polymerization initiator include acetophenones, benzophenones, Michler's benzoyl benzoate, α-amidoxime ester, tetramethyl thiuram monosulfide, and thioxanthones.

Commercially available examples of the photo-radical polymerization initiator include Kayacure series (e.g., DETX-S, BP-100, BDMK, CTX, BMS, 2-EAQ, ABQ, CPTX, EPD, ITX, QTX, BTC, and MCA: trade names) manufactured by Nippon Kayaku Co., Ltd.; Irgacure series (e.g., 651, 184, 127, 500, 907, 369, 1173, 2959, 4265, and 4263: trade names) manufactured by Ciba Specialty Chemicals Inc.; and Esacure series (KIP100F, KB1, EB3, BP, X33, KT046, KT37, KIP150, and TZT: trade names) manufactured by Sartomer Company Inc.

In particular, a photo-cleavage-type photo-radical polymerization initiator is preferred. The photo-cleavage-type photo-radical polymerization initiator is described in Saishin UV Koka Gijutsu (Advanced UV Curing Technology) (p. 159, Publisher: Kazuhiro Takausu, Publishing office: Technical Information Institute Co., Ltd., 1991).

Commercially available examples of the photo-cleavage-type photo-radical polymerization initiator include Irgacure series (651, 184, 127, and 907: trade names) manufactured by Ciba Specialty Chemicals Inc.

The content of the photo polymerization initiator is preferably 0.1 to 15 parts by mass, more preferably 1 to 10 parts by mass, based on 100 parts by mass of the curable resin.

In addition to photo polymerization initiator, a photosensitizer may also be used. Specific examples of the photosensitizer include n-butylamine, triethylamine, tri-n-butylphosphine, Michler's ketone, and thioxanthone.

Commercially available examples of the photosensitizer include Kayacure series (e.g., DMBI and EPA: trade names) manufactured by Nippon Kayaku Co., Ltd.

The photo polymerization is preferably performed by irradiating an applied and dried transparent resin layer with ultraviolet light to provide a hardened layer.

The transparent resin hardened layer may contain an oligomer and/or a polymer having a mass average molecular weight of 500 or more for obtaining brittleness.

Examples of the oligomer and the polymer include (meth)acrylates, cellulose, and styrene polymers; urethane acrylates; and polyester acrylates. Preferred examples of the oligomer and the polymer include poly(glycidyl (meth)acrylate) and poly(allyl (meth)acrylate) that have functional groups in side chains.

The total amount of the oligomer and the polymer contained in the transparent resin hardened layer is preferably 5 to 80% by mass, more preferably 25 to 70% by mass, and most preferably 35 to 65% by mass relative to the total mass of the resin layer.

The transparent resin hardened layer preferably has a strength of “H” or more, more preferably “2H” or more, and most preferably “3H” or more, measured by a pencil hardness test in accordance with JIS K5400.

In a Taber abrasion test in accordance with JIS K7204, a low abrasion loss of a test piece after the test is preferred.

When the transparent resin hardened layer is formed by crosslinking or polymerization of an ionizing radiation hardening compound, the crosslinking or polymerization is preferably performed under an atmosphere of an oxygen concentration of 10 vol % or less, which allows formation of a transparent resin hardened layer having excellent physical strength and durability.

The oxygen concentration as the condition for forming the layer by crosslinking or polymerization of an ionizing radiation hardening compound is preferably 6 vol % or less, more preferably 4 vol % or less, more preferably 2 vol % or less, and most preferably 1 vol % or less.

An oxygen concentration of 10 vol % or less is preferably achieved by replacing the air (nitrogen concentration: about 79 vol %, oxygen concentration: about 21 vol %) with another gas, in particular, with nitrogen (nitrogen purging).

The transparent resin hardened layer is preferably constructed by applying a coating composition for a transparent resin hardened layer to the surface of the dichroic dye layer.

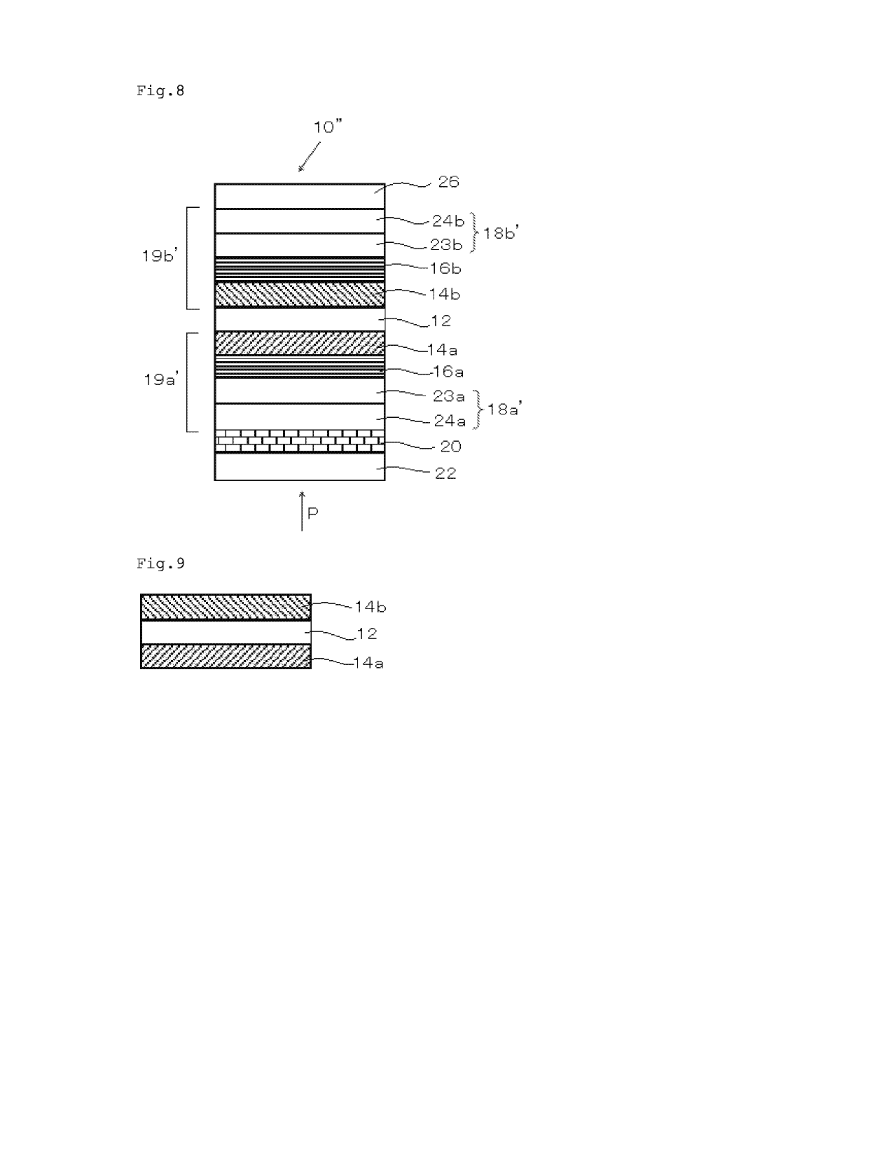

Though the protective layer, as shown in FIG. 7, may include two or more functional layers such as an oxygen-shielding layer and a transparent resin hardened layer, the protective layer 18a′ included in the first laminate 19a′ on the viewer-side is required to have an in-plane retardation value (Re) of 10 nm or less for visible light as a whole, preferably 0 to 5 nm, and most preferably 0 to 3 nm. These requirements are also applied to the embodiment shown in FIG. 8 described below.

FIG. 8 illustrates a schematic cross-sectional view of another example of the stereo image print of the present invention.

In the embodiment of the stereo image print shown in FIG. 8, a non-depolarizing reflecting layer 26 is disposed on the back surface of the second laminate 19b′, i.e., on the back side of the stereo image print shown in FIG. 7. In this embodiment, a stereoscopic image can be observed with reflected light of natural light.

### Reflecting Layer

The non-depolarizing reflecting layer that can be used in this embodiment is preferably, for example, paper coated with a thin metal film, a thin metal film mirror, metal foil, or metal flakes floating in plastic.

### 2. Method of Producing Stereo Image Print

The present invention also relates to a method of producing the stereo image print of the present invention.

The method of producing the stereo image print of the present invention at least involves:

applying a dichroic dye composition at least containing an organic solvent and at least one kind of dichroic dye dissolved in the organic solvent, simultaneously or separately, onto the front surface and the back surface of the transparent support so as to form respective dichroic images with pixels for a left eye and pixels for a right eye arranged in a predetermined array (Step a); and

horizontally aligning the at least one kind of dichroic dye spontaneously or passively by evaporating the organic solvent in the composition (Step b). Each step is as follows.

A printing sheet having image-receiving layers (e.g., alignment films) on both surfaces of a transparent support is prepared. FIG. 9 is a schematic cross-sectional view of an example printing sheet. The printing sheet includes a transparent support 12 and image-receiving layers 14a and 14b respectively disposed on both surfaces of the transparent support 12. Preferred embodiments of the transparent support and the image-receiving layers are as described above.

### Step a:

In the method of the present invention, an image is formed from a dichroic dye composition at least containing an organic solvent and at least one kind of dichroic dye dissolved in the solvent. The composition is applied onto the image-receiving layers disposed on the front and the back surfaces of the transparent support to form a dichroic image on each surface with pixels for a left eye and pixels for a right eye arranged in a predetermined array. Though the coating may be performed by any method, ink jetting is suitable for a case of applying the composition to the printing sheet so as to form an image based on digitized image data. An example using ink jetting is as follows.

Image data is digitized with an image data processor into image data for the left eye and image data for the right eye having parallax. Examples of the digitized image data include image data photographed with a digital camera, more specifically, digital data such as an image photographed with a digital camera equipped with taking lenses of two systems for right and left. In the image data processor, image data for the left eye and image data for the right eye are each decomposed into a predetermined pattern (e.g., stripe pattern) to generate image data composed of pixels for a left eye and pixels of the right eye arranged in a predetermined pattern. The dichroic dye composition is stored in an ink dispenser of an ink-jet apparatus connected to the image data processor. The ink-jet apparatus is controlled so as to discharge the composition from an ink-jet head according to digital signals transmitted from the image data processor. The composition discharged from the ink-jet head lands on a predetermined position of the image-receiving layer of the printing sheet that has been positioned and supported to form a dichroic image.

Images on both image-receiving layers may be formed simultaneously or separately. The mechanism of the ink-jet apparatus will be adjusted depending on the procedure.

The dichroic composition is applied preferably at a temperature of about 0° C. or more and 80° C. or less and a humidity of about 10% RH or more and 80% RH or less. These ranges preferably enable uniform application without causing evaporation of the solvent before landing of the coating solution on the alignment film surface.

When the dichroic dye is applied to the image-receiving layers (e.g., alignment films) so as to form respective images, the printing sheet may be warmed or cooled. In the case of using alignment films as the image-receiving layers of the printing sheet, the temperature of each alignment film is preferably 10° C. or more and 60° C. or less. A temperature higher than this upper limit may cause drying involving disordered alignment, whereas a temperature lower than this lower limit may form droplets of water on the base material surface to disadvantageously affect the application.

The dichroic dye composition at least contains an organic solvent and at least one kind of dichroic dye dissolved in the organic solvent. The dichroic dye preferably has liquid crystallinity. Preferred examples of the dichroic dye are the same as those described above. The dichroic dye composition is preferably prepared as a liquid composition that can be applied by ink jetting. Examples of the organic solvent include amides (e.g., N,N-dimethylformamide), sulfoxides (e.g., dimethylsulfoxide), heterocyclic compounds (e.g., pyridine), hydrocarbons (e.g., benzene and hexane), alkyl halides (e.g., chloroform and dichloromethane), esters (e.g., methyl acetate and butyl acetate), ketones (e.g., acetone and methyl ethyl ketone), and ethers (e.g., tetrahydrofuran and 1,2-dimethoxyethane). Alkyl halides and ketones are preferred. The organic solvents may be used in combination of two or more thereof.

The dichroic dye composition preferably has a viscosity of 0.5 cP or more, more preferably 1 cP or more, more preferably 5 cP or more, and most preferably 10 cP or more. The composition preferably has a surface tension of 20 dyn/cm or more, more preferably 25 dyn/cm or more, and most preferably 30 dyn/cm or more.

The total solid content in the dichroic dye composition is preferably 1 to 20% by mass, more preferably 1 to 10% by mass, and most preferably 1 to 5% by mass.

### Step b:

Subsequently, the at least one kind of dichroic dye is spontaneously or passively horizontally aligned through evaporation of the organic solvent from the composition applied onto the image-receiving layers (e.g., alignment films) by, for example, ink jetting to form respective dichroic images. For example, in the case of using alignment films as the image-receiving layers, each dichroic image is formed by horizontally aligning the dichroic dye molecules spontaneously or passively on the alignment film along the alignment axis of the alignment film. In the case of using molecularly aligned films as the image-receiving layers, each dichroic image is formed by allowing the dichroic dye to permeate the molecularly aligned film and horizontally aligning the dichroic dye molecules spontaneously or passively along the molecular alignment of the film. Drying is preferably performed not to disorder the alignment state of the dye molecules (to avoid thermal relaxation, etc.). From such a viewpoint, the drying temperature is preferably room temperature. That is, natural drying is preferred. On the contrary, in order to facilitate the alignment of the dichroic dye molecules in drying, the printing sheet may be heated. The temperature of the printing sheet on such occasion is therefore preferably 50° C. to 200° C. and more preferably 70° C. to 180° C. In order to decrease this alignment temperature, the composition may contain additives such as a plasticizer.

In this step, the dichroic dye molecules are horizontally aligned. For example, in the case of using alignment films as the image-receiving layers, for example, the alignment axes of the alignment films are in the directions of −45° and +45°, respectively, to define an angle of 90°. In the case of using molecularly aligned films as the image-receiving layers, for example, the molecularly aligned films are stretched in the directions of −45° and +45°, respectively, to be molecularly aligned to define an angle of 90°. When the dichroic dye molecules having the absorption axis in the major axis direction are aligned such that the major axis is parallel to the alignment axis of the alignment film or to the molecular alignment direction of the molecularly aligned film, a dichroic image having the absorption axis in the direction of −45° is formed on one of the image-receiving layers, and a dichroic image having the absorption axis in the direction of +45° is formed on the other image-receiving layer.

In Step b, the dichroic dye molecules are preferably aligned horizontally to the layer surface of each image-receiving layer. The liquid crystal phase in an alignment state may be a nematic phase, a smectic phase, or an intermediate therebetween.

After Step b, a protective layer may be formed on each dichroic image. The protective layer may be formed by coating or may by bonding a polymer film. Furthermore, after the step, a patterned retardation layer and a linearly polarizing layer may be formed on the surface, on the viewer side, of the protective layer. The formation of the patterned retardation layer and the bonding of the retardation layer and the linearly polarizing layer are as described above.

### EXAMPLES

The invention is described in more detail with reference to the following Examples. In the following Examples, the material used, its amount and ratio, the details of the treatment and the treatment process may be suitably modified or changed not overstepping the spirit and the scope of the invention. Accordingly, the invention should not be limitatively interpreted by the Examples mentioned below.

### 1. Example 1

### Preparation of Printing Sheet for Stereoscopic Image

### (Preparation of Transparent Support)

The components for the cellulose acetate solution composition shown below were put into a mixing tank and were heated with stirring to dissolve the components to prepare a cellulose acetate solution as a dope.

### (Composition of Cellulose Acetate Solution)

Cellulose acetate having a degree of acetylation of 60.9%: 100 parts by mass

Triphenyl phosphate (plasticizer): 7.8 parts by mass

Biphenyl diphenyl phosphate (plasticizer): 3.9 parts by mass

Methylene chloride (first solvent): 318 parts by mass

Methanol (second solvent): 47 parts by mass

The resulting dope was flow-cast with a band flow-casting machine. A film having a residual solvent content of 15% by mass was laterally stretched into a stretching ratio of 15% by free-end uniaxial stretching at 150° C. to produce a cellulose acetate film (thickness: 92 μm).

The Re value at 550 nm of the resulting cellulose acetate film was measured using light having a wavelength of 550 nm incident on the normal direction of the film with KOBRA 21ADH (trade name, manufactured by Oji Keisoku Kiki Co., Ltd.). The Re value was 7 nm.

### (Preparation of Rubbing Alignment Film)

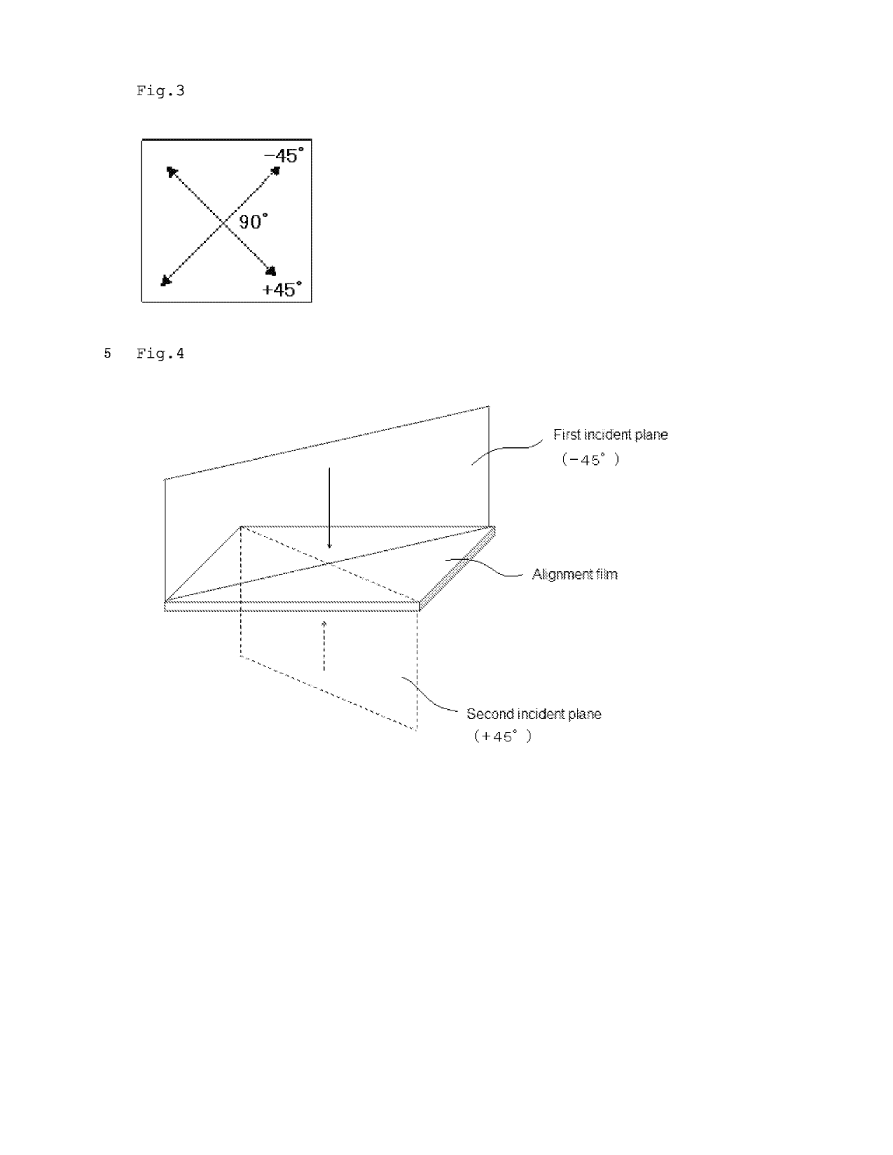

An aqueous solution of 4% “PVA103”, polyvinyl alcohol manufactured by Kuraray Co., Ltd., was applied to the front and the back surfaces of the cellulose acetate film with a No. 12 bar, followed by drying at 80° C. for 5 minutes. Subsequently, both the resulting coating films were subjected to rubbing treatment involving three reciprocating movements at 400 rpm in the directions (±45°) shown in FIG. 3 such that the directions on the front surface and the back surface are orthogonal to each other to prepare a printing sheet for a stereoscopic image. On the resulting alignment films, the liquid crystal molecules are horizontally aligned such that the major axis is coincident with the rubbing axis.

A printing sheet having a structure shown in FIG. 9 was produced in such a manner. That is, a printing sheet including a transparent support 12 of a cellulose acetate film and alignment films 14a and 14b on both surfaces of the transparent support 12 was produced.

### Preparation of Ink for Forming Stereoscopic Image

### (Preparation of Dichroic Dye Composition)

The following composition was stirred and dissolved to prepare inks for stereoscopic image. The yellow ink, magenta ink, and cyan ink each had a viscosity of 0.6 cP and a surface tension of 30 dyn/cm.

| | |
|---|---|
| (Yellow ink for stereoscopic image) | |
| Yellow azo dye A2-3 having the following structure (compound of Formula (II)): | 1 part by mass |
| Chloroform (solvent): | 99 parts by mass |
| (Magenta ink for stereoscopic image) | |
| Magenta azo dye C-9 having the following structure (compound of Formula (I)): | 1 part by mass |
| Chloroform (solvent): | 99 parts by mass |
| Cyan ink for stereoscopic image | |
| Cyan azo dye A3-1 having the following structure (compound of Formula (III)): | 0.87 parts by mass |
| Cyan squarylium dye VI-5 having the following structure: | 0.13 parts by mass |
| Chloroform (solvent): | 99 parts by mass |

A2-3 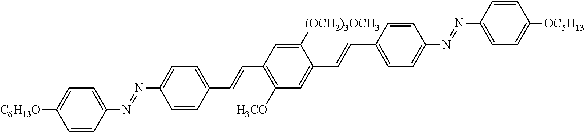
K: 138° C., N: 284° C., I
C-9 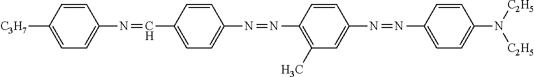
K: 167° C., N: 288° C., I
A3-1 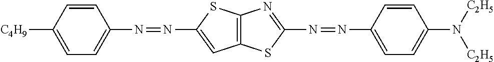
K: 200° C., N: 237° C., I
VI-5 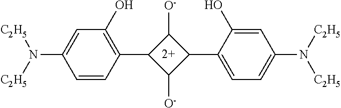 [SMILES: CCN(CC)c1ccc(C2C([O-])C(c3ccc(N(CC)CC)cc3O)C2[O-])c(O)c1]
K: crystal phase
N: nematic phase
I: isotropic phase

### Production of Stereo Image Print

### (Formation of Dichroic Dye Layer)

Data for the right eye and data for the left eye photographed with a digital camera equipped with taking lenses of two systems for right and left were each converted into digital data, and droplets of the ink for stereoscopic image prepared above were ejected on both rubbing alignment film with a piezoelectric ink-jet head. The pixels for a right eye and the pixels for a left eye were each separated into a predetermined stripe pattern and were alternately arranged to constitute an image in each of the front and the back printing surfaces such that the positions of the pixels for a right eye in the front printing surface correspond to those of the pixels for a left eye in the back printing surface. The solvent was evaporated at room temperature to fix the aligned state to form dichroic images. The gradation corresponding to the image data can be controlled by controlling the amount and the density of ink ejected. The dichroic images on the front surface and the back surface were each horizontally aligned within a range of ±1° such that the alignment directions of both images were orthogonal to each other. The dichroic dye layers of the front surface and the back surface each had a thickness of 1 μm.

### (Measurement of Dichroic Ratio of Dichroic Dye Layer)

A dichroic image was separately formed using the same ink and fixing under the same conditions as described above, and the dichroic ratio thereof was measured.

The absorbance of the dichroic dye layer was measured with a spectrophotometer having an incident optical system equipped with an iodine polarizer, and the dichroic ratio was calculated by the following expression:

Dichroic ratio (D)=Az/Ay

Az: absorbance of light absorbing anisotropic film for polarized light in the absorption axis direction

Ay: absorbance of light absorbing anisotropic film for polarized light in the polarization axis direction

The results of the measurement are shown in Table 1.

### (Preparation of Coating Solution for Oxygen-Shielding Layer)

The following composition was put into a mixing tank and was stirred to prepare a coating solution for oxygen-shielding layer.

A mixture of 3.2 parts by mass of polyvinyl alcohol (PVA205 (trade name), manufactured by Kuraray Co., Ltd.), 1.5 parts by mass of polyvinyl pyrrolidone (PVP K-30 (trade name), manufactured by Nippon Shokubai Co., Ltd.), 44 parts by mass of methanol, and 56 parts by mass of water was stirred and was filtered through a polypropylene filter having a pore size of 0.4 μm to prepare a coating solution for oxygen-shielding layer.

### (Production of Oxygen-Shielding Layer)

The coating solution for oxygen-shielding layer was applied onto the surface of each of the dichroic dye layers on the front surface and the back surface described above, followed by drying at 100° C. for 2 minutes to prepare oxygen-shielding layers. The oxygen-shielding layers each had a thickness of 1 μm.

### (Preparation of Coating Solution for Transparent Resin Hardened Layer)

The following composition was put into a mixing tank and was stirred to prepare a coating solution for transparent resin hardened layer.

A mixture of 2.7 parts by mass of poly(glycidyl methacrylate) having a mass average molecular weight of 15000, 7.3 parts by mass of methyl ethyl ketone, 5.0 parts by mass of cyclohexanone, and 0.5 parts by mass of a photo-polymerization initiator (Irgacure 184 (trade names), manufactured by Ciba Specialty Chemicals Inc.) to 7.5 parts by mass of trimethylolpropane triacrylate (Viscoat #295 (trade name), manufactured by Osaka Organic Chemical Industry Ltd.) was stirred and was filtered through a polypropylene filter having a pore size of 0.4 μm to prepare a coating solution for transparent resin hardened layer.

### (Production of Transparent Resin Hardened Layer)

The coating solution for transparent resin hardened layer was applied onto the surface of each of the oxygen-shielding layers on the front surface and the back surface described above, followed by drying at 100° C. for 2 minutes. Subsequently, irradiation with 5 J of ultraviolet light was performed under a nitrogen atmosphere (oxygen concentration: 100 ppm or less) for polymerization. Thus, a stereo image print having an oxygen-shielding layer having a thickness of 1 μm and a transparent resin hardened layer having a thickness of 2 μm stacked on the surface of the dichroic dye layer (thickness: 1.0 μm) in this order was produced. The transparent resin hardened layer had an Re value of 0 nm at a wavelength of 550 nm and a strength of “H” measured by a pencil hardness test in accordance with JIS K5400.

### (Production of Protective Layer)

The following composition was put into a mixing tank and was heated with stirring to dissolve the components to prepare a cellulose acylate solution A.

### <Composition of Cellulose Acylate Solution A>

Cellulose acetate having a degree of substitution of 2.86: 100 parts by mass

Triphenyl phosphate (plasticizer): 7.8 parts by mass

Biphenyl diphenyl phosphate (plasticizer): 3.9 parts by mass

Methylene chloride (first solvent): 300 parts by mass

Methanol (second solvent): 54 parts by mass

1-Butanol: 11 parts by mass

The following composition was put into another mixing tank and was heated with stirring to dissolve the components to prepare an additive solution B.

### <Composition of Additive Solution B>

| | |
|---|---|
| Compound B1 shown below (Re-reducing agent): | 40 parts by mass |
| Compound B2 shown below (chromatic | 4 parts by mass |
| dispersion controller): | |
| Methylene chloride (first solvent): | 80 parts by mass |
| Methanol (second solvent): | 20 parts by mass |

Compound B1 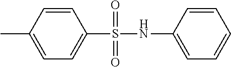 [SMILES: Cc1ccc(S(=O)(=O)Nc2ccccc2)cc1]
Compound B2

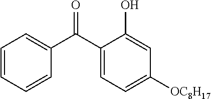

### <Production of Cellulose Acetate Protective Film>

A mixture of 477 parts by mass of cellulose acylate solution A and 40 parts by mass of additive solution B was sufficiently stirred to prepare a dope. The resulting dope was flow-cast from a flow-casting port onto a drum cooled to 0° C. The dope was peeled off in a state having a solvent content of 70% by mass. Both edges in the width direction of the resulting film were fixed with pin tenters (pin tenters shown in FIG. 3 of Japanese Patent Laid-Open No. Hei 4-1009), and the film was dried while the distance between the pin tenters was maintained so as to keep a 3% transverse stretching rate (direction perpendicular to the machine direction) in a state of a solvent content of 3 to 5% by mass. Subsequently, the film was further dried through the rolls of a heat treating machine to produce a cellulose acetate protective film having a thickness of 60 μm. The frontal Re of the protective film was 2.0 nm.

### <Production of Linearly Polarizing Layer>

The cellulose acetate protective film was immersed in a 1.5 N sodium hydroxide aqueous solution at 55° C. for 2 minutes. The film was washed in a water tank at room temperature, followed by neutralization with 0.1 N sulfuric acid at 30° C. The film was washed again in the water tank at room temperature and was dried in hot air of 100° C. Thus, the surface of the cellulose acylate protective film was saponified.

Subsequently, a rolled polyvinyl alcohol film having thickness of 80 μm was continuously stretched in an aqueous iodine solution to five times its original size, followed by drying to yield a linearly polarizing film. The linearly polarizing film was bonded between two alkali-saponified cellulose acylate protective films using a 3% polyvinyl alcohol (manufactured by Kuraray Co., Ltd., PVA-117H) aqueous solution as an adhesive such that the slow axes of the cellulose acylate protective films on both sides of the linearly polarizing film are parallel to the transmission axis of the linearly polarizing film to yield a linearly polarizing layer protected with the cellulose acylate protective films on both surfaces.

### (Production of Patterned Retardation Layer)

### <Preparation of Coating Solution for Alignment Layer AL-1>

The following composition was prepared and was filtered through a polypropylene filter having a pore size of 30 μm to prepare a coating solution for alignment layer AL-1.

Composition of coating solution for alignment layer (%)

Polyvinyl alcohol (PVA205, manufactured by Kuraray Co., Ltd.): 3.21
Polyvinyl pyrrolidone (Luvitec K30, manufactured by BASF): 1.48
Distilled water: 52.10
Methanol: 43.21

### <Preparation of Coating Solution for Retardation Layer LC-1>

The following composition was prepared and was filtered through a polypropylene filter having a pore size of 0.2 μm to prepare a coating solution for retardation layer LC-1.

I-22 is a liquid crystal compound having two different reactive groups, one being an acrylic group serving as a radical reactive group, and the other being an oxetanyl group serving as a cationic reactive group.

Composition of coating solution for retardation layer (%)

| | |
|---|---|
| Rod-like liquid crystal (I-22): | 32.59 |
| Horizontal alignment agent (LC-1-2): | 0.02 |
| Cationic photo-polymerization initiator (CPI100-P, manufactured by San-Apro Ltd.): | 0.66 |
| Polymerization controller (IRGANOX 1076, manufactured by Ciba Specialty Chemicals Inc.): | 0.07 |
| Methyl ethyl ketone: | 66.66 |

I-22 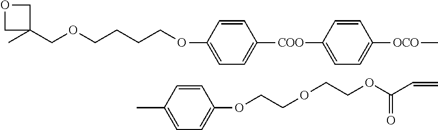
Horizontal alignment agent (LC-1-2)

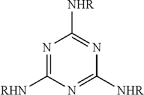

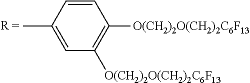

### (Preparation of Coating Solution for Radical Polymerization Initiator-Supplying Layer AD-1)

The following composition was prepared and was filtered through a polypropylene filter having a pore size of 0.2 μm to prepare a coating solution for radical polymerization initiator-supplying layer AD-1.

B-3 is a copolymer of benzyl methacrylate, methacrylic acid, and methyl methacrylate having a comonomer ratio (molar ratio) of 35.9/22.4/41.7 and a weight average molecular weight of 38000.

RPI-1 is 2-trichloromethyl-5-(p-styrylstyryl)-1,3,4-oxadiazole.

Composition of coating solution for radical polymerization
initiator-supplying layer (% by mass)

Binder (B-3): 8.05
Kayarad DPHA (manufactured by Nippon Kayaku Co., Ltd.): 4.83
Photo-radical polymerization initiator (RPI-1): 0.12
Hydroquinone monomethyl ether: 0.002
Megafac F-176PF (manufactured by DIC Corporation): 0.05
Propylene glycol monomethyl ether acetate: 34.80
Methyl ethyl ketone: 50.538
Methanol: 1.61

### <Production of Patterned Retardation Layer>

The coating solution for alignment layer AL-1 was applied onto a polyimide film support having a frontal Re of 0 nm and a thickness of 100 μm with a wire bar and was dried to form a film having a dry thickness of 1.6 μm. Subsequently, the coating solution for retardation layer LC-1 was applied onto the resulting film with a wire bar, followed by drying at a film surface temperature of 90° C. for 2 minutes to generate a liquid crystal phase state. The resulting coated film was then irradiated with ultraviolet light at 160 W/cm in air using an air-cooling metal halide lamp (manufactured by Eye Graphics Co., Ltd.) to fix the alignment state to form a retardation layer having a thickness of 3.2 μm. The illuminance of the ultraviolet light used on this occasion was 100 mW/cm² in a UV-A region (integration in the wavelength range of 320 to 400 nm), and the dose was 80 mJ/cm² in the UV-A region. Furthermore, the coating solution for radical polymerization initiator-supplying layer AD-1 was applied onto the retardation layer and dried to form a radical polymerization initiator-supplying layer having a thickness of 1.2 μm, followed by pattern exposure at an exposure density of 50 mJ/cm² with an exposure device M-3L manufactured by Mikasa Co., Ltd. and a photomask I. Subsequently, the unexposed portion was thermally fixed into an isotropic phase through baking in a clean oven at 230° C. for 1 hour to produce a patterned ½ wavelength layer. The patterned ½ wavelength layer had an in-plane retardation of 275 nm (½ wavelength) at a wavelength of 550 nm in the exposed portion and an in-plane retardation of 0 nm in the unexposed portion.

### (Production of Stereo Image Print)

### <Lamination of Patterned Retardation Layer and Linearly Polarizing Layer>

An adhesive sheet was attached to the initiator layer side of the patterned retardation layer, and the patterned retardation layer was bonded to the linearly polarizing layer such that the in-plane slow axis of the second domain of the retardation layer and the transmission axis of the linearly polarizing layer define an angle of 45°.

### <Stereo Image Print>

An adhesive sheet was attached to the polyimide film side of the patterned retardation layer, and the patterned retardation layer was bonded to the transparent resin hardened layer such that, as shown in FIG. 4, the slow axis of the ½ wavelength layer and the absorption axis of the dichroic dye layer of the surface define an angle of 45° and that the alignment axis of the linearly polarizing layer is coincident with the absorption axis of the dichroic dye layer.

The stereo image print having a structure shown in FIG. 7 was produced in such a manner (note that, the protective layers disposed on the front surface and the back surface of the linearly polarizing layer, the polyimide film used for forming the patterned retardation layer, the alignment film, the polymerization initiator-supplying layer, and the adhesive layer used for bonding in FIG. 7 were omitted). That is, produced was a stereo image print composed of a first laminate 19a′ that was stacked on the front surface of the transparent support 12 and composed of a rubbing alignment film 14a, an image layer 16a having a dichroic image constituted with pixels for a right eye and pixels for a left eye arranged in a predetermined stripe pattern, and a protective layer 18a′ consisting of an oxygen-shielding layer 23a and a transparent resin hardened layer 24a; a second laminate 19b′ that was stacked on the back surface of the transparent support 12 and composed of a rubbing alignment film 14b, an image layer 16b having a dichroic image constituted with pixels for a right eye and pixels for a left eye arranged in a predetermined stripe pattern, and a protective layer 18b′ consisting of an oxygen-shielding layer 23b and a transparent resin hardened layer 24b; and a patterned retardation layer 20 and a linearly polarizing layer 22 disposed on the viewer-side surface of the first laminate 19a′.

The patterned retardation layer 20 and the linearly polarizing layer 22 were bonded to each other such that the absorption axis direction of the dichroic dye forming each of the pixels for a right eye and the pixels for a left eye of the stereo image print, the in-plane slow axis of the second domain of the patterned retardation layer, and the polarization axis direction of the linearly polarizing layer satisfy a predetermined relationship, when viewed from each of the positions of the right eye and the left eye of a viewer, as shown in FIG. 2.

### Observation of Stereoscopic Image

A viewer observed the produced stereo image print from the designed viewing position without wearing polarized glasses. A clear stereoscopic image was observed without crosstalk and ghost images. In addition, in the stereo image print of this Example, the resolution was not decreased, whereas the resolution was decreased to a half when a conventional parallax barrier was used.

### 2. Example 2

### Production of Stereo Image Print

An aluminum reflecting layer was stacked on the back surface of the stereo image print produced in Example 1 to produce a stereo image print having a structure shown in FIG. 8 (note that, in FIG. 8, the protective layers disposed on the front surface and the back surface of the linearly polarizing layer, the polyimide film used for forming the patterned retardation layer, the alignment film, the polymerization initiator-supplying layer, and the adhesive layer used for bonding were omitted). That is, a stereo image print was produced which was composed of a first laminate 19a′ stacked on the front surface of the transparent support 12 and composed of a rubbing alignment film 14a, an image layer 16a having a dichroic image including pixels for a right eye and pixels for a left eye arranged in a predetermined stripe pattern, and a protective layer 18a′ consisting of an oxygen-shielding layer 23a and a transparent resin hardened layer 24a; a second laminate 19b′ stacked on the back surface of the transparent support 12 and composed of a rubbing alignment film 14b, an image layer 16b having a dichroic image including pixels for a right eye and pixels for a left eye arranged in a predetermined stripe pattern, and a protective layer 18b′ consisting of an oxygen-shielding layer 23b and a transparent resin hardened layer 24b; a patterned retardation layer 20 and a linearly polarizing layer 22 disposed on the viewer-side surface of the first laminate 19a′; and a reflecting layer 26 disposed on the rear surface of the second laminate 19b′.

### Observation of Stereoscopic Image

A viewer observed the thus produced stereo image print from the designed viewing position without wearing polarized glasses. A clear stereoscopic image was observed without crosstalk and ghost images. In addition, in the stereo image print of this Example, the resolution was not decreased, whereas the resolution was decreased to a half when a conventional parallax barrier was used.

### 3. Example 3

### Production of Printing Sheet for Stereoscopic Image

A stereo image print was produced as in Example 1 except that a photoalignment film shown below was used instead of the rubbing alignment film.

### (Production of Photoalignment Film)

An aqueous solution containing 1% photoalignment material E-1 having the structure shown below was applied to the front surface and the back surface of the cellulose acetate film by spin coating, followed by drying at 100° C. for 1 minute. The resulting coating film was irradiated with linearly polarized ultraviolet light (illuminance: 140 mW, irradiation time: 35 seconds, dose: 5 J/cm²) using a polarized ultraviolet light exposure device to produce a printing sheet for stereoscopic image. The irradiation was performed for both the front surface and the back surface. As shown in FIG. 4, the front and the back surfaces were irradiated with light such that the irradiation directions were perpendicular to these surfaces and were orthogonal to each other.

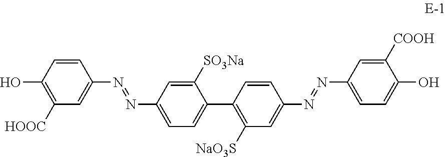

### Production of Stereo Image Print

### (Production of Dichroic Dye Layer)

Data for the right eye and data for the left eye photographed with a digital camera equipped with taking lenses of two systems for right and left were converted into digital data, and droplets of the ink for stereoscopic image prepared in Example 1 were ejected on the photoalignment film with a piezoelectric ink-jet head. The pixels for a right eye and the pixels for a left eye were each separated into a predetermined stripe pattern and were alternately arranged to constitute an image in each of the front and the back printing surfaces such that the positions of the pixels for a right eye in the front printing surface correspond to those of the pixels for a left eye in the back printing surface. The solvent was evaporated at room temperature to fix the aligned state to form dichroic dye layers. The gradation corresponding to the image data can be controlled by controlling the amount and the density of ink ejected. The dichroic dye layers on the front surface and the back surface were each horizontally aligned within a range of ±1° such that the alignment directions of both layers were orthogonal to each other. The dichroic dye layers of the front surface and the back surface each had a thickness of 1 μm.

### (Measurement of Dichroic Ratio of Dichroic Dye Layer)

A dichroic image was separately formed using the same ink and fixing under the same conditions as described above, and the dichroic ratio thereof was measured.

The results of the measurement are shown in Table 1.

### (Stereo Image Print)

A stereo image print was produced by the same procedure as that in Example 1.

### Observation of Stereoscopic Image

A viewer observed the thus produced stereo image print from the designed viewing position without wearing polarized glasses. A clear stereoscopic image was observed without crosstalk and ghost images. In addition, in the stereo image print of this Example, the resolution was not decreased, whereas the resolution was decreased to a half when a conventional parallax barrier was used.

TABLE 1

| No. | Dichroic dye | Dichroic ratio |
|---|---|---|
| Example 1 | A2-3 | 39 |
| | C-9 | 37 |
| | A3-1 | 24 |
| | VI-5 | 25 |
| Example 3 | A2-3 | 39 |
| | C-9 | 37 |
| | A3-1 | 24 |
| | VI-5 | 25 |

### 4. Examples 4 and 5

### Production of Image Print for Stereoscopic Image

An image print for stereoscopic image was produced as in Example 1 except that A1-16 or A1-46 was used as the magenta ink for stereoscopic image.

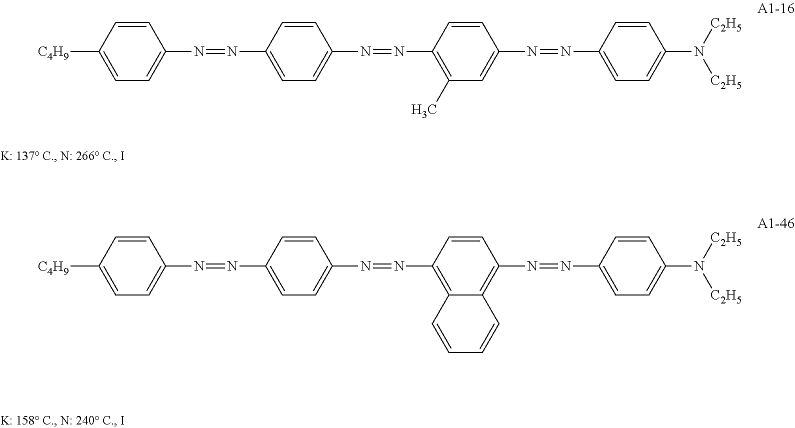

### (Measurement of Dichroic Ratio of Dichroic Dye Layer)

A dichroic dye layer was separately formed using the same magenta ink and fixing under the same conditions as described above, and the dichroic ratio thereof was measured.

The results of the measurement are shown in the following table.

### (Measurement of Periodic Structure of Dichroic Dye Layer)

The period and the half-value width of a dichroic dye layer separately formed using the magenta ink were determined from an in-plane profile and a φ profile measured with an X-ray diffractometer for thin-film evaluation (manufactured by Rigaku Corp., trade name: “ATX-G”, an in-plane optical system). Both measurements were performed using CuKα at an incident angle of 0.18°.

The relationship between the angle of diffraction and the distance was converted by the following expression:

d=λ/(2*sin θ)

(d: distance, λ: incident X-ray wavelength (CuKα: 1.54 Å)).

The results of the measurement are shown in the following table.

TABLE 2

| | | | Perpendicular to | | | Parallel to | | |
|---|---|---|---|---|---|---|---|---|
| | | Dichroic | the alignment axis | | | the alignment axis | | |
| No. | Dichroic dye | ratio | Peak 1 | Peak 2 | Peak 3 | Peak 1 | Peak 2 | Peak 3 |
| Example 1 | C-9 | 37 | 4.79 Å | 3.95 Å | | 10.56 Å | 3.93 Å | |
| | | | 0.46 Å | 0.25 Å | | 0.61 Å | 0.09 Å | |
| Example 4 | A1-16 | 80 | 4.84 Å | 4.03 Å | 3.35 Å | 4.01 Å | | |
| | | | 0.17 Å | 0.14 Å | 0.08 Å | 0.09 Å | | |
| Example 5 | A1-46 | 21 | 5.57 Å | 4.57 Å | | 7.56 Å | 4.56 Å | |
| | | | 0.19 Å | 0.89 Å | | 0.36 Å | 0.45 Å | |

Note:
The numbers on the upper row denote the periods, and the numbers of the lower row denote the half-value widths.

### Observation of Stereoscopic Image

A viewer observed the prepared stereo image prints. In Examples 1 and 4 using dichroic dyes C-9 and A1-16, respectively, as the magenta ink, the half-value widths of diffraction peaks in the direction perpendicular to the alignment axis and in the direction parallel to the alignment axis were each 0.5 Å or less, indicating a sharp peak. The variation in intermolecular distance was also small, providing a high dichroic ratio. As a result, the viewer observed clear and deep stereoscopic images without causing crosstalk and ghost images. In Example 5 using dichroic dye A1-46 as the magenta ink, however, the half-value width of diffraction peak in the direction perpendicular to the alignment axis was 0.89 Å, indicating a broad peak, a slight variation in the intermolecular distance was observed, and dichroic ratio was slightly low, 21. As a result, some ghost images were observed in the stereoscopic image.

### 5. Example 6

### Production of Image Print for Stereoscopic Image

An image print for stereoscopic image was produced as in Example 1 except that an ink having the composition shown below was used as the magenta ink for stereoscopic image.

### (Preparation of Magenta Ink for Stereoscopic Image)

The following composition was dissolved by stirring to prepare a magenta ink for stereoscopic image.

| | |
|---|---|
| Rod-like liquid crystal (B) having the structure shown below: | 20 parts by |
| | mass |
| Magenta azo dye A1-16 having the structure shown below: | 1 part by |
| | mass |
| Chloroform (solvent): | 79 parts by |
| | mass |

Rod-like liquid crystal (B) 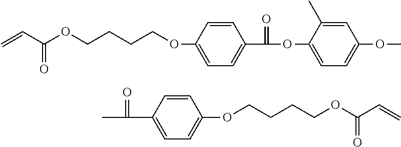
A1-16 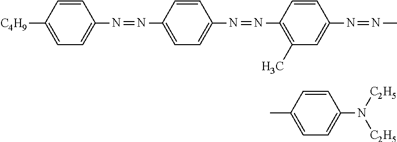
K:137° C., 266° C., I

### (Measurement of Dichroic Ratio of Dichroic Dye Layer)

A dichroic dye layer was separately formed using the same magenta ink and fixing under the same conditions as described above, and the dichroic ratio thereof was measured.

The results of the measurement are shown in the following table.

### (Measurement of Periodic Structure of Dichroic Dye Layer)

A dichroic dye layer was separately formed using the magenta ink mentioned above under the same conditions as in Examples 4 and 5, and the period and the half-value width of the layer were measured.

The results of the measurement are shown in the following table.

TABLE 3

| | | | Perpendicular to | | | Parallel to the | | |
|---|---|---|---|---|---|---|---|---|
| | | Di- | the alignment axis | | | alignment axis | | |
| | Dichroic | chroic | Peak | Peak | Peak | Peak | Peak | Peak |
| No. | dye | ratio | 1 | 2 | 3 | 1 | 2 | 3 |
| Ex- | Rod-like | 12 | 4.55 Å | | | | | |
| am- | liquid | | 1.46 Å | | | | | |
| ple 6 | crystal (B) | | | | | | | |
| | A1-16 | | | | | | | |

Note:
The number on the upper row denotes the period, and the number of the lower row denotes the half-value width.

### Observation of Stereoscopic Image

A viewer observed the stereo image print. In Example 6 using a guest-host-type magenta ink, the half-value width of diffraction peak in the direction perpendicular to the alignment axis was 1.46 Å, indicating a broad peak. Thus, a high variation in the intermolecular distance was observed, and a low dichroic ratio of 12 was also observed. As a result, ghost images were observed in the stereoscopic image.

### 6. Example 7

### Production of Image Print for Stereoscopic Image

An image print for stereoscopic image was produced as in Example 3 except that inks for stereoscopic image having compositions shown below were used and that the photoalignment material E-2 having a structure shown below was used as the alignment film.

### Production of Ink for Stereoscopic Image

### (Preparation of Dichroic Dye Composition)

The following composition was stirred and dissolved at 80° C. for 24 hours to prepare an ink for stereoscopic image. Observation of these dichroic dyes with a polarizing microscope showed that they were lyotropic liquid crystals soluble in water to show liquid crystallinity.

| | |
|---|---|
| (Red ink for stereoscopic image) | |
| C.I. Direct Red 81: | 5 parts by |
| | mass |
| Surfactant Emal 20C (manufactured by Kao Corporation): | 0.2 parts by |
| | mass |
| Water (solvent): | 94.8 parts by |
| | mass |
| (Green ink for stereoscopic image) | |
| C.I. Direct Green 59: | 5 parts by |
| | mass |
| Surfactant Emal 20C (manufactured by Kao Corporation): | 0.2 parts by |
| | mass |
| Water (solvent): | 94.8 parts by |
| | mass |
| (Blue ink for stereoscopic image) | |
| C.I. Direct Blue 67: | 5 parts by |
| | mass |
| Surfactant Emal 20C (manufactured by Kao Corporation): | 0.2 parts by |
| | mass |
| Water (solvent): | 94.8 parts by |
| | mass |

E-2

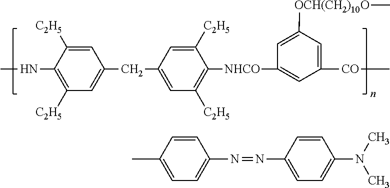

### (Measurement of Dichroic Ratio of Dichroic Dye Layer)

A dichroic dye layer was separately formed using the same ink and fixing under the same conditions as described above, and the dichroic ratio thereof was measured.

The results of the measurement are shown in the following table.

TABLE 4

| No. | Dichroic dye | Dichroic ratio |
|---|---|---|
| Example 7 | C.I. Direct Red 81 | 7 |
| | C.I. Direct Green 59 | 12 |
| | C.I. Direct Blue 67 | 10 |

### Observation of Stereoscopic Image

A viewer observed the stereo image print. In Example 7 using hydrophilic lyotropic liquid crystals as the dichroic dye for inks, the dichroic dyes formed a layer structure due to strong intermolecular interaction to considerably constrain the free movement of the molecules. As a result, the weak alignment-regulating force of the alignment film was insufficient for regulating the alignment to reduce the dichroic ratio. As a result, a stereoscopic image was observed with ghost images.

### 7. Example 8

### Production of Image Print for Stereoscopic Image

An image print for stereoscopic image was produced as in Example 1 except that the additive solution for producing the transparent support did not contain additive B1 (Re-reducing agent) and additive B2 (wavelength dispersion controller). In this case, the transparent support (cellulose acetate film) had a thickness of 200 μm and a Re value at 550 nm of 15 nm.

A viewer observed the stereo image print. Though a stereoscopic image was observed, the image on the opposite side of the transparent support with respect to the viewer was recognized as a ghost image due to the Re of the support.

### REFERENCE SIGNS LIST

10, 10′, 10″ stereo image print
12 transparent support
14a, 14b image-receiving layer
16a, 16b image layer
18a, 18b protective layer
19a, 19a′ first laminate
19b, 19b′ second laminate
20 patterned retardation layer
20x first domain of patterned retardation layer
20y second domain of patterned retardation layer
22 linearly polarizing layer
23a, 23b oxygen-shielding layer
24a, 24b transparent resin hardened layer
26 reflecting layer

The present disclosure relates to the subject matter contained in Japanese Patent Application No. 139316/2010, filed on Jun. 18, 2010, and PCT/JP2011/063927 filed on Jun. 17, 2011, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A stereo image print comprising:
a transparent support;
a first laminate and a second laminate disposed on a front surface and a back surface, respectively, of the transparent support, each laminate comprising an image layer satisfying the following condition (1) and a protective layer comprising at least one layer satisfying the following condition (2), the image layer and the protective layer being disposed in this order from the transparent support side:
(1) each image layer has a dichroic image including pixels for a left eye and pixels for a right eye arranged in a predetermined array, each pixel comprises at least one kind of horizontally aligned dichroic dye, and the dichroic images included in the first and second laminates have absorption axes being orthogonal to each other,
(2) the protective layer comprising at least one layer included in the first laminate has an in-plane retardation value (Re) of 10 nm or less for visible light; and
comprising a patterned retardation layer satisfying the following condition (3) and a linearly polarizing layer satisfying the following condition (4) on the surface of the first laminate, the stereo image print being viewed from exterior of the linearly polarizing layer:
(3) the patterned retardation layer is patterned into a first domain having an in-plane retardation of 0 and a second domain having an in-plane retardation of a ½ wavelength, the pixels for a left eye and the pixels for a right eye being arranged at positions corresponding to the first and second domains, the pixels for a left eye and the pixels for a right eye in the first laminate are left-right reversed to the pixels for a left eye and the pixels for a right eye in the second laminate, and the absorption axes of the dichroic images included in the first laminate and the second laminate forms an angle of 45° with respect to the in-plane slow axis of the second domain,
(4) the linearly polarizing layer has a polarization axis coincident with any one of the absorption axes of the dichroic images included in the first and second laminates,
wherein the stereo image print is configured such that only the dichroic image for a left eye enters an designed viewing position for the left eye and that only the dichroic image for a right eye enters an designed viewing position for the right eye.

2. The stereo image print according to claim 1, wherein the pixels for a right eye and the pixels for a left eye are alternately adjacently arranged, respectively; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included in the second laminate.

3. The stereo image print according to claim 1, wherein the transparent support shows an in-plane retardation value (Re) of 10 nm or less for visible light.

4. The stereo image print according to claim 1, wherein the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other.

5. The stereo image print according to claim 4, wherein the first and second alignment films are rubbing alignment films formed from a composition primarily composed of a polymer compound by rubbing the surfaces of the films such that the rubbing directions of the films are orthogonal to each other.

6. The stereo image print according to claim 4, wherein the first and second alignment films are photoalignment films aligned by light irradiation in the directions orthogonal to each other.

7. The stereo image print according to claim 4, wherein the at least one kind of liquid crystalline dichroic dye is hydrophobic; and the first and second alignment films each comprise a hydrophilic polymer as a main component.

8. The stereo image print according to claim 1, wherein the first laminate and/or the second laminate comprises an oxygen-shielding layer formed from a composition primarily composed of polyvinyl alcohol as one layer of the protective layer comprising one or more layers.

9. The stereo image print according to claim 1, wherein the first laminate and/or the second laminate comprises a layer containing a UV absorber as one layer of the protective layer comprising one or more layers.

10. The stereo image print according to claim 1, wherein the at least one kind of dichroic dye is a liquid crystalline dichroic dye represented by Formula (I), Formula (II), Formula (III), Formula (IV), or Formula (VI): 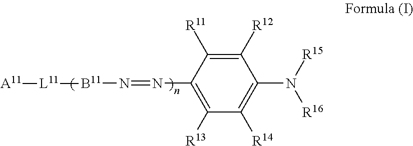
(in the formula, R¹¹ to R¹⁴ each independently represent a hydrogen atom or a substituent; R¹⁵ and R¹⁶ each independently represent a hydrogen atom or an optionally substituted alkyl group; L¹¹ represents —N═N—, —CH═N—, —N═CH—, —C(═O)O—, —OC(═O)—, or —CH═CH—; A¹¹ represents an optionally substituted phenyl group, an optionally substituted naphthyl group, or an optionally substituted aromatic heterocyclic group; B¹¹ represents an optionally substituted divalent aromatic hydrocarbon group or divalent aromatic heterocyclic group; and n represents an integer of 1 to 5, provided that when n represents an integer of 2 or more, a plurality of B¹¹'s may be the same as or different from each other); 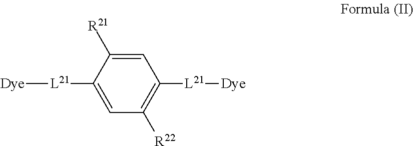
(in the formula, R²¹ and R²² each represent a hydrogen atom, an alkyl group, an alkoxy group, or a substituent represented by -L²²-Y, provided that at least one of R²¹ and R²² represents a group other than a hydrogen atom, wherein L²² represents an alkylene group, where one CH₂ group or two or more nonadjacent CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbon atoms); and Y represents a hydrogen atom, a hydroxy group, an alkoxy group, a carboxyl group, a halogen atom, or a polymerizable group; each L²¹ represents a linker selected from the group consisting of an azo group (—N═N—), a carbonyloxy group (—C(═O)O—), an oxycarbonyl group (—O—C(═O)—), an imino group (—N═CH—), and a vinylene group (—C═C—); and each Dye represents an azo dye residue represented by Formula (IIa): 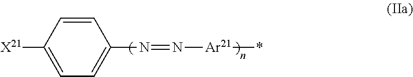
in Formula (IIa), * represents a bonding site to L²¹; X²¹ represents a hydroxy group, a substituted or unsubstituted alkyl group, a substituted or unsubstituted alkoxy group, an unsubstituted amino group, or a mono- or di-alkylamino group; each Ar²¹ represents an optionally substituted aromatic hydrocarbon ring or aromatic heterocyclic group; and n represents an integer of 1 to 3, and when n is an integer of 2 or more, a plurality of Ar²¹'s may be the same as or different from each other); 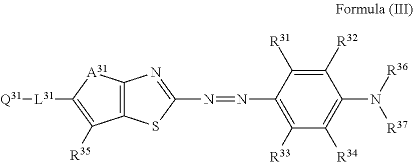
(in the formula, R³¹ to R³⁵ each independently represent a hydrogen atom or a substituent; R³⁶ and R³⁷ each independently represent a hydrogen atom or an optionally substituted alkyl group; Q³¹ represents an optionally substituted aromatic hydrocarbon, aromatic heterocyclic, or cyclohexane ring group; L³¹ represents a divalent linker; and A³¹ represents an oxygen atom or a sulfur atom); 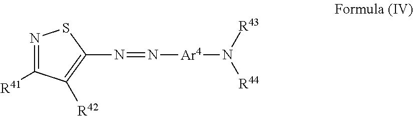
(in the formula, R⁴¹ and R⁴² each represent a hydrogen atom or a substituent or may be bonded to each other to form a ring; Ar⁴ represents an optionally substituted divalent aromatic hydrocarbon or aromatic heterocyclic group; and R⁴³ and R⁴⁴ each represent a hydrogen atom or an optionally substituted alkyl group or may be bonded to each other to form a heterocyclic ring); and 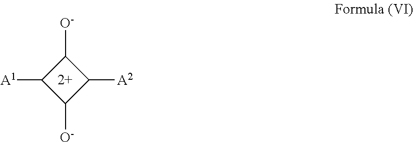
(in the formula, A¹ and A² each independently represent a substituted or unsubstituted hydrocarbon ring or heterocyclic group).

11. The stereo image print according to claim 1, wherein the patterned retardation layer is formed by hardening a curable liquid crystal composition.

12. The stereo image print according to claim 11, wherein the patterned retardation layer is formed by pattern-exposing a film comprising the curable liquid crystal composition to generate the first and the second domains through expression or extinction of in-plane retardation.

13. The stereo image print according to claim 1, further comprising a non-depolarizing reflecting layer on the surface opposite to the viewer side.

14. The stereo image print according to claim 1, wherein the pixels for a right eye and the pixels for a left eye are alternately adjacently arranged, respectively; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included in the second laminate;
wherein the at least one kind of dichroic dye has liquid crystallinity; and
which comprises a first alignment film disposed between the image layer of the first laminate and the transparent support and a second alignment film disposed between the image layer of the second laminate and the transparent support; and
the first and second alignment films have alignment axes orthogonal to each other.

15. The stereo image print according to claim 1, wherein the transparent support shows an in-plane retardation value (Re) of 10 nm or less for visible light and the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other.

16. The stereo image print according to claim 1, wherein the pixels for a right eye and the pixels for a left eye are alternately adjacently arranged, respectively; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included in the second laminate;
the transparent support shows an in-plane retardation value (Re) of 10 nm or less for visible light; and
the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other.

17. The stereo image print according to claim 1, wherein the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other; and
wherein the alignment axes of the first and the second alignment films are orthogonal to each other, and the at least one kind of dichroic dye is a liquid crystalline dichroic dye represented by Formula (I), Formula (II), Formula (III), Formula (IV), or Formula (VI): 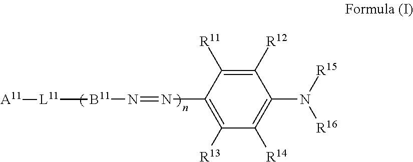
(in the formula, R¹¹ to R¹⁴ each independently represent a hydrogen atom or a substituent; R¹⁵ and R¹⁶ each independently represent a hydrogen atom or an optionally substituted alkyl group; L¹¹ represents —N═N—, —CH═N—, —N═CH—, —C(═O)O—, —OC(═O)—, or —CH═CH—; A¹¹ represents an optionally substituted phenyl group, an optionally substituted naphthyl group, or an optionally substituted aromatic heterocyclic group; B¹¹ represents an optionally substituted divalent aromatic hydrocarbon group or divalent aromatic heterocyclic group; and n represents an integer of 1 to 5, provided that when n represents an integer of 2 or more, a plurality of B¹¹'s may be the same as or different from each other); 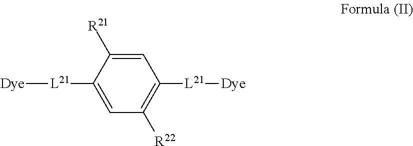
(in the formula, R²¹ and R²² each represent a hydrogen atom, an alkyl group, an alkoxy group, or a substituent represented by -L²²-Y, provided that at least one of R²¹ and R²² represents a group other than a hydrogen atom, wherein L²² represents an alkylene group, where one CH₂ group or two or more nonadjacent CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbon atoms); and Y represents a hydrogen atom, a hydroxy group, an alkoxy group, a carboxyl group, a halogen atom, or a polymerizable group; each L²¹ represents a linker selected from the group consisting of an azo group (—N═N—), a carbonyloxy group (—C(═O)O—), an oxycarbonyl group (—O—C(═O)—), an imino group (—N═CH—), and a vinylene group (—C═C—); and each Dye represents an azo dye residue represented by Formula (IIa): 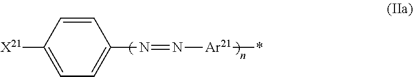
in Formula (IIa), * represents a bonding site to L²¹; X²¹ represents a hydroxy group, a substituted or unsubstituted alkyl group, a substituted or unsubstituted alkoxy group, an unsubstituted amino group, or a mono- or di-alkylamino group; each Ar²¹ represents an optionally substituted aromatic hydrocarbon ring or aromatic heterocyclic group; and n represents an integer of 1 to 3, and when n is an integer of 2 or more, a plurality of Ar²¹'s may be the same as or different from each other); 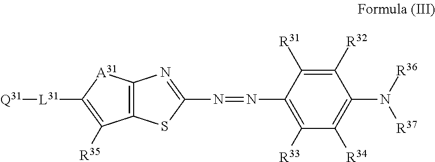
(in the formula, R³¹ to R³⁵ each independently represent a hydrogen atom or a substituent; R³⁶ and R³⁷ each independently represent a hydrogen atom or an optionally substituted alkyl group; Q³¹ represents an optionally substituted aromatic hydrocarbon, aromatic heterocyclic, or cyclohexane ring group; L³¹ represents a divalent linker; and A³¹ represents an oxygen atom or a sulfur atom); 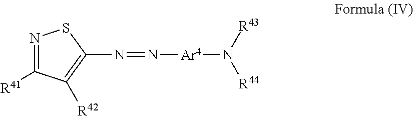
(in the formula, R⁴¹ and R⁴² each represent a hydrogen atom or a substituent or may be bonded to each other to form a ring; Ar⁴ represents an optionally substituted divalent aromatic hydrocarbon or aromatic heterocyclic group; and R⁴³ and R⁴⁴ each represent a hydrogen atom or an optionally substituted alkyl group or may be bonded to each other to form a heterocyclic ring); and 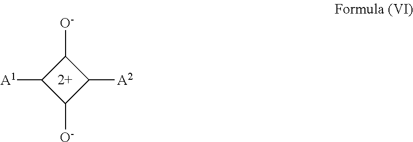
(in the formula, A¹ and A² each independently represent a substituted or unsubstituted hydrocarbon ring or heterocyclic group).

18. The stereo image print according to claim 1, wherein the pixels for a right eye and the pixels for a left eye are alternately adjacently arranged, respectively; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included in the second laminate; the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other; and
wherein the at least one kind of dichroic dye is a liquid crystalline dichroic dye represented by Formula (I), Formula (II), Formula (III), Formula (IV), or Formula (VI): 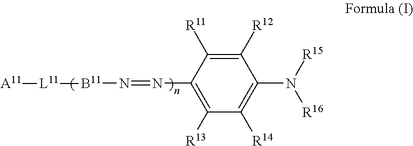
(in the formula, R¹¹ to R¹⁴ each independently represent a hydrogen atom or a substituent; R¹⁵ and R¹⁶ each independently represent a hydrogen atom or an optionally substituted alkyl group; L¹¹ represents —N═N—, —CH═N—, —N═CH—, —C(═O)O—, —OC(═O)—, or —CH═CH—; A¹¹ represents an optionally substituted phenyl group, an optionally substituted naphthyl group, or an optionally substituted aromatic heterocyclic group; B¹¹ represents an optionally substituted divalent aromatic hydrocarbon group or divalent aromatic heterocyclic group; and n represents an integer of 1 to 5, provided that when n represents an integer of 2 or more, a plurality of B¹¹'s may be the same as or different from each other); 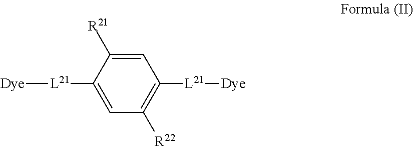
(in the formula, R²¹ and R²² each represent a hydrogen atom, an alkyl group, an alkoxy group, or a substituent represented by -L²²-Y, provided that at least one of R²¹ and R²² represents a group other than a hydrogen atom, wherein L²² represents an alkylene group, where one CH₂ group or two or more nonadjacent CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbon atoms); and Y represents a hydrogen atom, a hydroxy group, an alkoxy group, a carboxyl group, a halogen atom, or a polymerizable group; each L²¹ represents a linker selected from the group consisting of an azo group (—N═N—), a carbonyloxy group (—C(═O)O—), an oxycarbonyl group (—O—C(═O)—), an imino group (—N═CH—), and a vinylene group (—C═C—); and each Dye represents an azo dye residue represented by Formula (IIa): 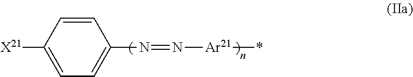
in Formula (IIa), * represents a bonding site to L²¹; X²¹ represents a hydroxy group, a substituted or unsubstituted alkyl group, a substituted or unsubstituted alkoxy group, an unsubstituted amino group, or a mono- or di-alkylamino group; each Ar²¹ represents an optionally substituted aromatic hydrocarbon ring or aromatic heterocyclic group; and n represents an integer of 1 to 3, and when n is an integer of 2 or more, a plurality of Ar²¹'s may be the same as or different from each other); 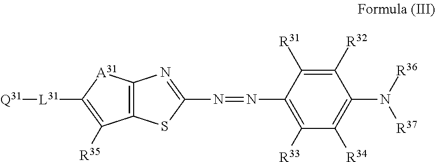
(in the formula, R³¹ to R³⁵ each independently represent a hydrogen atom or a substituent; R³⁶ and R³⁷ each independently represent a hydrogen atom or an optionally substituted alkyl group; Q³¹ represents an optionally substituted aromatic hydrocarbon, aromatic heterocyclic, or cyclohexane ring group; L³¹ represents a divalent linker; and A³¹ represents an oxygen atom or a sulfur atom); 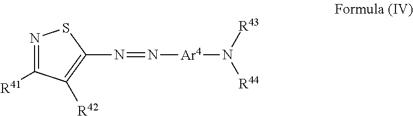
(in the formula, R⁴¹ and R⁴² each represent a hydrogen atom or a substituent or may be bonded to each other to form a ring; Ar⁴ represents an optionally substituted divalent aromatic hydrocarbon or aromatic heterocyclic group; and R⁴³ and R⁴⁴ each represent a hydrogen atom or an optionally substituted alkyl group or may be bonded to each other to form a heterocyclic ring); and 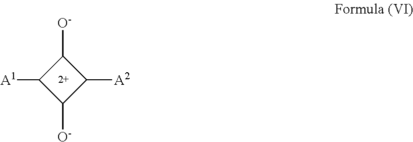
(in the formula, A¹ and A² each independently represent a substituted or unsubstituted hydrocarbon ring or heterocyclic group).

19. A method of producing a stereo image print according to claim 1, the method comprising:
applying a dichroic dye composition comprising an organic solvent and at least one kind of dichroic dye dissolved in the organic solvent, simultaneously or separately, onto the front surface and the back surface of a transparent support so as to form the respective images by arranging pixels for a left eye and pixels for a right eye in a predetermined array; and
horizontally aligning spontaneously or passively the at least one kind of dichroic dye by evaporating the organic solvent in the composition.

20. The method according to claim 19, wherein the liquid crystalline dichroic dye composition is applied by ink jetting.
